(19) United States
(12) Patent Application Publication
(10) Pub. No.: US 2017/0369818 A1
(43) Pub. Date: Dec. 28, 2017

(54) LAUNDRY DETERGENT COMPOSITIONS STABILIZED WITH AN AMPHIPHILIC RHEOLOGY MODIFIER CROSSLINKED WITH AN AMPHIPHILIC CROSSLINKER

(71) Applicant: Lubrizol Advanced Materials, Inc., Cleveland, OH (US)

(72) Inventors: Jung Hyun Park, Bel Air, MD (US); Francine I. Shuster, Valley City, OH (US); Sinan Li, Hudson, OH (US)

(21) Appl. No.: 15/537,979

(22) PCT Filed: Dec. 21, 2015
(86) PCT No.: PCT/US15/66972

§ 371 Date: Jun. 20, 2017

Related U.S. Application Data
(60) Provisional application No. 62/095,847, filed on Dec. 23, 2014.

(51) Int. Cl. C11D 1/94; C11D 3/50; C11D 1/83; C11D 1/29; C11D 1/86; C11D 17/00; C11D 3/37

(52) U.S. Cl. CPC C11D 1/94; C11D 17/0013; C11D 3/505; C11D 3/3773; C11D 1/29; C11D 1/86; C11D 1/83; C11D 3/3765

(57) ABSTRACT

A liquid laundry detergent composition capable of suspending particles and insoluble materials while remaining readily pourable. The composition is stable over long periods of time. In one aspect, the liquid laundry detergent comprises in an aqueous medium: a) at least one nonethoxylated anionic surfactant; b) at least one ethoxylated anionic surfactant; c) at least one nonionic fatty alcohol ethoxylate surfactant; d) an optional surfactant selected from a nonionic surfactant other than c), a cationic surfactant, fatty acid salt surfactant, an ampholytic surfactant, and mixtures thereof; and e) a nonionic, amphiphilic, emulsion polymer that is crosslinked with an amphiphilic crosslinking agent.

### FIELD

Certain embodiments of the present technology relate to an aqueous liquid laundry detergent composition and more particularly to a transparent heavy-duty aqueous liquid laundry detergent composition which is able to suspend solids and insoluble materials, is stable against phase separation, and is easily pourable. In certain embodiments, the heavy-duty liquid laundry composition comprises a non-ethoxylated anionic surfactant, an ethoxylated anionic surfactant, a nonionic surfactant, and a crosslinked, nonionic, amphiphilic, emulsion polymer capable of indefinitely suspending particulate and insoluble materials without simultaneously causing a large increase in the pour viscosity of the composition, wherein said amphiphilic polymer is crosslinked with an amphiphilic crosslinking agent.

### BACKGROUND

Liquid heavy-duty laundry detergents commonly contain high amounts of surfactants, e.g., above 10 wt. % or more. Highly concentrated liquid detergents are often considered to be more convenient to utilize than less concentrated liquids or dry powdered products and, therefore, have found substantial favor with consumers. Liquids are readily measurable, easily dissolve in the wash water, capable of being easily applied in concentrated solutions or dispersions to soiled areas on garments and fabrics to be laundered and they usually occupy less storage space in warehouses and on retail shelves. Advantageously, liquid detergents may have incorporated into their formulations materials which cannot withstand the high temperatures attendant to the drying operations needed in the manufacture of powders. These materials are often particulate solids or are insoluble in liquid phase systems and require suspension within the system. The materials requiring suspension can be functional, aesthetic or both.

Although liquid laundry detergents containing suspended materials possess many advantages over their powdered counterparts, liquid detergents often have certain inherent disadvantages which must be overcome to produce acceptable commercial detergent products. Heavy duty liquid compositions have traditionally been problematic to form and maintain because the materials desired to be incorporated into the compositions have a tendency to phase separate or coalesce. Some heavy duty liquid detergent products containing suspended materials may phase separate under prolonged storage while others may phase separate upon cooling, and the phase separated components cannot be easily redispersed. One problem is that particles or insoluble materials very frequently tend to be of a different density than the continuous phase of the composition to which they are added. This mismatch in the density can lead to separation of the particles from the continuous phase and a lack of overall product stability. If the added particulates and/or insoluble materials are less dense than that of the composition continuous phase, the particles tend to rise to the top of the phase (“creaming”). If the added particles have a density greater than that of the continuous phase, the particles and/or insoluble materials tend to gravitate to the bottom of the phase (“settling”).

Typically, particles and insoluble materials are suspended in surfactant containing compositions using structuring agents such as acrylate polymers or structuring gums (e.g., xanthan gum, rhamsan gum, etc.). While such polymers and gums are desirably used to structure liquids and suspend particles and insoluble materials, they are notoriously susceptible to electrolytes (e.g., surfactants, electrolyte salts) present in the compositions and so may generally only be used when the level of surfactant is severely limited (e.g., less than 10 wt. %). By contrast, heavy-duty laundry detergents typically contain 10 wt. % and greater of surfactant and/or electrolyte. Use of polymers and gums at such high levels of surfactant is known to lead to instability/precipitation which in turn leads to a cloudy product and to phase separation. Moreover, these polyacrylates and gums are pH dependent containing anionic groups which must be neutralized in order to build suspension viscosity. In addition, they have narrow limits of compatibility with cationic adjuvants such as deposition aids and fabric softeners contained in the detergent.

Many suspending agents operate on the principle of thickening a liquid product to a great enough viscosity to retard the phase separation of particulate and/or insoluble materials to such an extent that the product is stable over its lifetime. However, a suspending agent relying only on thickening must be incorporated at such a high percentage to provide long term suspension that an unacceptably viscous non-pourable product results. An increase in viscosity alone is not sufficient to afford permanent suspension of a dispersed phase. Stokes' law provides that merely increasing viscosity will delay but not stop separation or sedimentation of particles or droplets suspended in a liquid. This assumes of course that the particles are too large to be suspended by Brownian motion. Moreover, such increases in suspension viscosity are naturally limited by the requirement that the liquid suspension be readily pourable and flowable, even at low temperatures.

While a structuring agent may increase the viscosity of a composition in which it is included, it does not necessarily have desirable yield stress properties. A desirable yield stress property is critical to achieving certain physical and aesthetic characteristics in a liquid medium, such as the indefinite suspension of particles and, insoluble liquid droplets. Particles dispersed in a liquid medium will remain suspended if the yield stress (yield value) of the medium is sufficient to overcome the effect of gravity or buoyancy on those particles. Particulate materials and insoluble liquid droplets can be prevented from rising, settling and be suspended and uniformly distributed in a liquid medium using yield value as a formulating tool.

While attempts have been made to provide a heavy-duty laundry detergent that provides good cleaning with improved suspension stability and clarity, none have accomplished that objective. There remains a need for a heavy-duty laundry detergent containing a structuring agent that is independent of pH, compatible with cationic adjuvants and provides stable suspension of particulate and insoluble materials without significantly increasing viscosity.

### SUMMARY

It has been discovered that aqueous, heavy-duty laundry detergent compositions achieving good viscosity profiles, clarity and suspension stability are obtained by incorporating at least one crosslinked, nonionic, amphiphilic polymer in combination with at least one non-ethoxylated anionic surfactant, at least one ethoxylated anionic surfactant and at least one fatty alcohol ethoxylate surfactant, wherein said amphiphilic polymer is crosslinked with an amphiphilic crosslinking agent.

In one aspect, the disclosed technology relates to a heavy-duty laundry detergent composition containing in an aqueous medium:

(a) 1 to 20 wt. % of a nonethoxylated anionic surfactant;

(b) 1 to 20 wt. % of an ethoxylated anionic surfactant;

(c) 1 to 20 wt. % of a fatty alcohol ethoxylate;

(d) 0 to 7 wt. % of a surfactant selected from a nonionic surfactant other than component (c), a cationic surfactant, fatty acid salt, an ampholytic/zwitterionic surfactant, and mixtures thereof;

(e) 0.5 to 5 wt. % of a suspending polymer selected from a crosslinked, nonionic, amphiphilic, emulsion polymer prepared from a monomer composition comprising:

(i) at least one hydrophilic monomer,

(ii) at least one hydrophobic monomer, and

(iii) about 0.01 to about 5 wt. % of at least one amphiphilic crosslinking agent containing more than one unsaturated reactive moieties; and

(f) water; wherein the amount of (a) through (d) is at least 10 wt. % in one aspect, at least 15 wt. % in another aspect, at least 25 wt. % in still another aspect and from about 30 to about 70 wt. % in a further aspect, and wherein the weight percent is based on the total weight of the composition.

In one aspect, embodiments of the present technology relate to a heavy-duty laundry detergent composition containing in an aqueous medium:
a) at least one nonethoxylated surfactant component comprising a linear alkylbenzene sulfonate;
b) at least one ethoxylated surfactant component comprising an alkyl ether sulfate;
c) at least one nonionic fatty alcohol ethoxylate surfactant;
d) an optional surfactant selected from a nonionic surfactant other than c), a cationic surfactant, a fatty acid soap, an ampholytic surfactant, and mixtures thereof; and
e) a crosslinked, nonionic, amphiphilic, emulsion polymer prepared from a polymerizable monomer mixture comprising at least one hydrophilic monomer; at least one hydrophobic monomer; at least one amphiphilic crosslinking agent; wherein said hydrophilic monomer is selected from hydroxy(C₁-C₅)alkyl (meth)acrylates, N-vinyl amides, amino group containing monomers, or mixtures thereof; wherein said hydrophobic monomer is selected from esters of (meth)acrylic acid with alcohols containing 1 to 30 carbon atoms, vinyl esters of aliphatic carboxylic acids containing 1 to 22 carbon atoms, vinyl ethers of alcohols containing 1 to 22 carbon atoms, vinyl aromatic monomers, vinyl halides, vinylidene halides, associative monomers, semi-hydrophobic monomers, and mixtures thereof.

In one aspect of the disclosed technology, the nonionic, amphiphilic emulsion polymer (e) is prepared from a free radically polymerizable monomer composition comprising at least one hydroxy(C₁-C₅)alkyl (meth)acrylate, at least one ester of (meth)acrylic acid with alcohols containing 1 to 30 carbon atoms, at least one associative monomer, and at least one amphiphilic crosslinking monomer, and wherein the yield stress of the composition in which the polymer is included is at least 0.1 mPa and wherein the yield stress, viscosity, and optical clarity of the composition are substantially independent of pH ranging from about 2 to about 14.

### DESCRIPTION OF EXEMPLARY EMBODIMENTS

Exemplary embodiments in accordance with the disclosed technology will be described. Various modifications, adaptations or variations of the exemplary embodiments described herein may become apparent to those skilled in the art as such are disclosed. It will be understood that all such modifications, adaptations or variations that rely upon the teachings of the disclosed technology, and through which these teachings have advanced the art, are considered to be within the scope and spirit of the presently disclosed technology.

The compositions, polymers and methods of the disclosed technology may suitably comprise, consist of, or consist essentially of the components, elements, steps, and process delineations described herein. The technology illustratively disclosed herein suitably may be practiced in the absence of any element which is not specifically disclosed herein.

Except as otherwise noted, the articles “a”, “an”, and “the” mean one or more.

The phrase “at least one” as used herein means one or more and thus includes individual components as well as mixtures or combinations of individual components.

“Heavy-duty laundry detergent” means that the composition contains 10 wt. % and greater, or 15 wt. % and greater, or 20 wt. % and greater, or 25 wt. % and greater, or 30 to 70 wt. % of total surfactant and/or electrolyte.

By “pourable” is meant that the heavy-duty laundry detergent at 23° C. is of a consistency which can be poured from an open container without the need for application of any force other than gravity and be poured at a relatively low viscosity. This relatively low viscosity refers to below 2 Pas (2000 cps) at shear rate, 18 to 21 s⁻¹ at 23° C.

Unless otherwise stated, all percentages, parts, and ratios expressed herein are based upon weight of the total compositions of the disclosed technology.

When referring to a specified monomer(s) that is incorporated into a polymer of the disclosed technology, it will be recognized that the monomer(s) will be incorporated into the polymer as a unit(s) derived from the specified monomer(s) (e.g., repeating unit).

As used herein, the term “amphiphilic polymer” means that the polymeric material has distinct hydrophilic and hydrophobic portions. “Hydrophilic” typically means a portion that interacts intermolecularly and intramolecularly with water and other polar molecules. “Hydrophobic” typically means a portion that interacts preferentially with oils, fats or other non-polar molecules rather than aqueous media.

As used herein, the term “hydrophilic monomer” means a monomer that is substantially water soluble. “Substantially water soluble” refers to a material that is soluble in distilled (or equivalent) water, at 25° C., at a concentration of about 3.5% by weight in one aspect, and soluble at about 10% by weight in another aspect (calculated on a water plus monomer weight basis).

As used herein, the term “hydrophobic monomer” means a monomer that is substantially water insoluble. “Substantially water insoluble” refers to a material that is not soluble in distilled (or equivalent) water, at 25° C., at a concentration of about 3% by weight in one aspect, and not soluble at about 2.5% by weight in another aspect (calculated on a water plus monomer weight basis).

By “nonionic” is meant that a compound, monomer, monomer composition or a polymer polymerized from a monomer composition is devoid of ionic or ionizable moieties (“nonionizable”).

An ionizable moiety is any group that can be made ionic by neutralization with an acid or a base.

An ionic or an ionized moiety is any moiety that has been neutralized by an acid or a base.

By “substantially nonionic” is meant that the monomer, monomer composition or polymer polymerized from a monomer composition contains less than 15 wt. % in one aspect, less than 10 wt. % in another aspect, less than 5 wt. % in a further aspect, less than 2 wt. % in a still further aspect, less than 1 wt. % in an additional aspect, and less than 0.5 wt. % in a further aspect, or 0 wt. % of an ionizable and/or an ionized moiety.

The prefix “(meth)acryl” includes “acryl” as well as “methacryl”. For example, the term (meth)acrylic includes both acrylic and methacrylic, and the term (meth)acrylate includes acrylate as well as methacrylate. By way of further example, the term “(meth)acrylamide” includes both acrylamide and methacrylamide.

Here, as well as elsewhere in the specification and claims, individual numerical values (including carbon atom numerical values), or limits, can be combined to form additional non-disclosed and/or non-stated ranges.

While overlapping weight ranges for the various components and ingredients that can be contained in the compositions of the disclosed technology have been expressed for selected embodiments and aspects of the technology, it should be readily apparent that the specific amount of each component in the disclosed compositions will be selected from its disclosed range such that the amount of each component is adjusted such that the sum of all components in the composition will total 100 weight percent. The amounts employed will vary with the purpose and character of the desired product and can be readily determined by one skilled in the art.

The headings provided herein serve to illustrate, but not to limit the disclosed technology in any way or manner.

### Surfactant Chassis

The surfactant chassis of the heavy-duty laundry detergent of the disclosed technology comprises: (a) from about 1 to about 20 wt. % in one aspect, from about 3 to about 15 wt. % in another aspect, and from about 5 to about 12 wt. % in still another aspect of at least one nonethoxylated anionic surfactant; (b) from about 1 to about 20 wt. % in one aspect, from about 3 to about 15 wt. % in another aspect, and from about 5 to about 12 wt. % in still another aspect of at least one ethoxylated anionic surfactant; (c) from about 1 to about 20 wt. % in one aspect, from about 1 to about 15 wt. % in another aspect, and from about 2 to about 10 wt. % in still another aspect of at least one nonionic fatty alcohol ethoxylate surfactant; and optionally (d) from about 0 or 1 to about 7 wt. %. in one aspect, from about 1.5 to about 5 wt. % in another aspect, and from about 2 to about 3 wt. % in a further aspect of an auxiliary surfactant selected from a nonionic surfactant other than (c), a cationic surfactant, a fatty acid salt surfactant, an amphoteric or zwitterionic surfactant, and mixtures thereof; wherein the amount of surfactants (a) through (d) is at least about 10 wt. % in one aspect, at least about 15 wt. % in another aspect, at least about 20 wt. % in still another aspect, at least about 25 wt. % in a further aspect, and at least about 30, 35, 40, 45, 50, 55, 60, and 65 wt. % in still a further aspect (all weight percentages are based upon the total weight of the composition and 100 percent active material).

The weight ratio of the at least one nonethoxylated anionic surfactant (a) to the at least one ethoxylated anionic surfactant (b) to the at least one nonionic fatty alcohol ethoxylate (c) can range from about 1:1:1 to about 6:6:1 in one aspect, from about 2:2:1 to about 5:5:1 in another aspect, and from about 3:3:1 to about 4:4:1 in still another aspect.

### Nonethoxylated Anionic Surfactant (a)

In one aspect, surfactant component (a) is a nonethoxylated anionic surfactant selected from the alkali metal, ammonium or alkanolamine salts of alkyl benzene sulfonates and alkali metal, ammonium or alkanolamine salts of alkyl sulfates. The alkyl sulfates are those in which the alkyl groups contain 8 to 26 carbon atoms in one aspect, 10 to 22 carbon atoms in another aspect, and 12 to 18 carbon atoms in still another aspect. In one aspect the alkyl sulfates conform to the formula:

R′—OSO₃⁻M⁺

wherein R′ is a C₈ to C₂₆ alkyl radical, and M is an alkali metal (e.g., sodium, potassium), ammonium or alkanolamine cation moiety.

In one aspect, the alkyl substituent is linear, i.e., normal alkyl, however, branched chain alkyl sulfonates can be employed, although they are not as good with respect to biodegradability. The alkyl, substituent may be terminally sulfonated or the sulfonation can occur on any carbon atom of the alkyl chain, i.e., may be a secondary sulfonate. In one aspect, the alkyl sulfonates can be used as the alkali metal salts, such as sodium and potassium.

The alkyl group in the alkyl benzene sulfonate contains 8 to 16 carbon atoms in one aspect, and 10 to 15 carbon atoms in another aspect. In one aspect, the alkyl group is linear. It is understood that the benzene sulfonate moiety can be attached to any carbon atom on the linear alkyl chain. Such linear alkyl benzene sulfonate surfactants are known by the abbreviation “LAS”. In one aspect, the LAS surfactant is the sodium, potassium or ethanolamine C₁₀ to C₁₆ linear alkyl benzene sulfonate, e.g., sodium linear dodecyl benzene sulfonate. Sodium linear dodecyl benzene sulfonate is one compound of a mixture of surfactant compounds that contain variable linear alkyl chain lengths ranging from about 10 to about 16 carbon atoms. Dodecyl benzene sulfonate is considered representative of the entire range of alkyl chain substituents because the average number of carbon atoms in the alkyl chain is about 12.

### Ethoxylated Anionic Surfactant (b)

In one aspect, surfactant component (b) is an ethoxylated anionic surfactant selected from the alkali metal, ammonium or alkanolamine salt of an ethoxylated alkyl sulfate having from about 8 to 20 carbon atoms in the alkyl moiety in one aspect, and 10 to 18 carbon atoms in another aspect, with an ethylene oxide content of about 1 to 7 moles per mole of alkyl sulfate. In one aspect the ethoxylated alkyl sulfates conform to the formula:

R″—O—(CH₂CH₂O)ₙ—SO₃⁻M⁺

wherein R″ is a C₈ to C₂₀ alkyl group, M is an alkali metal (e.g., sodium, potassium), ammonium or alkanolamine cation moiety, and n is from about 1 to 7 in one aspect, from about 2 to 6 in another aspect, and from about 3 to 5 in still another aspect. In one aspect the ethoxylated alky sulfate surfactant comprises sodium ethoxylated lauryl sulfate containing 1, 2, or 3 moles of ethylene oxide, and mixtures thereof.

### Fatty Alcohol Ethoxylate Surfactant (c)

In one aspect, surfactant component (c) is a nonionic fatty alcohol ethoxylate surfactant where the fatty alcohol contains a C₁₀ to C₂₀ alkyl or alkenyl group or a C₈ to C₁₂ alkyl phenyl group, with from about 3 to about 15 moles of ethylene oxide content of per mole of fatty alcohol. In one aspect, the nonionic fatty alcohol ethoxylates conform to the formula:

R′″—(OCH₂CH₂)ₙ—OH

wherein R′″ is selected from a C₁₀ to C₂₀ alkyl, a C₁₀ to C₂₀ alkenyl, and a C₈ to C₁₂ alkyl phenyl group, and n is on average from about 3 to about 15 in one aspect, from about 4 to about 12 in another aspect, and from about 5 to about 9 in still another aspect. R′″ can comprise a single alkyl and alkenyl group or R′″ can comprise a mixture of alkyl and/or alkenyl groups. In one aspect, the fatty alcohol portion of the fatty alcohol ethoxylate surfactant is derived from linear alcohols of natural origin having 12 to 18 carbon atoms, e.g., from coconut, palm, tallow fatty or oleyl alcohol and having an average of from about 4 to about 12 moles of ethylene oxide per mole of alcohol. In one aspect the nonionic fatty alcohol ethoxylate is a C₁₂-C₁₄ alcohol ethoxylate containing 7 moles of ethoxylation. Representative commercially available nonionic alcohol ethoxylates for use in the present technology, include for example, Neodol® 45-7 (C₁₄-C₁₅ alcohols containing an average of 7 moles of ethoxylation), Neodol® 23-6.5 (C₁₂-C₁₃ alcohols containing an average of 6.5 moles of ethoxylation), Neodol® 25-9 (C₁₂-C₁₅ alcohols containing an average of 9 moles of ethoxylation), and Neodol® 25-12 (C₁₂-C₁₅ alcohols containing an average of 12 moles of ethoxylation) from Shell Chemical Company.

### Auxiliary Surfactant (d)

In one aspect the heavy-duty laundry detergent of the present technology can comprise an optional auxiliary surfactant selected from a nonionic surfactant other than (c), a cationic surfactant, a fatty acid salt (soap) surfactant, a zwitterionic surfactant, and mixtures thereof.

### Nonionic Auxiliary Surfactant

Auxiliary nonionic surfactants include, for example, alkoxylated linear fatty alcohols, ethylene oxide/propylene oxide block copolymers, amine oxides, and alkyl polyglycosides.

The alkoxylated linear fatty alcohols are the reaction product of a higher linear alcohol containing 12 to 16 carbon atoms and a mixture of ethylene and propylene oxides to give a mixed chain of ethylene oxide and propylene oxide which is terminated with a hydroxyl group. Such alkoxylated linear fatty alcohol surfactants are commercially are available under the Plurafac® trade name from BASF Corporation. Examples include Plurafac RA-30 (a C₁₃-C₁₅ fatty alcohol condensed with 6 moles ethylene oxide and 3 moles propylene oxide), Plurafac RA-40 (a C₁₃-C₁₅ fatty alcohol condensed with 7 moles propylene oxide and 4 moles ethylene oxide), and Plurafac D-25 (a C₁₃-C₁₅ fatty alcohol condensed with 5 moles propylene oxide and 10 moles ethylene oxide).

The ethylene oxide/propylene oxide block copolymer nonionic surfactants are condensation products of ethylene oxide with a hydrophobic base segment formed by the condensation of propylene oxide with propylene glycol. The hydrophobic portion of these compounds typically has a molecular weight of from about 1500 to 1800 and exhibits water insolubility. The addition of ethylene oxide moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially available Pluronic™ surfactants, marketed by BASF Corporation.

In another aspect, the ethylene oxide/propylene oxide condensation reaction can be reversed by adding ethylene oxide to ethylene glycol to form a hydrophilic base segment then adding propylene oxide to obtain hydrophobic blocks on the terminal ends of the hydrophilic base segment. The hydrophobic portion of the condensation product has a molecular weight from 1000 to 3100 where the polyethylene content is about 10 to 80% of the total weight of the condensation product. These reverse condensation products are also manufactured by BASF Corporation under the trade name Pluronic™ R surfactants.

In one aspect, the amine oxides which can be used as an auxiliary surfactant are compounds corresponding to the formula R(OR′)ₙ(R″)₂N→O in which R is selected from an alkyl, a hydroxyalkyl, and an acylamidopropoyl group containing from 8 to 22 carbon atoms in one aspect, and from 10 to 16 carbon atoms in another aspect; R′ is an alkylene or hydroxyalkylene group containing 2 to 3 carbon atoms in one aspect, and 2 carbon atoms in another aspect; n is from about 0 to about 5; and R″ is an alkyl or hydyroxyalkyl group containing from 1 to 3 carbon atoms in one aspect, and from 1 to 2 carbon atoms in another aspect (e.g., methyl, ethyl, and 2-hydroxyethyl), or a polyethylene oxide group containing from 1 to 3, ethylene oxide groups; and the arrow designates a semi-polar bond. In one aspect, R is a C₁₂-C₁₈ primary alkyl group; n is 0; and R″ is methyl.

Exemplary amine oxide surfactants include dimethyloctylamine oxide, diethyldecylamine oxide, bis-(2-hydroxyethyl) dodecylamine oxide, dimethyldodecylamine oxide, dipropyltetradecylamine oxide, methylethylhexadecylamine oxide, dodecylamidopropyl dimethylamine oxide, dimethyltetradecylamine oxide, cetyl dimethylamine oxide, stearyl dimethylamine oxide, tallow dimethylamine oxide and dimethyl-2-hydroxyoctadecylamine oxide.

Suitable auxiliary alkylpolysaccharide surfactants for use herein conform to the formula: RO(CₙH₂ₙO)ₜ(glycosyl)ₓ wherein R is a hydrophobic moiety selected from acyl, alkyl, alkylphenyl, hydroxyalkyl, hydroxyalkylphenyl, and mixtures thereof, wherein the hydrophobic moiety contains from 8 to 18 carbon atoms; n is 2 or 3; t is from 0 to 10, and x is the degree of polymerization and ranges from about 1.3 to about 10 in one aspect, from about 1.3 to about 3 in another aspect, from about 1.3 to about 2.7, and from about 1.4 to about in still another aspect. Glycosyl is a moiety derived from a saccharide containing 5 or 6 carbon atoms, e.g., pentose or hexose. In one aspect, the glycosyl moiety is derived from glucose (i.e., glucoside).

The optional polyalkyleneoxide chain joining the hydrophobic moiety and the glycosyl moiety contains ethylene oxide, propylene oxide, and mixtures thereof. In one aspect, a suitable alkyleneoxide is ethylene oxide. Typical hydrophobic groups include alkyl groups, either saturated or unsaturated, branched or unbranched containing from about 8 to about 18 carbon atoms in one aspect, and from about 10 to about 16 carbon atoms in another aspect. Representative alkylpolysaccharides are octyl, nonyldecyl, undecyldodecyl tridecyl, tetradecyl, pentadecyl, hexadecyl, heptadecyl and octadecyl, di-, tri-, tetra-, penta-, and hexaglucosides, galactosides, lactosides, fructosides, fructoses, galactoses, and glucoses. Suitable mixtures include coconut alkyl di-, tri-, tetra-, and pentaglucosides and tallow alkyl tetra-, penta-, and hexaglucosides.

Suitable commercially available alkylglycosides include, for example, those derived from glucose which are available from BASF Corporation under the trade names APG® 225 (a C₈-C₁₂ alkyl polyglucoside with a degree of polymerization of about 1.7), APG 325 (a C₉-C₁₁ alkyl polyglycoside with a degree of polymerization of about 1.5), APG 425 (a C₈-C₁₆ alkyl polyglycoside with a degree of polymerization of about 1.6), and APG 625 (a C₁₂-C₁₆ alkyl polyglycoside with a degree of polymerization of about 1.6).

### Cationic Auxiliary Surfactant

Many cationic surfactants are known in the art, and almost any cationic surfactant having at least one long chain alkyl group of about 10 to 24 carbon atoms is suitable in the present technology. Such compounds are described in “Cationic Surfactants”, Jungermann, 1970, incorporated by reference. Specific cationic surfactants which can be used as surfactants in the present technology are described in detail in U.S. Pat. No. 4,497,718, which is hereby incorporated by reference.

In one aspect, suitable cationic surfactants are monoalkyl quaternary ammonium surfactants conforming to the structure:

(R′″)(R″)(R′)(R)N⁺A⁻

wherein R′, R″, and R′″ are independently selected from a C₁-C₃ alkyl or hydroxyalkyl group (e.g., methyl, ethyl, propyl, hydroxymethyl, hydroxyethyl, hydroxypropyl); and R is selected from an alkyl group of from 6 to 22 carbon atoms in one aspect, 8 to 18 carbon atoms in another aspect, and 10 to 16 carbon atoms in still another aspect; and A is a salt-forming anion such as, for example, those selected from halogen, (e.g., chloride, bromide), acetate, citrate, lactate, glycolate, phosphate, nitrate, sulphate, and alkylsulfate (e.g., methosulfate).

In one aspect, the auxiliary cationic surfactant is a dialkyl quaternary ammonium compound corresponding to the general formula: (R⁷⁵)(R⁷⁶)(R⁷⁷)(R⁷⁸)N⁺CA⁻ wherein two of R⁷⁵, R⁷⁶, R⁷⁷ and R⁷⁸ are selected from an alkyl group containing from 12 to 22 carbon atoms or an aromatic, alkoxy, polyoxyalkylene, alkylamido, hydroxyalkyl, aryl or alkylaryl group having up to about 30 carbon atoms with or without an ester group; and the remainder of R⁷⁵, R⁷⁶, R⁷⁷ and R⁷⁸ are independently selected from an alkyl group containing from to about 4 carbon atoms or an alkoxy, polyoxyalkylene, alkylamido, hydroxyalkyl, aryl or alkylaryl group having up to about 4 carbon atoms; and CA⁻ is a salt-forming anion such as those selected from halogen, (e.g. chloride, bromide), acetate, citrate, lactate, glycolate, phosphate, nitrate, sulfonate, sulfate, alkylsulfate, and alkyl sulfonate (e.g., methosulfate and ethosulfate) moieties. The alkyl groups can contain, in addition to carbon and hydrogen atoms, ether and/or ester linkages, and other groups such as amino groups. The longer chain alkyl groups, e.g., those of about 12 carbons, or higher, can be saturated or unsaturated or branched. In one embodiment, two of R⁷⁵, R⁷⁶, R⁷⁷ and R⁷⁸ are selected from an alkyl group containing from 12 to 22 carbon atoms in one aspect, from 14 to 20 carbon atoms in another aspect, and from 16 to 18 carbon atoms in a further aspect; the remainder of R⁷⁵, R⁷⁶, R⁷⁷ and R⁷⁸ are independently selected from CH₃, C₂H₅, C₂H₄OH, and mixtures thereof. Any two of R⁷⁵, R⁷⁶, R⁷⁷, and R⁷⁸ together with the nitrogen atom to which they are attached can be taken together to form a ring structure containing 5 to 6 carbon atoms, one of said carbon atoms can optionally be replaced with a heteroatom selected from nitrogen, oxygen or sulfur. CA⁻ is a salt-forming anion selected from halogen, (e.g. chloride, bromide), acetate, citrate, lactate, glycolate, phosphate, nitrate, sulfate, and alkylsulfate (e.g., methosulfate, ethosulfate).

Non-limiting examples of dialkyl quaternized ammonium compounds include dicocodimonium chloride; dicocodimonium bromide; dimyristyldimonium chloride; dimyristyldimonium bromide; dicetyldimonium chloride; dicetyldimonium bromide; dicetylmethylbenzylmonium chloride; distearyldimonium chloride; distearyldimonium bromide; dimetyldi(hydrogenated tallow)monium chloride; hydroxypropylbisstearylmonium chloride; distearylmethylbenzylmonium chloride; dibehenyl/diarachidyldimonium chloride; dibehenyl/diarachidyldimonium bromide; dibehenyldimonium chloride; dibehenyldimonium bromide; dibehenyldimonium methosulfate; dibehenylmethylbenzylmonium chloride; dihydrogenated tallow benzylmonium chloride; dihydrogenated tallowethyl hydroxyethylmonium methosulfate; dihydrogenated tallow hydroxyethylmonium methosulfate; di-C₁₂-C₁₅ alkyldimonium chloride; di-C₁₂-C₁₈ alkyldimonium chloride; di-C₁₄-C₁₈ alkyldimonium chloride; dicocoylethyl hydroxyethylmonium methosulfate; disoyoylethyl hydroxyethylmonium methosulfate; dipalmitoylethyldimonium chloride; dihydrogenated palmoylethyl hydroxyethylmonium methosulfate; dihydrogenated tallowam idoethyl hydroxyethylmonium chloride; dihydrogenated tallowamidoethyl hydroxyethylmonium methosulfate; dihydrogenated tallowoylethyl hydroxyethylmonium methosulfate; distearoylethyl hydroxyethylmonium methosulfate; and Quaternium-82.

In one aspect, the cationic auxiliary surfactant is an asymmetric dialkyl quaternary ammonium compound corresponding to the general formula: (R⁸⁰)(R⁸¹)(R⁸²)(R⁸³)N+CA⁻ wherein R⁸⁰ is selected from an alkyl group containing from 12 to 22 carbon atoms or an aromatic, alkoxy, polyoxyalkylene, alkylamido, hydroxyalkyl, aryl or alkylaryl group containing up to about 22 carbon atoms; R⁸¹ is selected from an alkyl group containing from 5 to 12 carbon atoms or an aromatic, alkoxy, polyoxyalkylene, alkylamido, hydroxyalkyl, aryl or alkylaryl group containing up to about 12 carbon atoms; R⁸² and R⁸³ are independently selected from an alkyl group containing from 1 to about 4 carbon atoms or an aromatic, alkoxy, polyoxyalkylene, alkylamido, hydroxyalkyl, aryl or alkylaryl group containing up to about 4 carbon atoms; and CA³¹ is a salt-forming anion such as, for example, halogen, (e.g. chloride, bromide), acetate, citrate, lactate, glycolate, phosphate, nitrate, sulfate, and alkylsulfate (e.g., methosulfate, ethosulfate). The alkyl groups can contain, in addition to carbon and hydrogen atoms, ether linkages, ester linkages, and other moieties such as amino groups. The longer chain alkyl groups, e.g., those of about 12 carbons, or higher, can be saturated or unsaturated and/or straight or branched. In one embodiment, R⁸⁰ is selected from a non-functionalized alkyl group containing from 12 to 22 carbon atoms in one aspect, from 14 to 20 carbon atoms in another aspect, and from 16 to 18 carbon atoms in a further aspect; R⁸¹ is selected from a non-functionalized alkyl group containing from 5 to 12 carbon atoms in one aspect, from 6 to 10 carbon atoms in another aspect, and 8 carbon atoms in a further aspect; R⁸² and R⁸³ are independently selected from CH₃, C₂H₅, C₂H₄OH, and mixtures thereof; and CA³¹ is selected from Cl, Br, CH₃OSO₃, C₂H₅OSO₃, and mixtures thereof. In one aspect, R⁸⁰ is a straight, saturated non-functionalized alkyl group, and R⁸¹ is a branched, saturated non-functionalized alkyl group. In one aspect, the branched group of R⁸¹ is a straight, saturated alkyl group containing from 1 to 4 carbon atoms, and in another aspect, R⁸¹ is an alkyl group containing 2 carbon atoms.

Non-limiting examples of asymmetric dialkyl quaternized ammonium salt compounds include: stearylethylhexyldimonium chloride, stearylethylhexyldimonium bromide; stearyl ethylhexyl dimonium methosulfate; cetearyl ethylhexyldimonium methosulfate.

### Fatty Acid Salt (Soap) Auxiliary Surfactants

In one aspect, suitable fatty acid soaps are selected from at least one the fatty acid salt (e.g., sodium, potassium, ammonium and alkanolammonium, such as monoethanolammonium, diethanolammonium, and triethanolammonium salts of fatty acids containing from about 10 to about 22 carbon atoms in one aspect, from about 12 to about 18 carbon atoms in another aspect and from about 14 to about 16 carbon atoms in still another aspect. Mixtures of various fatty acid carbon chain lengths are possible. The fatty acids can be linear or branched and saturated or unsaturated and can be derived from synthetic sources, as well as from the saponification of fats and natural oils by a suitable base (e.g., sodium, potassium and ammonium hydroxides). Exemplary saturated fatty acids include but are not limited to octanoic, decanoic, lauric, myristic, pentadecanoic, palmitic, margaric, steric, isostearic, nonadecanoic, arachidic, behenic, and the like, and mixtures thereof. Exemplary unsaturated fatty acids include but are not limited to the salts (e.g., sodium, potassium, ammonium) of myristoleic, palmitoleic, oleic, linoleic, linolenic, and the like, and mixtures thereof. The fatty acids can be derived from animal fat such as tallow or from vegetable oil such as coconut oil, red oil, palm kernel oil, palm oil, cottonseed oil, olive oil, soybean oil, peanut oil, corn oil, and mixtures thereof. When derived from natural sources the fatty acid soaps are usually obtained as mixtures of various carbon atom lengths.

### Amphoteric/Zwitterionic Auxiliary Surfactants

Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. The cationic atom in the quaternary compound can be part of a heterocyclic ring. In all of these compounds there is at least one aliphatic group, straight chain or branched, containing from about 3 to 18 carbon atoms and at least one aliphatic substituent containing an anionic water solubilizing group, e.g., carboxy, sulfonate, sulfate, phosphate, or phosphonate. Specific examples of zwitterionic surfactants which may be used are set forth in U.S. Pat. No. 4,062,647, hereby incorporated by reference.

Suitable zwitterionic surfactants include betaines and sultaines, conforming to the formula:

(R⁸⁶)(R⁸⁷)(R⁸⁸)N⁺R⁸⁹-T⁻

wherein T³¹ is selected from COO⁻ and SO₃⁻ and R⁸⁶ is an alkyl group having 10 to about 20 carbon atoms, or 12 to 16 carbon atoms, or the amido radical:

R⁹⁰C(═O)NH—(CH₂)ₙ—

wherein R⁹⁰ is an alkyl group having about 9 to 19 carbon atoms and n is the integer 1 to 4; R⁸⁷ and R⁸⁸ are each alkyl groups having 1 to 3 carbons (e.g., methyl, ethyl, propyl); R⁸⁹ is an alkylene or hydroxyalkylene group having from 1 to 4 carbon atoms and, optionally, one hydroxyl group. Typical alkyldimethyl betaines include, but are not limited to, decyl dimethyl betaine or 2-(N-decyl-N,N-dimethyl-ammonia) acetate, coco dimethyl betaine or 2-(N-coco N,N-dimethylammonia) acetate, myristyl dimethyl betaine, palmityl dimethyl betaine, lauryl dimethyl betaine, cetyl dimethyl betaine, stearyl dimethyl betaine, and the like. The amidobetaines similarly include, but are not limited to, cocoamidoethylbetaine, cocoamidopropyl betaine and the like. The amidosulfobetaines include, but are not limited to, cocoamidoethylsulfobetaine, cocoamidopropyl sulfobetaine and the like.

### Ampholytic Polymer

The nonionic, amphiphilic emulsion polymer component (c) useful in the compositions of the disclosed technology are polymerized from monomer components that contain free radical polymerizable unsaturation. In one embodiment, the nonionic, amphiphilic polymers useful in the practice of the disclosed technology are polymerized from a monomer composition comprising at least one nonionic, hydrophilic unsaturated monomer, and at least one unsaturated hydrophobic monomer. In another embodiment, the nonionic, amphiphilic polymers useful in the practice of the disclosed technology are crosslinked. The crosslinked polymers are prepared from a monomer composition comprising at least one nonionic, hydrophilic unsaturated monomer, at least one unsaturated hydrophobic monomer, and at least one polyunsaturated crosslinking monomer and/or at least one polyunsaturated reactive surfactant crosslinker.

In one embodiment, the copolymers can be prepared from a monomer composition typically having a hydrophilic monomer to hydrophobic monomer ratio of from about 5:95 wt. % to about 95:5 wt. % in one aspect, from about 15:85 wt. % to about 85:15 wt. % in another aspect, and from about 30:70 wt. % to about 70:30 wt. % in a further aspect, based on the total weight of the hydrophilic and hydrophobic monomers present. The hydrophilic monomer component can be selected from a single hydrophilic monomer or a mixture of hydrophilic monomers, and the hydrophobic monomer component can be selected from a single hydrophobic monomer or a mixture of hydrophobic monomers.

### Hydrophilic Monomer

The hydrophilic monomers suitable for the preparation of the crosslinked, nonionic, amphiphilic polymer compositions of the disclosed technology are selected from but are not limited to hydroxy(C₁-C₅)alkyl (meth)acrylates; open chain and cyclic N-vinylamides (N-vinyllactams containing 4 to 9 atoms in the lactam ring moiety, wherein the ring carbon atoms optionally can be substituted by one or more lower alkyl groups such as methyl, ethyl or propyl); amino group containing vinyl monomers selected from (meth)acrylamide, N—(C₁-C₅)alkyl(meth)acrylamides, N,N-di(C₁-C₅)alkyl(meth)acrylamides, N—(C₁-C₅)alkylamino(C₁-C₅)alkyl(meth)acrylamides and N,N-di(C₁-C₅)alkylamino(C₁-C₅)alkyl(meth)acrylamides, wherein the alkyl moieties on the disubstituted amino groups can be the same or different, and wherein the alkyl moieties on the monosubstituted and disubstituted amino groups can be optionally substituted with a hydroxyl group; other monomers include vinyl alcohol; vinyl imidazole; and (meth)acrylonitrile. Mixtures of the foregoing monomers also can be utilized.

The hydroxy(C₁-C₅)alkyl (meth)acrylates can be structurally represented by the following formula:

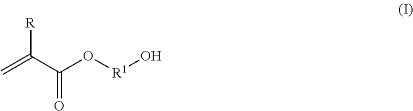

wherein R is hydrogen or methyl and R¹ is an divalent alkylene moiety containing 1 to 5 carbon atoms, wherein the alkylene moiety optionally can be substituted by one or more methyl groups. Representative monomers include 2-hydroxyethyl(meth)acrylate, 3-hydroxypropyl(meth)acrylate, 4-hydroxybutyl(meth)acrylate, and mixtures thereof.

Representative open chain N-vinylamides include N-vinylformamide, N-methyl-N-vinylformamide, N-(hydroxymethyl)-N-vinylformamide, N-vinylacetamide, N-vinylmethylacetamide, N-(hydroxymethyl)-N-vinylacetamide, and mixtures thereof.

Representative cyclic N-vinylamides (also known as N-vinyllactams) include N-vinyl-2-pyrrolidinone (vinyl pyrrolidone), N-(1-methyl vinyl) pyrrolidinone, N-vinyl-2-piperidone, N-vinyl-2-caprolactam, N-vinyl-5-methyl pyrrolidinone, N-vinyl-3,3-dimethyl pyrrolidinone, N-vinyl-5-ethyl pyrrolidinone and N-vinyl-6-methyl piperidone, and mixtures thereof. Additionally, monomers containing a pendant N-vinyl lactam moiety can also be employed, e.g., N-vinyl-2-ethyl-2-pyrrolidone (meth)acrylate.

The amino group containing vinyl monomers include (meth)acrylamide, diacetone acrylamide and monomers that are structurally represented by the following formulas:

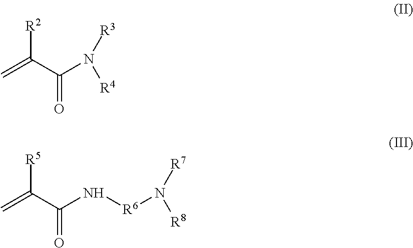

Formula (II) represents N—(C₁-C₅)alkyl(meth)acrylamide or N,N-di(C₁-C₅)alkyl(meth)acrylamide wherein R² is hydrogen or methyl, R³ independently is selected from hydrogen, C₁ to C₅ alkyl and C₁ to C₅ hydroxyalkyl, and R⁴ independently is selected from is C₁ to C₅ alkyl or C₁ to C₅ hydroxyalkyl.

Formula (III) represents N—(C₁-C₅)alkylamino(C₁-C₅)alkyl(meth)acrylamide or N,N-di(C₁-C₅)alkylamino(C₁-C₅)alkyl(meth)acrylamide wherein R⁵ is hydrogen or methyl, R⁶ is C₁ to C₅ alkylene, R⁷ independently is selected from hydrogen or C₁ to C₅ alkyl, and Fe independently is selected from C₁ to C₅ alkyl.

Representative N-alkyl(meth)acrylamides include but are not limited to N-methyl(meth)acrylamide, N-ethyl(meth)acrylamide, N-propyl(meth)acrylamide, N-isopropyl(meth)acrylamide, N-tert-butyl(meth)acrylamide, N-(2-hydroxyethyl)(meth)acrylamide, N-(3-hydroxypropyl)(meth)acrylamide, and mixtures thereof.

Representative N,N-dialkyl(meth)acrylamides include but are not limited to N,N-dimethyl(meth)acrylamide, N,N-diethyl(meth)acrylamide, N,N-(di-2-hydroxyethyl)(meth)acrylamide, N,N-(di-3-hydroxypropyl)(meth)acrylamide, N-methyl, N-ethyl(meth)acrylamide, and mixtures thereof.

Representative N,N-dialkylaminoalkyl(meth)acrylamides include but are not limited to N,N-dimethylaminoethyl(meth)acrylamide, N,N-diethylaminoethyl(meth)acrylamide, N,N-dimethylaminopropyl(meth)acrylamide, and mixtures thereof.

### Hydrophobic Monomer

Hydrophobic monomers suitable for the preparation of the nonionic, amphiphilic polymer compositions of the disclosed technology are selected from but are not limited to one or more of alkyl esters of (meth)acrylic acid having an alkyl group containing 1 to 30 carbon atoms; vinyl esters of aliphatic carboxylic acids containing 1 to 22 carbon atoms; vinyl ethers of alcohols containing 1 to 22 carbon atoms; vinyl aromatics containing 8 to 20 carbon atoms; vinyl halides; vinylidene halides; linear or branched alpha-monoolefins containing 2 to 8 carbon atoms; an associative monomer having a hydrophobic end group containing 8 to 30 carbon atoms, and mixtures thereof.

### Semi-Hydrophobic Monomer

Optionally, at least one alkoxylated semi-hydrophobic monomer can be used in the preparation of the amphiphilic polymers of the disclosed technology. A semi-hydrophobic monomer is similar in structure to an associative monomer, but has a substantially non-hydrophobic end group selected from hydroxyl or a moiety containing 1 to 4 carbon atoms.

In one aspect, of the disclosed technology, alkyl esters of (meth)acrylic acid having an alkyl group containing 1 to 22 carbon atoms can be represented by the following formula:

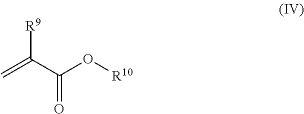

wherein R⁹ is hydrogen or methyl and R¹⁰ is C₁ to C₂₂ alkyl

Representative monomers under formula (IV) include but are not limited to methyl (meth)acrylate, ethyl (meth)acrylate, butyl (meth)acrylate, sec-butyl (meth)acrylate, iso-butyl (meth)acrylate, hexyl (meth)acrylate), heptyl (meth)acrylate, octyl (meth)acrylate, 2-ethylhexyl (meth)acrylate, decyl (meth)acrylate, isodecyl (meth)acrylate, lauryl (meth)acrylate, tetradecyl (meth)acrylate, hexadecyl (meth)acrylate, stearyl (meth)acrylate, behenyl (meth)acrylate, and mixtures thereof.

Vinyl esters of aliphatic carboxylic acids containing 1 to 22 carbon atoms can be represented by the following formula:

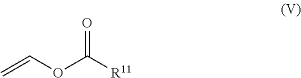

wherein R¹¹ is a C₁ to C₂₂ aliphatic group which can be an alkyl or alkenyl. Representative monomers under formula (V) include but are not limited to vinyl acetate, vinyl propionate, vinyl butyrate, vinyl isobutyrate, vinyl valerate, vinyl hexanoate, vinyl 2-methylhexanoate, vinyl 2-ethylhexanoate, vinyl iso-octanoate, vinyl nonanoate, vinyl neodecanoate, vinyl decanoate, vinyl versatate, vinyl laurate, vinyl palmitate, vinyl stearate, and mixtures thereof.

In one aspect, the vinyl ethers of alcohols containing 1 to 22 carbon atoms can be represented by the following formula:

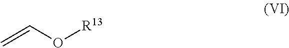

wherein R¹³ is a C₁ to C₂₂ alkyl. Representative monomers of formula (VI) include methyl vinyl ether, ethyl vinyl ether, butyl vinyl ether, isobutyl vinyl ether, 2-ethylhexyl vinyl ether, decyl vinyl ether, lauryl vinyl ether, stearyl vinyl ether, behenyl vinyl ether, and mixtures thereof.

Representative vinyl aromatic monomers include but are not limited to styrene, alpha-methylstyrene, 3-methyl styrene, 4-methyl styrene, 4-propyl styrene, 4-tert-butyl styrene, 4-n-butyl styrene, 4-n-decyl styrene, vinyl naphthalene, and mixtures thereof.

Representative vinyl and vinylidene halides include but are not limited to vinyl chloride and vinylidene chloride, and mixtures thereof.

Representative alpha-olefins include but are not limited to ethylene, propylene, 1-butene, iso-butylene, 1-hexene, and mixtures thereof.

The alkoxylated associative monomer of the disclosed technology has an ethylenically unsaturated end group portion (i) for addition polymerization with the other monomers of the disclosed technology; a polyoxyalkylene mid-section portion (ii) for imparting selective hydrophilic and/or hydrophobic properties to the product polymer, and a hydrophobic end group portion (iii) for providing selective hydrophobic properties to the polymer.

The portion (i) supplying the ethylenically unsaturated end group can be a residue derived from an α,β-ethylenically unsaturated monocarboxylic acid. Alternatively, portion (i) of the associative monomer can be a residue derived from an allyl ether or vinyl ether; a nonionic vinyl-substituted urethane monomer, such as disclosed in U.S. Reissue Pat. No. 33,156 or U.S. Pat. No. 5,294,692; or a vinyl-substituted urea reaction product, such as disclosed in U.S. Pat. No. 5,011,978; the relevant disclosures of each are incorporated herein by reference.

The mid-section portion (ii) is a polyoxyalkylene segment of about 2 to about 150 in one aspect, from about 10 to about 120 in another aspect, and from about 15 to about 60 in a further aspect of repeating C₂-C₄ alkylene oxide units. The mid-section portion (ii) includes polyoxyethylene, polyoxypropylene, and polyoxybutylene segments, and combinations thereof comprising from about 2 to about 150 in one aspect, from about 5 to about 120 in another aspect, from about 10 to about 60 in a further aspect, and from about 15 to about 30 in a still further aspect of ethylene, propylene and/or butylene oxide units, arranged in random or block sequences of ethylene oxide, propylene oxide and/or butylene oxide units.

The hydrophobic end group portion (iii) of the associative monomer is a hydrocarbon moiety belonging to one of the following hydrocarbon classes: a C₈-C₃₀ linear alkyl, a C₈-C₃₀ branched alkyl, a C₂-C₃₀ alkyl-substituted phenyl, aryl-substituted C₂-C₃₀ alkyl groups, a C₇-C₃₀ saturated or unsaturated carbocyclic alkyl group. The saturated or unsaturated carbocyclic moiety can be a C₁-C₅ alkyl substituted or unsubstituted monocyclic or bicyclic moiety. In one aspect the bicyclic moiety is selected from bicycloheptyl or bicycloheptenyl. In another aspect the bicycloheptenyl moiety is disubstituted with the alkyl substituent(s). In a further aspect the bicycloheptenyl moiety is disubstituted with methyl on the same carbon atom.

Non-limiting examples of suitable hydrophobic end group portions (iii) of the associative monomers are linear or branched alkyl groups having about 8 to about 30 carbon atoms, such as capryl (C₈), iso-octyl (branched C₈), decyl (C₁₀), lauryl (C₁₂), myristyl (C₁₄), cetyl (C₁₆), cetearyl (C₁₆-C₁₈), stearyl (C₁₈), isostearyl (branched C₁₈), arachidyl (C₂₀), behenyl (C₂₂), lignoceryl (C₂₄), cerotyl (C₂₆), montanyl (C₂₈), melissyl (C₃₀), and the like.

Examples of linear and branched alkyl groups having about 8 to about 30 carbon atoms that are derived from a natural source include, without being limited thereto, alkyl groups derived from hydrogenated peanut oil, soybean oil and canola oil (all predominately C₁₈), hydrogenated tallow oil (C₁₆-C₁₈), and the like; and hydrogenated C₁₀-C₃₀ terpenols, such as hydrogenated geraniol (branched C₁₀), hydrogenated farnesol (branched C₁₅), hydrogenated phytol (branched C₂₀), and the like.

Non-limiting examples of suitable C₂-C₃₀ alkyl-substituted phenyl groups include octylphenyl, nonylphenyl, decylphenyl, dodecylphenyl, hexadecylphenyl, octadecylphenyl, isooctylphenyl, sec-butylphenyl, and the like.

Exemplary aryl-substituted C₂-C₄₀ alkyl groups include, without limitation, styryl (e.g., 2-phenylethyl), distyryl (e.g., 2,4-diphenylbutyl), tristyryl (e.g., 2,4,6-triphenylhexyl), 4-phenylbutyl, 2-methyl-2-phenylethyl, tristyrylphenolyl, and the like.

Suitable C₇-C₃₀ carbocyclic groups include, without limitation, groups derived from sterols from animal sources, such as cholesterol, lanosterol, 7-dehydrocholesterol, and the like; from vegetable sources, such as phytosterol, stigmasterol, campesterol, and the like; and from yeast sources, such as ergosterol, mycosterol, and the like. Other carbocyclic alkyl hydrophobic end groups useful in the disclosed technology include, without limitation, cyclooctyl, cyclododecyl, adamantyl, decahydronaphthyl, and groups derived from natural carbocyclic materials, such as pinene, hydrogenated retinol, camphor, isobornyl alcohol, norbornyl alcohol, nopol and the like.

Useful alkoxylated associative monomers can be prepared by any method known in the art. See, for example, U.S. Pat. No. 4,421,902 to Chang et al.; No. 4,384,096 to Sonnabend; No. 4,514,552 to Shay et al.; No. 4,600,761 to Ruffner et al.; No. 4,616,074 to Ruffner; No. 5,294,692 to Barron et al.; No. 5,292,843 to Jenkins et al.; No. 5,770,760 to Robinson; No. 5,412,142 to Wilkerson, III et al.; and No. 7,772,421, to Yang et al., the pertinent disclosures of which are incorporated herein by reference.

In one aspect, exemplary alkoxylated associative monomers include those represented by formulas (VII) and (VIIA) as follows:

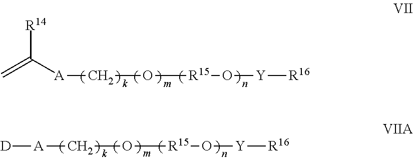

wherein R¹⁴ is hydrogen or methyl; A is —CH₂C(O)O—, —C(O)O—, —O—, —CH₂O—, —NHC(O)NH—, —C(O)NH—, —Ar—(CE₂)_{z}-NHC(O)O—, —Ar—(CE₂)_{z}-NHC(O)NH—, or —CH₂CH₂NHC(O)—; Ar is a divalent arylene (e.g., phenylene); E is H or methyl; z is 0 or 1; k is an integer ranging from about 0 to about 30, and m is 0 or 1, with the proviso that when k is 0, m is 0, and when k is in the range of 1 to about 30, m is 1; D represents a vinyl or an allyl moiety; (R¹⁵—O)ₙ is a polyoxyalkylene moiety, which can be a homopolymer, a random copolymer, or a block copolymer of C₂-C₄ oxyalkylene units, R¹⁵ is a divalent alkylene moiety selected from C₂H₄, C₃H₆, or C₄H₈, and combinations thereof; and n is an integer in the range of about 2 to about 150 in one aspect, from about 10 to about 120 in another aspect, and from about 15 to about 60 in a further aspect; Y is —R¹⁵O—, —R¹⁵NH—, —C(O)—, —C(O)NH—, —R¹⁵NHC(O)NH—, —C(O)NHC(O)—, or a divalent alkylene radical containing 1 to 5 carbon atoms, e.g., methylene, ethylene, propylene, butylene, pentylene; R¹⁶ is a substituted or unsubstituted alkyl selected from a C₈-C₃₀ linear alkyl, a C₈-C₃₀ branched alkyl, a C₇-C₃₀ carbocyclic, a C₂-C₃₀ alkyl-substituted phenyl, an araalkyl substituted phenyl, and an aryl-substituted C₂-C₃₀ alkyl; wherein the R¹⁶ alkyl group, aryl group, phenyl group, or carbocyclic group optionally comprises one or more substituents selected from the group consisting of a methyl group, a hydroxyl group, an alkoxyl group, benzyl group phenylethyl group, and a halogen group. In one aspect, Y is ethylene and R¹⁶ is

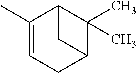

In one aspect, the hydrophobically modified alkoxylated associative monomer is an alkoxylated (meth)acrylate having a hydrophobic group containing 8 to 30 carbon atoms represented by the following Formula VIIB as follows:

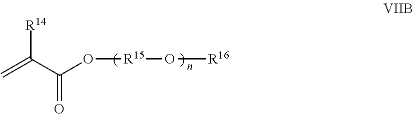

wherein R¹⁴ is hydrogen or methyl; R¹⁵ is a divalent alkylene moiety independently selected from C₂H₄, C₃H₆, and C₄H₈, and n represents an integer ranging from about 2 to about 150 in one aspect, from about 5 to about 120 in another aspect, from about 10 to about 60 in a further aspect, and from about 15 to about 30 in a still further aspect, (R¹⁵—O) can be arranged in a random or a block configuration; R¹⁶ is a substituted or unsubstituted alkyl selected from a C₈-C₃₀ linear alkyl, a C₈-C₃₀ branched alkyl, an alkyl substituted and unsubstituted C₇-C₃₀ carbocyclic alkyl, a C₂-C₃₀ alkyl-substituted phenyl, and an aryl-substituted C₂-C₃₀ alkyl.

Representative monomers under Formula VIIB include lauryl polyethoxylated (meth)acrylate (LEM), cetyl polyethoxylated (meth)acrylate (CEM), cetearyl polyethoxylated (meth)acrylate (CSEM), stearyl polyethoxylated (meth)acrylate, arachidyl polyethoxylated (meth)acrylate, behenyl polyethoxylated (meth)acrylate (BEM), cerotyl polyethoxylated (meth)acrylate, montanyl polyethoxylated (meth)acrylate, melissyl polyethoxylated (meth)acrylate, phenyl polyethoxylated (meth)acrylate, nonylphenyl polyethoxylated (meth)acrylate, ω-tristyrylphenyl polyoxyethylene (meth)acrylate, where the polyethoxylated portion of the monomer contains about 2 to about 150 ethylene oxide units in one aspect, from about 5 to about 120 in another aspect, from about 10 to about 60 in a further aspect and from about 15 to about 30 in a still further aspect; octyloxy polyethyleneglycol (8) polypropyleneglycol (6) (meth)acrylate, phenoxy polyethylene glycol (6) polypropylene glycol (6) (meth)acrylate, and nonylphenoxy polyethylene glycol polypropylene glycol (meth)acrylate.

The alkoxylated semi-hydrophobic monomers of the disclosed technology are structurally similar to the associative monomer described above, but have a substantially non-hydrophobic end group portion. The alkoxylated semi-hydrophobic monomer has an ethylenically unsaturated end group portion (i) for addition polymerization with the other monomers of the disclosed technology; a polyoxyalkylene mid-section portion (ii) for imparting selective hydrophilic and/or hydrophobic properties to the product polymer and a semi-hydrophobic end group portion (iii). The unsaturated end group portion (i) supplying the vinyl or other ethylenically unsaturated end group for addition polymerization is preferably derived from an α,β-ethylenically unsaturated mono carboxylic acid. Alternatively, the end group portion (i) can be derived from an allyl ether residue, a vinyl ether residue or a residue of a nonionic urethane monomer.

The polyoxyalkylene mid-section (ii) comprises a polyoxyalkylene segment, which is substantially similar to the polyoxyalkylene portion of the associative monomers described above. In one aspect, the polyoxyalkylene portions (ii) include polyoxyethylene, polyoxypropylene, and/or polyoxybutylene units comprising from about 2 to about 150 in one aspect, from about 5 to about 120 in another aspect, from about 10 to about 60, and from about 15 to about 30 in a still further aspect in a further aspect of ethylene oxide, propylene oxide, and/or butylene oxide units, arranged in random or blocky sequences.

In one aspect, the alkoxylated semi-hydrophobic monomer can be represented by the following formulas:

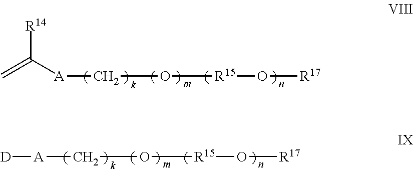

wherein R¹⁴ is hydrogen or methyl; A is —CH₂C(O)O—, —C(O)O—, —O—, —CH₂O—, —NHC(O)NH—, —C(O)NH—, —Ar—(CE₂)_{z}-NHC(O)O—, —Ar—(CE₂)_{z}-NHC(O)NH—, or —CH₂CH₂NHC(O)—; Ar is a divalent arylene (e.g., phenylene); E is H or methyl; z is 0 or 1; k is an integer ranging from about 0 to about 30, and m is 0 or 1, with the proviso that when k is 0, m is 0, and when k is in the range of 1 to about 30, m is 1; (R¹⁵—O)ₙ is a polyoxyalkylene moiety, which can be a homopolymer, a random copolymer, or a block copolymer of C₂-C₄ oxyalkylene units, R¹⁵ is a divalent alkylene moiety selected from C₂H₄, C₃H₆, or C₄H₈, and combinations thereof; and n is an integer in the range of about 2 to about 150 in one aspect, from about 5 to about 120 in another aspect, and from about 10 to about 60, and from about 15 to about 30 in a still further aspect in a further aspect; R¹⁷ is selected from hydrogen and a linear or branched C₁-C₄ alkyl group (e.g., methyl, ethyl, propyl, iso-propyl, butyl, iso-butyl, and tert-butyl); and D represents a vinyl or an allyl moiety.

In one aspect, the alkoxylated semi-hydrophobic monomer under formula VIII can be represented by the following formulas:

CH₂═C(R¹⁴)C(O)O—((C₂H₄O)ₐ(C₃H₆O)_{b}—H VIIIA

CH₂═C(R¹⁴)C(O)O—((C₂H₄O)ₐ(C₃H₆O)_{b}—CH₃ VIIIB

wherein R¹⁴ is hydrogen or methyl, and “a” is an integer ranging from 0 or 2 to about 120 in one aspect, from about 5 to about 45 in another aspect, and from about 10 to about 0.25 in a further aspect, and “b” is an integer ranging from about 0 or 2 to about 120 in one aspect, from about 5 to about 45 in another aspect, and from about 10 to about 25 in a further aspect, subject to the proviso that “a” and “b” cannot be 0 at the same time.

Examples of alkoxylated semi-hydrophobic monomers under formula VIIIA include polyethyleneglycol methacrylate available under the product names Blemmer® PE-90 (R¹⁴=methyl, a=2, b=0), PE-200 (R¹⁴=methyl, a=4.5, b=0), and PE-350 (R¹⁴=methyl a=8, b=0,); polypropylene glycol methacrylate available under the product names Blemmer® PP-1000 (R¹⁴=methyl, b=4-6, a=0), PP-500 (R¹⁴=methyl, a=0, b=9), PP-800 (R¹⁴=methyl, a=0, b=13); polyethyleneglycol polypropylene glycol methacrylate available under the product names Blemmer® 50PEP-300 (R¹⁴=methyl, a=3.5, b=2.5), 70PEP-350B (R¹⁴=methyl, a=5, b=2); polyethyleneglycol acrylate available under the product names Blemmer® AE-90 (R¹⁴=hydrogen, a=2, b=0), AE-200 (R¹⁴=hydrogen, a=2, b=4.5), AE-400 (R¹⁴=hydrogen, a=10, b=0); polypropyleneglycol acrylate available under the product names Blemmer® AP-150 (R¹⁴=hydrogen, a=0, b=3), AP-400(R¹⁴=hydrogen, a=0, b=6), AP-550 (R¹⁴=hydrogen, a=0, b=9). Blemmer® is a trademark of NOF Corporation, Tokyo, Japan.

Examples of alkoxylated semi-hydrophobic monomers under formula VIIIB include methoxypolyethyleneglycol methacrylate available under the product names Visiomer° MPEG 750 MA W (R¹⁴=methyl, a=17, b=0), MPEG 1005 MA W (R¹⁴=methyl, a=22, b=0), MPEG 2005 MA W (R¹⁴=methyl, a=45, b=0), and MPEG 5005 MAW (R¹⁴=methyl, a=113, b=0) from Evonik Röhm GmbH, Darmstadt, Germany); Bisomer® MPEG 350 MA (R¹⁴=methyl, a=8, b=0), and MPEG 550 MA (R¹⁴=methyl, a=12, b=0) from GEO Specialty Chemicals, Ambler Pa.; Blemmer® PME-100 (R¹⁴=methyl, a=2, b=0), PME-200 (R¹⁴=methyl, a=4, b=0), PME-400 (R¹⁴=methyl, a=9, b=0), PME-1000 (R¹⁴=methyl, a=23, b=0), PME-4000 (R¹⁴=methyl, a=90, b=0).

In one aspect, the alkoxylated semi-hydrophobic monomer set forth in formula IX can be represented by the following formulas:

CH₂═CH—O—(CH₂)_{d}—O—(C₃H₆O)ₑ—((C₂H₄O)_{f}—H IXA

CH₂═CH—CH₂—O—(C₃H₆O)_{g}—((C₂H₄O)ₕ—H IXB

wherein d is an integer of 2, 3, or 4; e is an integer in the range of from about 1 to about 10 in one aspect, from about 2 to about 8 in another aspect, and from about 3 to about 7 in a further aspect; f is an integer in the range of from about 5 to about 50 in one aspect, from about 8 to about 40 in another aspect, and from about 10 to about 30 in a further aspect; g is an integer in the range of from 1 to about 10 in one aspect, from about 2 to about 8 in another aspect, and from about 3 to about 7 in a further aspect; and h is an integer in the range of from about 5 to about 50 in one aspect, and from about 8 to about 40 in another aspect; e, f, g, and h can be 0 subject to the proviso that e and f cannot be 0 at the same time, and g and h cannot be 0 at the same time.

Monomers under formulas IXA and IXB are commercially available under the trade names Emulsogen® R109, R208, R307, RAL109, RAL208, and RAL307 sold by Clariant Corporation; BX-AA-E5P5 sold by Bimax, Inc.; and combinations thereof. EMULSOGEN7 R109 is a randomly ethoxylated/propoxylated 1,4-butanediol vinyl ether having the empirical formula CH₂═CH—O(CH₂)₄O(C₃H₆O)₄((C₂H₄O)₁₀H; Emulsogen® R208 is a randomly ethoxylated/propoxylated 1,4-butanediol vinyl ether having the empirical formula CH₂═CH—O(CH₂)₄O(C₃H₆O)₄((C₂H₄O)₂₀H; Emulsogen® R307 is a randomly ethoxylated/propoxylated 1,4-butanediol vinyl ether having the empirical formula CH₂═CH—O(CH₂)₄O(C₃H₆O)₄((C₂H₄O)₃₀H;; Emulsogen® RAL109 is a randomly ethoxylated/propoxylated allyl ether having the empirical formula CH₂═CHCH₂O(C₃H₆O)₄((C₂H₄O)₁₀H; Emulsogen® RAL208 is a randomly ethoxylated/propoxylated allyl ether having the empirical formula CH₂═CHCH₂O(C₃H₆O)₄((C₂H₄O)₂₀H; Emulsogen® RAL307 is a randomly ethoxylated/propoxylated allyl ether having the empirical formula CH₂═CHCH₂O(C₃H₆O)₄((C₂H₄O)₃₀H; and BX-AA-E5P5 is a randomly ethoxylated/propoxylated allyl ether having the empirical formula CH₂═CHCH₂O(C₃H₆O)5((C₂H₄O)₅H.

Referring to the alkoxylated associative and the alkoxylated semi-hydrophobic monomers of the disclosed technology, the polyoxyalkylene mid-section portion contained in these monomers can be utilized to tailor the hydrophilicity and/or hydrophobicity of the polymers in which they are included. For example, mid-section portions rich in ethylene oxide moieties are more hydrophilic while mid-section portions rich in propylene oxide moieties are more hydrophobic. By adjusting the relative amounts of ethylene oxide to propylene oxide moieties present in these monomers the hydrophilic and hydrophobic properties of the polymers in which these monomers are included can be tailored as desired.

The amount of alkoxylated associative and/or semi-hydrophobic monomer utilized in the preparation of the polymers of the present disclosed technology can vary widely and depends, among other things, on the final rheological and aesthetic properties desired in the polymer. When utilized, the monomer reaction mixture contains one or more monomers selected from the alkoxylated associative and/or semi-hydrophobic monomers disclosed above in amounts ranging from about 0 or 0.5 to about 10 wt. % in one aspect, and from about 1, 2 or 3 to about 5 wt. % in a further aspect, based on the weight of the total monomers.

### Ionizable Monomer

In one aspect of the disclosed technology, the nonionic, amphiphilic polymer compositions of the disclosed technology can be polymerized from a monomer composition including 0 to 15 wt. % of an ionizable and/or ionized monomer, based on the weight of the total monomers, so long as the yield stress and viscosity properties of the surfactant compositions in which the polymers of the disclosed technology are included are not deleteriously affected.

In another aspect, the amphiphilic polymer compositions of the disclosed technology can be polymerized from a monomer composition comprising less than 10 wt. % in one aspect, less than 5 wt. % in a further aspect, less than 2 wt. % in a still further aspect, less than 1 wt. % in an additional aspect, and less than 0.5 wt. % in a further aspect, and 0 wt. % in a still further aspect of an ionizable and/or an ionized moiety, based on the weight of the total monomers.

Ionizable monomers include monomers having a base neutralizable moiety and monomers having an acid neutralizable moiety. Base neutralizable monomers include olefinically unsaturated monocarboxylic and dicarboxylic acids and their salts containing 3 to 5 carbon atoms and anhydrides thereof. Examples include (meth)acrylic acid, itaconic acid, maleic acid, maleic anhydride, and combinations thereof. Other acidic monomers include styrenesulfonic acid, acrylamidomethylpropanesulfonic acid (AMPS° monomer), vinylsulfonic acid, vinylphosphonic acid, allylsulfonic acid, methallylsulfonic acid; and salts thereof.

Acid neutralizable monomers include olefinically unsaturated monomers which contain a basic nitrogen atom capable of forming a salt or a quaternized moiety upon the addition of an acid. For example, these monomers include vinylpyridine, vinylpiperidine, vinylimidazole, vinylmethylimidazole, dimethylaminomethyl (meth)acrylate, dimethylaminoethyl (meth)acrylate, diethylaminomethyl (meth)acrylate and methacrylate, dimethylaminoneopentyl (meth)acrylate, dimethylaminopropyl (meth)acrylate, and diethylaminoethyl (meth)acrylate.

### Crosslinking Monomer

In one embodiment, the crosslinked, nonionic, amphiphilic polymers useful in the practice of the disclosed technology are polymerized from a monomer composition comprising a first monomer comprising at least one nonionic, hydrophilic unsaturated monomer, at least one nonionic, unsaturated hydrophobic monomer, and mixtures thereof, and a third monomer comprising at least one polyunsaturated crosslinking monomer. The crosslinking monomer(s) is utilized to polymerize covalent crosslinks into the polymer backbone. The crosslinking monomer can be an amphiphilic crosslinking agent or a mixture of an amphiphilic crosslinking agent and a conventional crosslinking agent.

In one aspect, the crosslinking monomer is an amphiphilic crosslinking agent. The amphiphilic crosslinking agent is utilized to polymerize covalent crosslinks into the amphiphilic polymer backbone. In some instances, conventional crosslinking agents can affect the volume expansion or swelling of micro-gel particles in fluids containing surfactants. For example, a high level of conventional crosslinking agent could provide a high yield stress but the limited expansion of the micro-gels would result in undesirably high polymer use levels and low optical clarity. On the other hand, a low level of conventional crosslinking agents could give high optical clarity but low yield stress. It is desirable that polymeric micro-gels allow maximum swelling while maintaining a desirable yield stress, and it has been found that the use of amphiphilic crosslinking agents in place of, or in conjunction with conventional crosslinking agents can provide just these benefits. In addition, it has been found that the amphiphilic crosslinking agent can be easily reacted into the amphiphilic polymer. Often, certain processing techniques, such as staging, can be required with conventional crosslinking agents to achieve the proper balance of optical clarity and yield stress. In contrast, it has been found that amphiphilic crosslinking agents can simply be added in a single stage with the monomer mixture.

Amphiphilic crosslinking agents are a subset of compounds known in the art as reactive surfactants. Reactive surfactants are surface acting agents containing at least one reactive moiety so that they can covalently link to the surface of polymeric particles. By linking to particles, the reactive surfactants can improve the colloidal stability of latex particles due to the surfactant's resistance to desorbing from the particle surface. Reactive surfactants in the art commonly only have, or only need, one reactive moiety to prevent such desorption.

As a subset of reactive surfactants, amphiphilic crosslinking agents as used herein are those compounds or mixtures thereof that include more than one reactive moiety. It has surprisingly been found that such amphiphilic crosslinking agents not only can be employed to improve stability of particles, but can be efficiently employed to prepare yield stress fluids as described herein. In one aspect, the mixture of amphiphilic crosslinking agent contains more than one unsaturated moieties, or an average of 1.5 or 2 unsaturated moieties. In another aspect, the mixture of amphiphilic crosslinking agents contains an average of 2.5 unsaturated moieties. In still another aspect, the mixture of amphiphilic crosslinking agents contains an average of about 3 unsaturated moieties. In a further aspect, the mixture of amphiphilic crosslinking agents contains an average of about 3.5 unsaturated moieties.

In one aspect, exemplary amphiphilic crosslinking agents suitable for use with the present technology can include, but not be limited to, compounds such as those disclosed in US 2013/0047892 (published Feb. 28, 2013 to Palmer, Jr. et al.), represented by the following formulas:

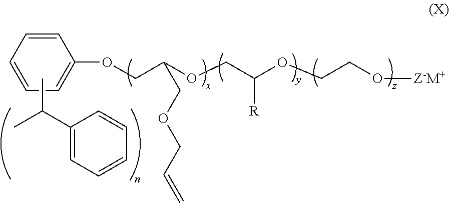

where R is CH₃, CH₂CH₃, C₆H₅, or C₁₄H₂₉; n is 1, 2, or 3; x is 2-10, y is 0-200, z is 4-200, more preferably from about 5 to 60, and most preferably from about 5 to 40; Z can be either SO₃⁻ or PO₃²⁻, and M⁺ is Na⁺, K⁺, NH₄⁺, or an alkanolammonium group such as, for example, monoethanolammonium, diethanolammonium, and triethanolammonium;

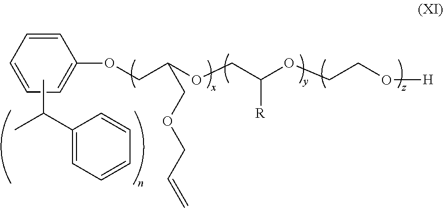

where R is CH₃, CH₂CH₃, C₆H₅, or C₁₄H₂₉; n is 1, 2, 3; x is 2-10, y is 0-200, z is 4-200, more preferably from about 5 to 60, and most preferably from about 5 to 40;

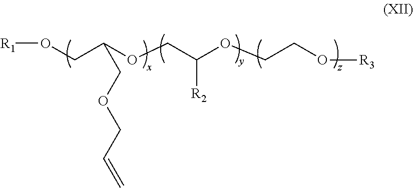

where R₁ is a C₁₀₋₂₄ alkyl, alkaryl, alkenyl, or cycloalkyl, R₂ is CH₃, CH₂CH₃, C₆H₅, or C₁₄H₂₉; x is 2-10, y is 0-200, z is 4-200, more preferably from about 5 to 60, and most preferably from about 5 to 40; and R₃ is H or Z⁻M⁺Z can be either SO₃⁻ or PO₃²⁻, and M⁺ is Na⁺, K⁺, NH₄⁺, or an alkanolamine such as, for example, monoethanolamine, diethanolamine, and triethanolamine.

The foregoing amphiphilic crosslinking agents conforming to formulas (X), (XI), (XII), (XIII) and (XIV) are disclosed in U.S. Patent Application Publication No. US 2014/0114006, the disclosure of which is herein incorporated by reference, and are commercially available under the E-Sperse™ RS Series trade name (e.g., product designations RS-1617, RS-1618, RS-1684) from Ethox Chemicals, LLC.

In one embodiment, the amphiphilic crosslinking agent can be used in an amount ranging from about 0.01 to about 3 wt. % in one aspect, from about 0.05 to about 0.1 wt. % in another aspect, and from about 0.1 to about 0.75 wt. % in a further aspect, based on the dry weight of the nonionic, amphiphilic polymer of the disclosed technology.

In another embodiment, the amphiphilic crosslinking agent can contain an average of about 1.5 or 2 unsaturated moieties and can be used in an amount ranging from about 0.01 to about 5 wt. % in one aspect, from about 0.02 to about 1 wt. % in another aspect, from about 0.05 to about 0.75 wt. % in a further aspect, and from about 0.075 to about 0.5 wt. % in a still further aspect, and from about 0.1 to about 0.15 wt. % in another aspect, based upon the total weight of the, nonionic, amphiphilic polymer of the disclosed technology.

In one aspect, the amphiphilic crosslinking agent is selected from compounds of formulas (XII), (XIII) or (XIV).

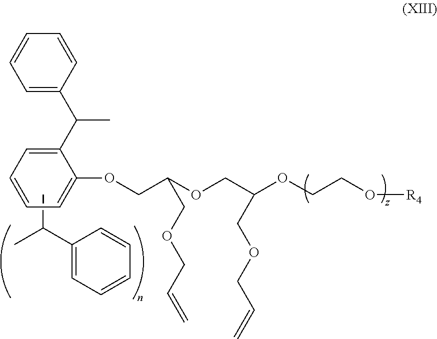

where n is 1 or 2; z is 4 to 40 in one aspect, 5 to 38 in another aspect, and 10 to 20 in a further aspect; and R₄ is H, SO₃⁻M⁺ or PO₃⁻M⁺, and M is selected from Na, K, and NH₄.

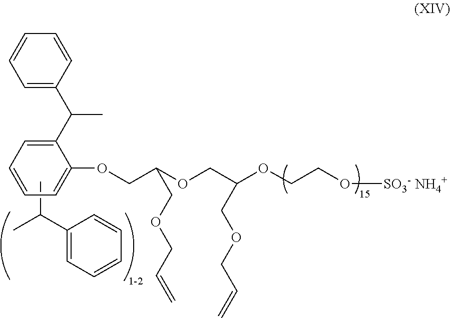

In one embodiment, the crosslinking monomer can include a combination of an amphiphilic crosslinking agent and a conventional crosslinking agent. In one aspect, the conventional crosslinking agent is a polyunsaturated compound containing at least 2 unsaturated moieties. In another aspect, the conventional crosslinking agent contains at least 3 unsaturated moieties. Exemplary polyunsaturated compounds include di(meth)acrylate compounds such as ethylene glycol di(meth)acrylate, polyethylene glycol di(meth)acrylate, triethylene glycol di(meth)acrylate, 1,3-butylene glycol di(meth)acrylate, 1,6-butylene glycol di(meth)acrylate, 1,6-hexanediol di(meth)acrylate, neopentyl glycol di(meth)acrylate, 1,9-nonanediol di(meth)acrylate, 2,2′-bis(4-(acryloxy-propyloxyphenyl)propane, and 2,2′-bis(4-(acryloxydiethoxy-phenyl)propane; tri(meth)acrylate compounds such as, trimethylolpropane tri(meth)acrylate, trimethylolethane tri(meth)acrylate, and tetramethylolmethane tri(meth)acrylate; tetra(meth)acrylate compounds such as ditrimethylolpropane tetra(meth)acrylate, tetramethylolmethane tetra(meth)acrylate, and pentaerythritol tetra(meth)acrylate; hexa(meth)acrylate compounds such as dipentaerythritol hexa(meth)acrylate; allyl compounds such as allyl (meth)acrylate, diallylphthalate, diallyl itaconate, diallyl fumarate, and diallyl maleate; polyallyl ethers of sucrose having from 2 to 8 allyl groups per molecule, polyallyl ethers of pentaerythritol such as pentaerythritol diallyl ether, pentaerythritol triallyl ether, and pentaerythritol tetraallyl ether, and combinations thereof; polyallyl ethers of trimethylolpropane such as trimethylolpropane diallyl ether, trimethylolpropane triallyl ether, and combinations thereof. Other suitable polyunsaturated compounds include divinyl glycol, divinyl benzene, and methylenebisacrylamide.

In another aspect, suitable conventional polyunsaturated monomers can be synthesized via an esterification reaction of a polyol made from ethylene oxide or propylene oxide or combinations thereof with unsaturated anhydride such as maleic anhydride, citraconic anhydride, itaconic anhydride, or an addition reaction with unsaturated isocyanate such as 3-isopropenyl-α-α-dimethylbenzene isocyanate.

Mixtures of two or more of the foregoing conventional polyunsaturated crosslinking monomers can also be utilized to crosslink the nonionic, amphiphilic polymers of the disclosed technology. In one aspect, the mixture of conventional unsaturated crosslinking monomers contains an average of 2 unsaturated moieties. In another aspect, the mixture of conventional crosslinking monomers contains an average of 2.5 unsaturated moieties. In still another aspect, the mixture of conventional crosslinking monomers contains an average of about 3 unsaturated moieties. In a further aspect, the mixture of conventional crosslinking monomers contains an average of about 3.5 unsaturated moieties.

In one embodiment of the disclosed technology, the amount of the conventional crosslinking monomer ranges from 0 to about 1 wt. % in one aspect, from about 0.01 to about 0.75 wt. % in another aspect, from about 0.1 to about 0.5 in still another aspect, and from about 0.15 to about 0.3 wt. % in a still further aspect, all weight percentages are based on the weight of the monomer composition.

In another embodiment of the disclosed technology, the conventional crosslinking monomer component contains an average of about 3 unsaturated moieties and can be used in an amount ranging from about 0.01 to about 0.3 wt. % in one aspect, from about 0.02 to about 0.25 wt. % in another aspect, from about 0.05 to about 0.2 wt. % in a further aspect, and from about 0.075 to about 0.175 wt. % in a still further aspect, and from about 0.1 to about 0.15 wt. % in another aspect, based on the weight of the monomer composition.

In one aspect, the conventional crosslinking monomer is selected from trimethylolpropane tri(meth)acrylate, trimethylolethane tri(meth)acrylate, tetramethylolmethane tri(meth)acrylate, pentaerythritol triallylether and polyallyl ethers of sucrose having 3 allyl groups per molecule.

In one aspect, the combination of the conventional crosslinking agent and amphiphilic crosslinking agent can contain an average of about 2 or 3 unsaturated moieties and can be used in an amount ranging from about 0.01 to about 2 wt. % in one aspect, from about 0.02 to about 0.3 wt. % in another aspect, from about 0.05 to about 0.2 wt. % in a further aspect, and from about 0.075 to about 0.175 wt. % in a still further aspect, and from about 0.1 to about 0.15 wt. % in another aspect, based upon the total weight of the, nonionic, amphiphilic polymer of the disclosed technology.

### Amphiphilic Polymer Synthesis

The crosslinked, nonionic, amphiphilic, polymers of the disclosed technology can be made using conventional free-radical emulsion polymerization techniques. The polymerization processes are carried out in the absence of oxygen under an inert atmosphere such as nitrogen. The polymerization can be carried out in a suitable solvent system such as water. Minor amounts of a hydrocarbon solvent, organic solvent, as well as mixtures thereof can be employed. The polymerization reactions are initiated by any means which results in the generation of a suitable free-radical. Thermally derived radicals, in which the radical species is generated from thermal, homolytic dissociation of peroxides, hydroperoxides, persulfates, percarbonates, peroxyesters, hydrogen peroxide and azo compounds can be utilized. The initiators can be water soluble or water insoluble depending on the solvent system employed for the polymerization reaction.

The initiator compounds can be utilized in an amount of up to 30 wt. % in one aspect, 0.01 to 10 wt. % in another aspect, and 0.2 to 3 wt. % in a further aspect, based on the total weight of the dry polymer.

Exemplary free radical water soluble initiators include, but are not limited to, inorganic persulfate compounds, such as ammonium persulfate, potassium persulfate, and sodium persulfate; peroxides such as hydrogen peroxide, benzoyl peroxide, acetyl peroxide, and lauryl peroxide; organic hydroperoxides, such as cumene hydroperoxide and t-butyl hydroperoxide; organic peracids, such as peracetic acid, and water soluble azo compounds, such as 2,2′-azobis(tert-alkyl) compounds having a water solubilizing substituent on the alkyl group. Exemplary free radical oil soluble compounds include, but are not limited to 2,2′-azobisisobutyronitrile, and the like. The peroxides and peracids can optionally be activated with reducing agents, such as sodium bisulfite, sodium formaldehyde, or ascorbic acid, transition metals, hydrazine, and the like.

In one aspect, azo polymerization catalysts include the Vazo® free-radical polymerization initiators, available from DuPont, such as Vazo® 44 (2,2′-azobis(2-(4,5-dihydroimidazolyl)propane), Vazo® 56 (2,2′-azobis(2-methylpropionamidine) dihydrochloride), Vazo® 67 (2,2′-azobis(2-methylbutyronitrile)), and Vazo® 68 (4,4′-azobis(4-cyanovaleric acid)).

In emulsion polymerization processes, it can be advantageous to stabilize the monomer/polymer droplets or particles by means of surface active auxiliaries. Typically, these are emulsifiers or protective colloids. Emulsifiers used can be anionic, nonionic, cationic or amphoteric. Examples of anionic emulsifiers are alkylbenzenesulfonic acids, sulfonated fatty acids, sulfosuccinates, fatty alcohol sulfates, alkylphenol sulfates and fatty alcohol ether sulfates. Examples of usable nonionic emulsifiers are alkylphenol ethoxylates, primary alcohol ethoxylates, fatty acid ethoxylates, alkanolamide ethoxylates, fatty amine ethoxylates, EO/PO block copolymers and alkylpolyglucosides. Examples of cationic and amphoteric emulsifiers used are quaternized amine alkoxylates, alkylbetaines, alkylamidobetaines and sulfobetaines.

Optionally, the use of known redox initiator systems as polymerization initiators can be employed. Such redox initiator systems include an oxidant (initiator) and a reductant. Suitable oxidants include, for example, hydrogen peroxide, sodium peroxide, potassium peroxide, t-butyl hydroperoxide, t-amyl hydroperoxide, cumene hydroperoxide, sodium perborate, perphosphoric acid and salts thereof, potassium permanganate, and ammonium or alkali metal salts of peroxydisulfuric acid, typically at a level of 0.01% to 3.0% by weight, based on dry polymer weight, are used. Suitable reductants include, for example, alkali metal and ammonium salts of sulfur-containing acids, such as sodium sulfite, bisulfite, thiosulfate, hydrosulfite, sulfide, hydrosulfide or dithionite, formadinesulfinic acid, hydroxymethanesulfonic acid, acetone bisulfite, amines such as ethanolamine, glycolic acid, glyoxylic acid hydrate, ascorbic acid, isoascorbic acid, lactic acid, glyceric acid, malic acid, 2-hydroxy-2-sulfinatoacetic acid, tartaric acid and salts of the preceding acids typically at a level of 0.01% to 3.0% by weight, based on dry polymer weight, is used. In one aspect, combinations of peroxodisulfates with alkali metal or ammonium bisulfites can be used, for example, ammonium peroxodisulfate and ammonium bisulfite. In another aspect, combinations of hydrogen peroxide containing compounds (t-butyl hydroperoxide) as the oxidant with ascorbic or erythorbic acid as the reductant can be utilized. The ratio of peroxide-containing compound to reductant is within the range from 30:1 to 0.05:1.

Examples of typical protective colloids are cellulose derivatives, polyethylene glycol, polypropylene glycol, copolymers of ethylene glycol and propylene glycol, polyvinyl acetate, poly(vinyl alcohol), partially hydrolyzed poly(vinyl alcohol), polyvinyl ether, starch and starch derivatives, dextran, polyvinylpyrrolidone, polyvinylpyridine, polyethyleneimine, polyvinylimidazole, polyvinylsuccinimide, polyvinyl-2-methylsuccinimide, polyvinyl-1,3-oxazolid-2-one, polyvinyl-2-methylimidazoline and maleic acid or anhydride copolymers. The emulsifiers or protective colloids are customarily used in concentrations from 0.05 to 20 wt. %, based on the weight of the total monomers.

The polymerization reaction can be carried out at temperatures ranging from 20 to 200° C. in one aspect, from 50 to 150° C. in another aspect, and from 60 to 100° C. in a further aspect.

The polymerization can be carried out the presence of chain transfer agents. Suitable chain transfer agents include, but are not limited to, thio- and disulfide containing compounds, such as C₁-C₁₈ alkyl mercaptans, such as tert-butyl mercaptan, n-octyl mercaptan, n-dodecyl mercaptan, tert-dodecyl mercaptan hexadecyl mercaptan, octadecyl mercaptan; mercaptoalcohols, such as 2-mercaptoethanol, 2-mercaptopropanol; mercaptocarboxylic acids, such as mercaptoacetic acid and 3-mercaptopropionic acid; mercaptocarboxylic acid esters, such as butyl thioglycolate, isooctyl thioglycolate, dodecyl thioglycolate, isooctyl 3-mercaptopropionate, and butyl 3-mercaptopropionate; thioesters; C₁-C₁₈ alkyl disulfides; aryldisulfides; polyfunctional thiols such as trim ethylolpropane-tris-(3-mercaptopropionate), pentaerythritol-tetra-(3-mercaptopropionate), pentaerythritol-tetra-(thioglycolate), pentaerythritol-tetra-(thiolactate), dipentaerythritol-hexa-(thioglycolate), and the like; phosphites and hypophosphites; C₁-C₄ aldehydes, such as formaldehyde, acetaldehyde, propionaldehyde; haloalkyl compounds, such as carbon tetrachloride, bromotrichloromethane, and the like; hydroxylammonium salts such as hydroxylammonium sulfate; formic acid; sodium bisulfite; isopropanol; and catalytic chain transfer agents such as, for example, cobalt complexes (e.g., cobalt (II) chelates).

The chain transfer agents are generally used in amounts ranging from 0.1 to 10 wt. %, based on the total weight of the monomers present in the polymerization medium.

### Emulsion Process

In one exemplary aspect of the disclosed technology, the crosslinked, nonionic, amphiphilic polymer is polymerized via an emulsion process. The emulsion process can be conducted in a single reactor or in multiple reactors as is well-known in the art. The monomers can be added as a batch mixture or each monomer can be metered into the reactor in a staged process. A typical mixture in emulsion polymerization comprises water, monomer(s), an initiator (usually water-soluble) and an emulsifier. The monomers may be emulsion polymerized in a single-stage, two-stage or multi-stage polymerization process according to well-known methods in the emulsion polymerization art. In a two-stage polymerization process, the first stage monomers are added and polymerized first in the aqueous medium, followed by addition and polymerization of the second stage monomers. The aqueous medium optionally can contain an organic solvent. If utilized the organic solvent is less than about 5 wt. % of the aqueous medium. Suitable examples of water-miscible organic solvents include, without limitation, esters, alkylene glycol ethers, alkylene glycol ether esters, lower molecular weight aliphatic alcohols, and the like.

To facilitate emulsification of the monomer mixture, the emulsion polymerization is carried out in the presence of at least one surfactant. In one embodiment, the emulsion polymerization is carried out in the presence of surfactant (active weight basis) ranging in the amount of about 0.2% to about 5% by weight in one aspect, from about 0.5% to about 3% in another aspect, and from about 1% to about 2% by weight in a further aspect, based on a total monomer weight basis. The emulsion polymerization reaction mixture also includes one or more free radical initiators which are present in an amount ranging from about 0.01% to about 3% by weight based on total monomer weight. The polymerization can be performed in an aqueous or aqueous alcohol medium. Surfactants for facilitating the emulsion polymerization include anionic, nonionic, amphoteric, and cationic surfactants, as well as mixtures thereof. Most commonly, anionic and nonionic surfactants can be utilized as well as mixtures thereof.

Suitable anionic surfactants for facilitating emulsion polymerizations are well known in the art and include, but are not limited to (C₆-C₁₈) alkyl sulfates, (C₆-C₁₈) alkyl ether sulfates (e.g., sodium lauryl sulfate and sodium laureth sulfate), amino and alkali metal salts of dodecylbenzenesulfonic acid, such as sodium dodecyl benzene sulfonate and dimethylethanolamine dodecylbenzenesulfonate, sodium (C₆-C₁₆) alkyl phenoxy benzene sulfonate, disodium (C₆-C₁₆) alkyl phenoxy benzene sulfonate, disodium (C₆-C₁₆) di-alkyl phenoxy benzene sulfonate, disodium laureth-3 sulfosuccinate, sodium dioctyl sulfosuccinate, sodium di-sec-butyl naphthalene sulfonate, disodium dodecyl diphenyl ether sulfonate, disodium n-octadecyl sulfosuccinate, phosphate esters of branched alcohol ethoxylates, and the like.

Nonionic surfactants suitable for facilitating emulsion polymerizations are well known in the polymer art, and include, without limitation, linear or branched C₈-C₃₀ fatty alcohol ethoxylates, such as capryl alcohol ethoxylate, lauryl alcohol ethoxylate, myristyl alcohol ethoxylate, cetyl alcohol ethoxylate, stearyl alcohol ethoxylate, cetearyl alcohol ethoxylate, sterol ethoxylate, oleyl alcohol ethoxylate, and, behenyl alcohol ethoxylate; alkylphenol alkoxylates, such as octylphenol ethoxylates; and polyoxyethylene polyoxypropylene block copolymers, and the like. Additional fatty alcohol ethoxylates suitable as non-ionic surfactants are described below. Other useful nonionic surfactants include C₈-C₂₂ fatty acid esters of polyoxyethylene glycol, ethoxylated mono- and diglycerides, sorbitan esters and ethoxylated sorbitan esters, C₈-C₂₂ fatty acid glycol esters, block copolymers of ethylene oxide and propylene oxide, and combinations thereof. The number of ethylene oxide units in each of the foregoing ethoxylates can range from 2 and above in one aspect, and from 2 to about 150 in another aspect.

Optionally, other emulsion polymerization additives and processing aids which are well known in the emulsion polymerization art, such as auxiliary emulsifiers, protective colloids, solvents, buffering agents, chelating agents, inorganic electrolytes, polymeric stabilizers, biocides, and pH adjusting agents can be included in the polymerization system.

In one aspect of the disclosed technology, the protective colloid or auxiliary emulsifier is selected from poly(vinyl alcohol) that has a degree of hydrolysis ranging from about 80 to about 95% in one aspect, and from about 85 to about 90% in another aspect.

In a typical two stage emulsion polymerization, a mixture of the monomers is added to a first reactor under inert atmosphere to a solution of emulsifying surfactant (e.g., anionic surfactant) in water. Optional processing aids can be added as desired (e.g., protective colloids, auxiliary emulsifier(s)). The contents of the reactor are agitated to prepare a monomer emulsion. To a second reactor equipped with an agitator, an inert gas inlet, and feed pumps are added under inert atmosphere a desired amount of water and additional anionic surfactant and optional processing aids. The contents of the second reactor are heated with mixing agitation. After the contents of the second reactor reaches a temperature in the range of about 55 to 98° C., a free radical initiator is injected into the so formed aqueous surfactant solution in the second reactor, and the monomer emulsion from the first reactor is gradually metered into the second reactor over a period typically ranging from about one half to about four hours. The reaction temperature is controlled in the range of about 45 to about 95° C. After completion of the monomer addition, an additional quantity of free radical initiator can optionally be added to the second reactor, and the resulting reaction mixture is typically held at a temperature of about 45 to 95° C. for a time period sufficient to complete the polymerization reaction to obtain the polymer emulsion.

In one aspect, the crosslinked, nonionic, amphiphilic polymers of the disclosed technology are selected from an emulsion polymer polymerized from a monomer mixture comprising from about 20 to about 60 wt. % of at least one C₁-C₄ hydroxyalkyl (meth)acrylate (e.g., hydroxyethyl methacrylate); from about 10 to about 70 wt. % of at least one C₁-C₁₂ alkyl (meth)acrylate in one aspect or from about 10 to about 70 wt. % of at least one C₁-C₅ alkyl (meth)acrylate in another aspect; from about 0, 1, 5 or 15 to about 40 wt. % of at least one vinyl ester of a C₁-C₁₀ carboxylic acid, from about 0, 1 or 15 to about 30 wt. % of a vinyl lactam (e.g., vinyl pyrrolidone); from about 0, 0.1, 1, 5, or 7 to about 15 wt. % of at least one associative and/or a semi-hydrophobic monomer (wherein all monomer weight percentages are based on the weight of the total monomers); and from about 0.01 to about 5 wt. % in one aspect, from about 0.1 to about 3 in another aspect, and from about 0.5 to about 1 wt. % in a further aspect of at least one crosslinker (based on the dry weight of the polymer), wherein the at least one crosslinker is selected from an amphiphilic crosslinking agent or a combination of an amphiphilic crosslinking agent and a conventional crosslinking agent as defined herein.

In another aspect, the crosslinked, nonionic, amphiphilic polymers of the disclosed technology are selected from an emulsion polymer polymerized from a monomer mixture comprising from about 20 to about 50 wt. % at least one C₁-C₄ hydroxyalkyl (meth)acrylate (e.g., hydroxyethyl methacrylate); from about 10 to about 40 wt. % ethyl acrylate; from about 10 to about 35 wt. % butyl acrylate; from about 0 or 15 to about 25 wt. % of a vinyl ester of a C₁-C₅ carboxylic acid selected from vinyl formate, vinyl acetate, vinyl propionate, vinyl butyrate, vinyl isobutyrate, and vinyl valerate; from about 0, 1 or 15 to about 30 wt. % of vinyl pyrrolidone; and from about 0, 0.1, 1, 5 or 7 to about 15 wt. % of at least one associative monomer and/or semi-hydrophobic monomer (wherein all monomer weight percentages are based on the weight of the total monomers); and from about 0.01 to about 5 wt. % in one aspect, from about 0.1 to about 3 in another aspect, and from about 0.5 to about 1 in a further aspect of at least one crosslinker (based on the dry weight of the polymer), wherein the at least one crosslinker is selected from an amphiphilic crosslinking agent or a combination of an amphiphilic crosslinking agent and a conventional crosslinking agent as defined herein.

In one aspect, the crosslinked, nonionic, amphiphilic polymers of the disclosed technology are selected from an emulsion polymer polymerized from a monomer mixture comprising from about 40 to 50 wt. % of hydroxyethyl (meth)acrylate, 30 to 40 wt. % of ethyl acrylate, 10 to 20 wt. % of butyl acrylate and from about 1 to about 5 wt. % of at least one associative and/or semi-hydrophobic monomer (based on the weight of the total monomers), and from about 0.01 to about 5 wt. % in one aspect, from about 0.1 to about 3 in another aspect, and from about 0.5 to about 1 in a further aspect of at least one crosslinker (based on the dry weight of the polymer), wherein the at least one crosslinker is selected from an amphiphilic crosslinking agent or a combination of an amphiphilic crosslinking agent and a conventional crosslinking agent as defined herein.

In another embodiment, the crosslinked, nonionic, amphiphilic polymers of the disclosed technology are selected from an emulsion polymer polymerized from a monomer mixture comprising from about 20 to about 50 wt. % of hydroxyethyl methacrylate; from about 10 to about 30 wt. % ethyl acrylate; from about 10 to about 30 wt. % butyl acrylate; from about 0, 1, or 15 to about 25 wt. % of vinyl pyrrolidone; from about 0 or 15 to about 25 wt. % of vinyl acetate; from about 0, 0.1, 1, 5 or 7 to about 10 wt. % of at least one associative and/or semi-hydrophobic monomer (wherein all monomer weight percentages are based on the weight of the total monomers); and from about 0.01 to about 5 wt. % in one aspect, from about 0.1 to about 3 wt. % in another aspect, and from about 0.5 to about 1 wt. % in a further aspect of at least one crosslinker (based on the dry weight of the polymer), wherein the at least one crosslinker is selected from an amphiphilic crosslinking agent or a combination of an amphiphilic crosslinking agent and a conventional crosslinking agent as defined herein.

In one aspect, the crosslinked, nonionic, amphiphilic polymers of the disclosed technology are selected from an emulsion polymer polymerized from a monomer mixture comprising from about 20 to 50 wt. % of hydroxyethyl methacrylate; from about 10 to about 30 wt. % ethyl acrylate; from about 10 to about 30 wt. % butyl acrylate; from about 1 to about 10 wt. % of at least one associative and/or semi-hydrophobic monomer (wherein all monomer weight percentages are based on the weight of the total monomers); and from about 0.01 to about 5 wt. % in one aspect, from about 0.1 to about 3 wt. % in another aspect, and from about 0.5 to about 1 wt. % in a further aspect of at least one crosslinker (based on the dry weight of the polymer), wherein the at least one crosslinker is selected from an amphiphilic crosslinking agent or a combination of an amphiphilic crosslinking agent and a conventional crosslinking agent as defined herein.

In one aspect, the crosslinked, nonionic, amphiphilic polymers of the disclosed technology are selected from an emulsion polymer polymerized from a monomer mixture comprising from about 20 to 35 wt. % of hydroxyethyl methacrylate, from about 10 to about 30 wt. % ethyl acrylate, from about 10 to about 30 wt. % butyl acrylate, from about 15 to about 25 wt. % of vinyl pyrrolidone, from about 15 to about 25 wt. % of vinyl acetate (wherein all monomer weight percentages are based on the weight of the total monomers), and from about 0.01 to about 5 wt. % in one aspect, from about 0.1 to about 3 wt. % in another aspect, and from about 0.5 to about 1 wt. % in a further aspect of at least one crosslinker (based on the dry weight of the polymer), wherein the at least one crosslinker is selected from an amphiphilic crosslinking agent or a combination of an amphiphilic crosslinking agent and a conventional crosslinking agent as defined herein.

In one aspect, the at least one nonionic, amphiphilic polymer utilized in formulating the liquid laundry detergent compositions of the disclosed technology is crosslinked. The crosslinked nonionic, amphiphilic polymers of the technology are random copolymers and have weight average molecular weights ranging from above about 500,000 to at least about a billion Daltons or more in one aspect, and from about 600,000 to about 4.5 billion Daltons in another aspect, and from about 1,000,000 to about 3,000,000 Daltons in a further aspect, and from about 1,500,000 to about 2,000,000 Daltons in a still further aspect (see TDS-222, Oct. 15, 2007, Lubrizol Advanced Materials, Inc., which is herein incorporated by reference).

### Aqueous Carrier

The liquid heavy-duty laundry detergent compositions according to the present technology can be in a “concentrated form”, in such case, the liquid compositions according to the present technology will contain a lower amount of water compared to conventional liquid detergents. Typically the water content of the concentrated liquid composition is 80 wt. % or less in one aspect, 75 wt. % or less in another aspect 70 wt. % or less in still another aspect, 65 wt. % or less in a further aspect, 60 wt. % or less in a still further aspect, 55 wt. % or less in an additional aspect 40 wt. % or less in a still additional aspect, and 35 wt. % or less in a further additional aspect, based on the weight of the total composition.

In one aspect, the aqueous carrier comprises deionized water, although water from natural, municipal or commercial sources can be utilized as long as any mineral cations that may be present in such water do not deleteriously affect the intended function of any of the components contained in the laundry composition.

In addition to the at least one nonionic, amphiphilic polymer and the surfactant(s), the liquid detergents or cleaners may comprise additional ingredients (adjuvants or benefit agents) which further improve the application and/or aesthetic properties of the liquid detergent or cleaner. As a rule, in addition to the thickener and surfactant(s), preferred compositions comprise one or more substances from the group of builders, electrolytes, bleaches, bleach activators, enzymes, nonaqueous cosolvents, pH adjusting agents, perfume, perfume carriers, fluorescent brighteners, suds suppressors, hydrotopes, anti-redeposition agents, optical brighteners, dye transfer inhibitors, antimicrobial active ingredients, auxiliary rheology modifiers, antioxidants, corrosion inhibitors, fabric softeners, and UV absorbers.

### Cosolvent

In addition to water the aqueous carrier can comprise water miscible cosolvents. Cosolvents can aid in the dissolution of various nonionic laundry detergent adjuvants that require dissolution in the liquid phase. Suitable cosolvents include the lower alcohols such as ethanol and isopropanol but can be any lower monohydric alcohol containing up to 5 carbon atoms. Some or all of the alcohol may be replaced with dihydric or trihydric lower alcohols or glycol ethers which in addition to providing solubilizing properties and reducing the flash point of the product, also can provide anti-freezing attributes as well as to improve the compatibility of the solvent system with particular laundry detergent adjuvants. Exemplary dihydric and trihydric lower alcohols and glycol ethers are glycol, propanediol (e.g., propylene glycol, 1,3-propane diol), butanediol, glycerol, diethylene glycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl ether monoethyl ether, diisopropylene glycol monomethyl ether, diisopropylene glycol monoethyl ether, methoxytriglycol, ethoxytriglycol, butoxytriglycol, isobutoxyethoxy-2-propanol, 3-methyl-3-methoxybutanol, propylene glycol t-butyl ether, and mixtures of these solvents The amount of cosolvent(s) if utilized can range from about 0.5 to about 15 wt. % in one aspect, from about 1 to about 10 wt. % in another aspect, and from about 2 to about 5 wt. % in a further aspect, based on the weight of the total composition.

### Hydrotrope

The heavy-duty liquid detergent compositions optionally comprise a hydrotrope to aid in the compatibility of the liquid detergent with water. In one aspect, suitable hydrotropes include but are not limited to the anionic hydrotropes such as, for example, the sodium, potassium, ammonium, monoethanolamine, and triethanolamine salts of benzene sulfonate, xylene sulfonate, toluene sulfonate, cumene sulfonate, and mixtures thereof. In one aspect, nonionic hydrotropes such as glycerin, urea and alkanolamines (e.g., triethanolamine) can be employed.

In one aspect, the liquid detergent composition may comprise a hydrotrope when the total amount of surfactant contained in the detergent composition is above about 25 wt. % in one aspect above about 27 wt. % in another aspect, above about 30 wt. % in still another aspect, above about 33, 35, 37, 40, 45, 50, 55, 60, 65 wt. % in a further aspect, based on the weight of the total composition.

The amount of hydrotrope can range from about 0 to about 10 wt. % in one aspect, from about 0.1 to about 5 wt. % in another aspect, from about 0.2 to about 4 wt. % in a further aspect, and from about 0.5 to about 3 wt. % in a still further aspect, based on the weight of the total composition.

### Builders/Electrolytes

In one aspect of the present technology, the heavy-duty liquid detergent compositions may optionally comprise dissolved or suspended builders and electrolytes. The builder can be any material that is capable of reducing the level of alkaline earth metal ions, particularly, magnesium and calcium in the wash water. Builders also can provide other beneficial properties such as generation of an alkaline pH and aiding in the suspension of soil removed from the fabric. The electrolyte that may be utilized can be any water-soluble salt. The electrolyte may also be a detergency builder, e.g., sodium tripolyphosphate, or it may be a non-functional electrolyte to promote the solubility of other electrolytes, for example, potassium salts can be used to promote the solubility of sodium salts enabling the amount of dissolved electrolyte to be increased considerably. Suitable builders include those which are commonly used in detergents, e.g., zeolites (aluminosilicate), crystalline and amorphous silicates, carbonates, phosphorous containing compositions, borates, as well as organic based builders.

A suitable zeolite or aluminosilicate which is useful in the compositions of the present technology is an amorphous water insoluble hydrated compound of the formula (NaAlO₂)ₓ(SiO₂)_{y}, wherein x is a number from 1.0 to 1.2 and y is 1, the amorphous material can be further characterized by a Mg⁺² exchange capacity of from about 50 mg eq. CaCO₃/g. and a particle diameter of from about 0.01 to about 5 μm (volume distribution; measurement method: Coulter counter). This ion exchange builder is more fully described in British Patent No. 1,470,250. In another aspect, a water insoluble synthetic aluminosilicate ion exchange material useful herein is crystalline and conforms to the formula Na_{z}[(AlO₂)_{y}.(SiO₂)]xH₂O, wherein z and y are integers of at least 6; the molar ratio of z to y is in the range from 1.0 to about 0.5, and x is an integer from about 15 to about 264, the aluminosilicate ion exchange material can be further characterized as having a particle size diameter from about 0.1 to about 100 μm (volume distribution; measurement method: Coulter counter); a calcium ion exchange capacity on an anhydrous basis of at least about 200 mg equivalent of CaCO₃ hardness per gram; and a calcium exchange rate on an anhydrous basis of at least about 2 grains/gallon/minute/gram. These synthetic aluminosilicates are more fully described in British Patent No. 1,429,143.

In one aspect, suitable silicates include crystalline, sheetlike sodium silicates having the general formula NaMSiₓO₂ₓ₊₁.H₂O, where M denotes sodium or hydrogen, x is a number from 1.9 to 4, and y is a number from 0 to 20. Crystalline silicates or phyllosilicates of this kind are described, for example, in European Patent Application EP-A-0 164 514. In one aspect, M is sodium and x represents a value of 2 or 3.

In one aspect, suitable silicates include amorphous sodium silicates having a Na₂O:SiO₂ modulus of from 1:2 to 1:3.3, and which are dissolution-retarded and have secondary detergency properties. The retardation of dissolution relative to conventional amorphous sodium silicates may have been brought about in a variety of ways, for example, by surface treatment, compounding, compacting or overdrying.

Representative carbonates include alkali metal carbonates and bicarbonates, such as, for example, sodium carbonate, potassium carbonate, sodium sesquicarbonate, sodium bicarbonate and potassium bicarbonate.

Exemplary phosphorous containing compositions include the alkali metal pyrophosphates, orthophosphates, polyphosphates and phosphonates, specific examples of which are the sodium and potassium pyrophosphates, tripolyphosphates, phosphates, and hexametaphosphates.

Representative borates include the alkali metal borates such as sodium tetraborate.

Examples of organic builders which can be used as builder salts alone or in admixture with other organic and/or inorganic builders are (1) water-soluble amino polycarboxylates, e.g., sodium and potassium ethylenediaminetetraacetates, nitrilotriacetates and N-(2 hydroxyethyl)-nitrilodiacetates; (2) water-soluble salts of phytic acid, e.g., sodium and potassium phytates as set forth in U.S. Pat. No. 2,379,942; (3) water-soluble polyphosphonates, including the sodium, potassium and lithium salts of ethane-1-hydroxy-1,1-diphosphonic acid; the sodium, potassium and lithium salts of methylene diphosphonic acid; the sodium, potassium and lithium salts of ethylene diphosphonic acid; and the sodium, potassium and lithium salts of ethane-1,1,2-triphosphonic acid. Other examples include the alkali metal salts of ethane-2-carboxy-1,1-diphosphonic acid, hydroxymethanediphosphonic acid, carboxyldiphosphonic acid, ethane-1-hydroxy-1,1,2-triphosphonic acid, ethane-2-hydroxy-1,1,2-triphosphonic acid, propane-1,1,3,3-tetraphosphonic acid, propane-1,1,2,3-tetraphosphonic acid, and propane-1,2,2,3-tetraphosphonic acid; (4) the water-soluble salts of polycarboxylate polymers and copolymers as described in U.S. Pat. No. 3,308,067.

In addition, mono- and polycarboxylate salts also are suitable, including the water soluble salts of mellitic acid, citric acid, and carboxymethyloxysuccinic acid, imino disuccinate, salts of polymers of itaconic acid and maleic acid, tartrate monosuccinate, tartrate disuccinate and mixtures thereof. Exemplary polycarboxylate salts are the sodium and potassium salts of citric acid and tartaric acid. In one aspect, the polycarboxylate salt is sodium citric acid, e.g., monosodium, disodium and trisodium citrate, or sodium tartaric acid, e.g., monosodium and disodium tartrate. An example of a monocarboxylate salt is sodium formate.

Other organic builders are polymers and copolymers of (meth)acrylic acid and maleic anhydride and the alkali metal salts thereof. More specifically such builder salts can consist of a copolymer which is the reaction product of about equal moles of methacrylic acid and maleic anhydride which has been completely neutralized to form the sodium salt thereof.

Suitable electrolytes for incorporation in the present compositions include inorganic salts. Non-limiting examples of suitable inorganic salts include: MgI₂, MgBr₂, MgCl₂, Mg(NO₃)₂, Mg₃(PO₄)₂, Mg₂P₂O₇, MgSO₄, magnesium silicate, NaI, NaBr, NaCl, NaF, Na₃(PO₄), NaSO₃, Na₂SO₄, Na₂SO₃, NaNO₃, NaIO₃, Na₃(PO₄), Na₄P₂O₇, sodium zirconate, CaF₂, CaCl₂, CaBr₂, CaI₂, CaSO₄, Ca(NO₃)₂, KI, KBr, KCl, KF, KNO₃, KIO₃, K₂SO₄, K₂SO₃, K₃(PO₄), K₄ (P₂O₇), potassium pyrosulfate, potassium pyrosulfite, LiI, LiBr, LiCl, LiF, LiNO₃, AlF₃, AlCl₃, AlBr₃, AlBr₃, AlI₃Al₂(SO₄)₃, Al(PO₄), Al(NO₃)₃, and including combinations of these salts or salts with mixed cations e.g. potassium alum AlK(SO₄)₂ and salts with mixed anions, e.g. potassium tetrachloroaluminate and sodium tetrafluoroaluminate.

The builders/electrolytes can be used in an amount ranging from about 0 to about 20 wt. % in one aspect, from about 0.1 to about 10 wt. % in another aspect, from about 1 to about 8 wt. % in a further aspect, and from about 2 to about 5 wt. % in a still further aspect, based on the total weight of the composition.

### Bleaching Agents

In one aspect, the liquid detergent compositions may optionally comprise bleaching agents and bleaching agent activators to improve the bleaching and cleansing characteristics of the composition. In one aspect, the bleaching agent is selected from an oxygen bleach. Oxygen bleaches liberate hydrogen peroxide in aqueous solution. Among the compounds which produce hydrogen peroxide in water and serve as bleaches are peroxygen compounds. Exemplary peroxygen compounds include sodium perborate tetrahydrate and sodium perborate monohydrate. Additional peroxygen compounds that can be used are, for example, sodium percarbonate, peroxypyrophosphates, citrate perhydrates, and peracidic salts or peracids, such as perbenzoates, peroxophthalates, diperazelaic acid, phthaloimino peracid or diperdodecanedioic acid.

In one aspect, the peroxygen compound is used in combination with an activator. The activator lowers the effective operating temperature of the peroxygen bleaching agent. Bleach activators which can be used are compounds which, under perhydrolysis conditions, produce aliphatic peroxocarboxylic acids having 1 to 10 carbon atoms in one aspect, and from 2 to 4 carbon atoms in another aspect, and/or optionally substituted perbenzoic acid in a further aspect. Substances which contain O- and/or N-acyl groups of the specified number of carbon atoms and/or optionally substituted benzoyl groups are suitable activators. In one aspect the activator is selected from polyacylated alkylenediamines such as tetraacetylethylenediamine (TAED); acylated triazine derivatives such as 1,5-diacetyl-2,4-dioxohexahydro-1,3,5-triazine (DADHT); acylated glycolurils such as tetraacetylglycoluril (TAGU); N-acylimides such as N-nonanoylsuccinimide (NOSI); acylated phenolsulfonates such as n-nonanoyl and isononanoyl oxybenzenesulfonate (n- or iso-NOBS); carboxylic acid anhydrides such as phthalic anhydride; acylated polyhydric alcohols such as glycerin triacetate, ethylene glycol diacetate and 2,5-diacetoxy-2,5-dihydrofuran.

In general, when a bleaching agent is used, the compositions of the present technology may comprise from about 0.1 to about 50 wt. % in one aspect, from about 0.5 to about 35 wt. % in another aspect, and from about 0.75 to about 25 wt. % in a further aspect of bleaching agent by weight of the total weight of composition.

When utilized, the bleach activator is generally present in the composition in an amount of from about 0.1 to about 60 wt % in one aspect, from about 0.5 to about 40 wt. % or even from about 0.6 to about 10 wt. % based on the total weight of the composition.

The bleach activator interacts with the peroxygen compound to form a peroxyacid bleaching agent in the wash water. In one aspect, a sequestering agent of high complexing power is included in the composition to inhibit any undesired reaction between such peroxyacid and hydrogen peroxide in the wash solution in the presence of metal ions. Suitable sequestering agents for this purpose include the sodium salts of nitrilotriacetic acid (NTA), ethylene diamine tetraacetic acid (EDTA), diethylene triamine pentaacetic acid (DETPA), diethylene triamine pentamethylene phosphonic acid (DTPMP); and ethylene diamine tetramethylene phosphonic acid (EDITEMPA). The sequestering agents can be used alone or in admixture, the amount of which is conventionally known in the art.

In order to avoid loss of peroxide bleaching agent, e.g. sodium perborate, resulting from enzyme induced decomposition, such as by a catalase enzyme, the compositions may additionally include an enzyme inhibitor compound, i.e., a compound capable of inhibiting enzyme induced decomposition of the peroxide bleaching agent. Suitable inhibitor compounds are disclosed in U.S. Pat. No. 3,606,990, the relevant disclosure of which is incorporated herein by reference. In one aspect, a suitable enzyme inhibitor is hydroxylamine sulfate and other water-soluble hydroxylamine salts. Suitable amounts of the hydroxylamine salt inhibitors can be as low as about 0.01 to 0.4 wt. % in one aspect. Generally, however, suitable amounts of enzyme inhibitors can range up to about 15 wt. % in another aspect, and from about 1 to about 10 wt. % in a further aspect, based on the total weight of the composition.

### Enzymes

The heavy-duty liquid detergent compositions of the present technology can optionally comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof.

Enzymes for use in compositions, for example, detergents can be stabilized by various techniques. The enzymes employed herein can be stabilized by the presence of water-soluble sources of calcium and/or magnesium ions in the finished compositions that provide such ions to the enzymes, or the enzymes can be adsorbed to carriers in order to protect them from premature degradation. In one aspect, the amount of enzymes that can be employed range from about 0.1 to about 5 wt. % in one aspect, and from about 0.15 to about 2.5 wt. % in another aspect, based on the total weight of the composition.

### Optical Brighteners

In one aspect, the liquid detergent can optionally comprise optical brighteners (whiteners) in order to eliminate graying and yellowing of the treated textile fabrics. These substances attach to the fibers and bring about a brightening and quasi-bleaching effect by converting invisible ultraviolet radiation into visible longer-wave light, where the ultraviolet light absorbed from the sunlight is emitted as pale bluish fluorescence and produces pure white with the yellow shade of grayed and/or yellowed laundry. Suitable compounds originate, for example, from the substance classes of the 4,4′-diamino-2,2′-stilbenedisulfonic acids (flavonic acids), 4,4′-distyrylbiphenylene, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles. The optical brighteners are usually used in amounts ranging from about 0.03 to about 0.3 wt. %, based on the total weight of the composition.

### Fluorescent Brighteners

The liquid detergent can optionally comprise fluorescent brighteners. In one aspect, exemplary fluorescent brighteners include specific stilbene derivatives, more particularly diaminostilbenedisulphonic acids and their salts. The salts of 4,4′-bis(2-anilino-4-morpholino-1,3,5-triazinyl-6-amino) stilbene-2,2′-disulphonic acid, and related compounds where the morpholino group is replaced by another nitrogen-comprising moiety, are suitable; as are the 4,4′-bis(2-sulphostyryl) biphenyl type. Mixtures of brighteners can be used. Further examples of stilbene derivatives include disodium 4,4′-bis-(2-diethanolamino-4-anilino-s-triazin-6-ylamino)stilbene-2:2′ disulphonate, disodium 4,4′-bis-(2-morpholino-4-anilino-s-triazin-6-ylamino)stilbene-2:2′ disulphonate, disodium 4,4′-bis-(2,4-dianilino-s-triazin-6-ylamino)stilbene-2:2′-disulphonate, monosodium 4′,4″-bis-(2,4-dianilino-s-triazin-6-ylamino)stilbene-2-sulphonate, disodium 4,4′-bis-(4-phenyl-2,1,3-triazol-2-yl)-stilbene-2,2′ disulphonate, disodium 4,4′-bis-(2-anilino-4-(1 methyl-2-hydroxyethylamino)-s-triazin-6-ylamino)stilbene-2,2′ disulphonate, sodium 2(stilbyl-4″-(naphtho-1′,2′:4,5)-1,2,3-triazole-2″-sulphonate and 4,4′-bis(2-sulphostyryl)biphenyl. Brighteners are available as C.I. Fluorescent Brightener (CAS No. 13863-31-5), C.I. Fluorescent Brightener 28 (CAS No. 4404-43-7), C.I. Fluorescent Brightener 28, disodium salt (CAS No. 4193-55-9), C.I. Fluorescent Brightener 71, 244, 250, 260 (CAS No. 16090-02-1), C.I. Fluorescent Brightener 220 (CAS No. 16470-24-9), C.I. Fluorescent Brightener 235 (CAS No. 29637-52-3), and C.I. Fluorescent Brightener 263 (CAS No. 67786-25-8). Fluorescent brighteners will typically be incorporated into the laundry detergent compositions in concentrations ranging from about 0.001 to about 1 wt. % in one aspect, and from about 0.05 to about 0.5 wt. % in another aspect, based on the total weight of the composition.

### Dye Transfer Inhibitors

The liquid detergent compositions of the present technology can optionally comprise one or more dye transfer inhibiting agents. Suitable dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. The dye transfer inhibiting agents may be present at levels from about 0.0001 to about 10 wt. % in one aspect, from about 0.01 to about 5 wt. % in another aspect, and from about 0.1 to about 3 wt. % in another aspect, based on the total weigh of the composition.

### Soil Release Agents

In the present liquid laundry detergent, a soil release agent may optionally be incorporated into the compositions. In one aspect, such a soil release agent is a polymer having random blocks of ethylene terephthalate and polyethylene oxide (PEO) terephthalate. The molecular weight of this polymeric soil release agent ranges from about 25,000 to about 55,000 daltons. Descriptions of such copolymers and their uses are provided in U.S. Pat. Nos. 3,959,230 and 3,893,929.

In one aspect, the soil release polymer is a crystallizable polyester with repeating units of ethylene terephthalate containing from about 10 to about 15 wt. % of ethylene terephthalate units together with from about 10 to about 50 wt. % of polyoxyethylene terephthalate units that are derived from a polyoxyethylene glycol of average molecular weight of from about 300 to about 6,000 daltons. The molar ratio of ethylene terephthalate units to polyoxyethylene terephthalate units in such a crystallizable polymeric compound is between 2:1 and 6:1. Examples of this polymer include the commercially available materials available under the trade names Zelcon 4780° and Zelcon 5126 from Dupont (see also U.S. Pat. No. 4,702,857).

In one aspect, the polymeric soil release agents useful in the present technology may also include cellulosic derivatives such as hydroxyether cellulosic polymers, and the like. Such agents are commercially available and include hydroxyethers of cellulose such as those available under the METHOCEL™ trade name from Dow Chemical. Cellulosic soil release agents for use herein also include those selected from C₁-C₄ alkyl and C₄ hydroxyalkyl cellulose (see U.S. Pat. No. 4,000,093).

In one aspect, soil release agents include graft copolymers of poly(vinyl ester) segments (e.g., C₁-C₆ vinyl esters, such as vinyl acetate) grafted onto polyalkylene oxide backbones, such as polyethylene oxide backbones as disclosed in European Patent Application 0 219 048. Soil release agents of this type are commercially available under the Sokalan™ HP-22 trade name from BASF Corporation.

In one aspect, the soil release agent is an oligomer with repeat units of terephthaloyl units, sulfoisoterephthaloyl units, oxyethyleneoxy and oxy-1,2-propylene units. The repeat units form the backbone of the oligomer and are terminated with modified isethionate end-caps. In one aspect, a soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. The soil release agent also comprises from about 0.5 to about 20 wt. %, of the oligomer, of a crystalline reducing stabilizer selected from the group consisting of xylene sulfonate, cumene sulfonate, toluene sulfonate, and mixtures thereof.

A more complete disclosure of soil release agents is contained in U.S. Pat. Nos. 4,018,569; 4,661,267; 4,702,857; 4,711,730; 4,749,596; 4,808,086; 4,818,569; 4,877,896; 4,956,447; 4,968,451; and 4,976,879. If utilized, soil release agents will generally comprise from about 0.01 to about 10.0 wt. % in one aspect, from about 0.1 to about 5 wt. % in another aspect, and from about 0.2 to about 3.0 wt. % in a further aspect, based on the total weight of the composition.

### Anti-Redeposition Agents

In one aspect, the liquid detergent compositions can optionally include an anti-redeposition agent which functions to keep the soil removed from the treated fabric suspended in the wash water, thus preventing the redeposition of the soil back onto the fabric. Suitable anti-redeposition agents are, but not limited to, water soluble colloids, for example, gelatin, salts of ether sulfonic acids of starch or of cellulose or salts of acidic sulfuric acid esters of cellulose or of starch. Water soluble polyamides comprising acidic groups are also suitable for this purpose. Furthermore, soluble starch preparations and starch products other than those mentioned above can be used, for example, degraded starch, aldehyde starches, etc. It is also possible to use polyvinylpyrrolidone, polyvinyl alcohol and fatty amides. Acrylic acid/maleic acid copolymers having a molecular weight ranging from about 20,000 to about 100,000 daltons are also suitable for use herein. Such polymers are commercially available under the trade name Sokalan® CP-5 from BASF Corporation. In one aspect, the anti-redoposition agent is selected from cellulose ethers, such as sodium carboxymethyl cellulose, methylcellulose, hydroxyalkyl cellulose, such as hydroxyethyl methylcellulose, hydroxypropyl methylcellulose, carboxymethyl methyl cellulose, and mixtures thereof. In one aspect, the anti-redeposition agents are used in amounts ranging from about 0.1 to about 5 wt. %, based on the total weight of the composition.

### Fabric Softeners

The compositions of the present technology may optionally contain a fabric softening additive. Examples of fabric softening additives useful herein include alkyl quaternary ammonium alkyl quaternary ammonium compounds, ester quaternary ammonium compounds, cationic silicones, cationic polymers, silicones, clays, and mixtures thereof.

In one aspect, the alkyl quaternary ammonium softener compounds are represented by the formula:

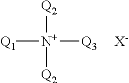

wherein Q₁ independently represents an alkyl or alkenyl group containing 15 to 22 carbon atoms; Q₂ independently is an alkyl group containing 1 to 4 carbon atoms; Q₃ is Q₁ or Q₂ or phenyl; and X is an anion selected from a halide (e.g., choride, bromide), methyl sulfate and ethyl sulfate. The foregoing alkyl groups may optionally be substituted or contain functional groups or moieties such as —OH, —O—, —C(O)NH—, C(P)O—. Representative examples of these quaternary softeners include ditallow dimethyl ammonium chloride; ditallow dimethyl ammonium methyl sulphate; dihexadecyl dimethyl ammonium chloride; di(hydrogenated tallow) dimethyl ammonium methyl sulphate or chloride; di(coconut)dimethyl ammonium chloride dihexadecyl diethyl ammonium chloride; dibenhenyl dimethyl ammonium chloride.

In one aspect, the ester quaternary ammonium softeners are represented by the formula:

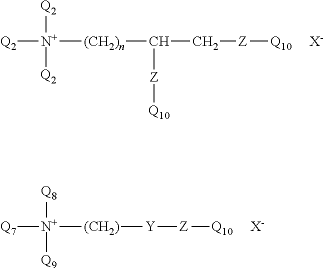

wherein Q₂ independently is as defined above, Q₇ is and alkyl group containing 1 to 4 carbon atoms, Q₈ is —(CH₂)ₙ—Z-Q₁₀, Q₉ is an alkyl or hydroxyalkyl group containing 1 to 4 carbon atoms or is Q₈, Q₁₀ is an alkyl or alkenyl group containing 12 to 22 carbon atoms, Y is a divalent alkene group containing 1 to 3 carbon atoms or the moiety —CH(OH)—CH₂—, Z is a moiety selected from —O—C(O)—O—, —C(O)O—C(O)O—, and —OC(O)—, and X is an anion as previously defined, and n is an integer from 1 to 4.

An illustrative examples of ester quaternary ammonium compounds are 1,2-ditallowyloxy-3-trimethyl ammoniopropane chloride (a ditallow ester of 2,3-dihydroxy propane trimethyl ammonium chloride), N,N-di(stearyl-oxyethyl)-N,N-dimethyl ammonium chloride and N,N-di(stearyl-oxyethyl)-N-hydroxyethyl-N-dimethyl ammonium chloride, wherein the stearyl group may be replaced with oleyl, palmityl or tallowyl (mixed chain length) groups.

In one aspect, the cationic silicones are selected from amino functional and quaternized polyorganosiloxanes represented by the formula:

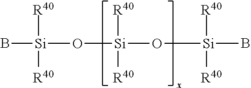

wherein B independently represents hydroxy, methyl, methoxy, ethoxy, propoxy, and phenoxy; R⁴⁰ independently represents methyl, ethyl, propyl, phenyl, methylphenyl, phenylmethyl, a primary, secondary or tertiary amine, a quaternary group selected from a group selected from:

R⁴¹—N(R⁴²)CH₂CH₂N(R⁴²)₂;

R⁴¹—N(R⁴²)₂;

R⁴¹—N⁺(R⁴²)₃CA⁻; and

R⁴¹—N(R⁴²)CH₂CH₂N⁺(R⁴²)H₂CA³¹

wherein R⁴¹ is a linear or branched, hydroxyl substituted or unsubstituted alkylene or alkylene ether moiety containing 2 to 10 carbon atoms; R⁴² independently is hydrogen, C₁-C₂₀ alkyl (e.g., methyl), phenyl or benzyl; q is an integer ranging from about 2 to about 8; CA³¹ is a halide ion selected from chlorine, bromine, iodine and fluorine; and x is an integer ranging from about 7 to about 8000 in one aspect, from about 50 to about 5000 in another aspect, form about 100 to about 3000 in still another aspect, and from about 200 to about 1000 in a further aspect.

In one aspect, the amino functional and quaternized polyalkylsiloxane can be represented by the formula:

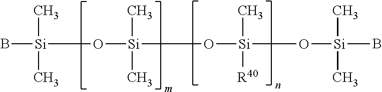

wherein B independently represents hydroxy, methyl, methoxy, ethoxy, propoxy, and phenoxy; and R⁴⁰ is selected from:

R⁴¹—N(R⁴²)CH₂CH₂N(R⁴²)₂;

R⁴¹—N(R⁴²)₂;

R⁴¹—N⁺(R⁴²)₃CA⁻; and

R⁴¹—N(R⁴²)CH₂CH₂N⁺(R⁴²)H₂CA³¹

wherein R⁴¹ is a linear or branched, hydroxyl substituted or unsubstituted alkylene or alkylene ether moiety containing 2 to 10 carbon atoms; R⁴² independently is hydrogen, C₁-C₂₀ alkyl, phenyl or benzyl; CA³¹ is a halide ion selected from chlorine, bromine, iodine and fluorine; and the sum of m+n ranges from about 7 to about 1000 in one aspect, from about 50 to about 250 in another aspect, and from about 100 to about 200 in another aspect, subject to the proviso that m or n is not 0. In one aspect, B is hydroxy and R⁴⁰ is —(CH₂)₃NH(CH₂)₃NH₂. In another aspect, B is methyl and R⁴⁰ is —(CH₂)₃NH(CH₂)₃NH₂. In still another aspect, B is methyl and R⁴⁰ is a quaternary ammonium moiety represented by —(CH₂)₃OCH₂CH(OH)CH₂N⁺(R⁴²)₃CA⁻; wherein R⁴² and CA³¹ are as previously defined.

In one aspect, the cationic silicone is a water soluble dimethicone copolyol containing a quaternium moiety be represented by the formula:

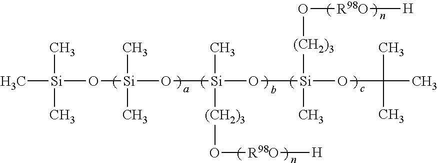

wherein a represents an integer ranging from about 0 or 1 to about 200; b is an integer ranging from about 1 to about 100; c is an integer ranging from about 0 or 1 to about 200; (R⁹⁸O)ₙ is a polyoxyalkylene moiety which can be arranged as a homopolymer, a random copolymer, or a block copolymer of oxyalkylene units; R⁹⁸ is a divalent alkylene moiety selected from C₂H₄, C₃H₆, or C₄H₈, and combinations thereof; and n independently is an integer ranging from about 1 to about 50 in one aspect, from about 3 to about 35 in another aspect, from about 5 to about 25 in a still another aspect, and from about 8 to about 20 in a further aspect; R′ is selected from a radical of the following formulas:

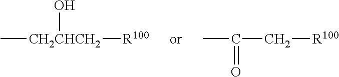

wherein R¹⁰⁰ is a quaternary nitrogen containing moiety selected from the formulas:

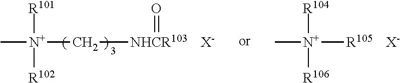

wherein R¹⁰¹ and R¹⁰² independently are selected from methyl or ethyl; R¹⁰³ is a C₅ to C₂₁ alkyl group; R¹⁰⁴, R¹⁰⁵, R¹⁰⁶ independently represent C₁ to C₂₀ alkyl; and X⁻ is a salt forming anion. In one aspect, R¹⁰¹ and R¹⁰² are both methyl or both ethyl and R¹⁰³ is a C₁₁ to C₂₁ alkyl group. In one aspect, two of R¹⁰⁴, R¹⁰⁵ or R¹⁰⁶ are methyl and the remaining R¹⁰⁴, R¹⁰⁵ or R¹⁰⁶ that is not methyl is selected from a C₁₂ to C₂₀ alkyl group. In one aspect, X⁻ is a chloride anion.

Dimethicone copolyol quaternary nitrogen containing compounds are disclosed in U.S. Pat. Nos. 5,098,979 and 5,166,297, the disclosures of which are herein incorporated by reference.

In one aspect, the dimethicone copolyol contains an amine functional group. Amine functional dimethicone copolyols can be represented by the formula:

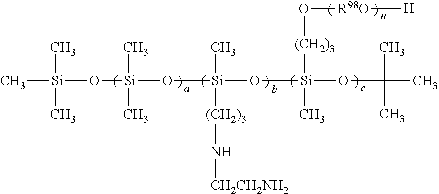

wherein a represents an integer ranging from about 0 or 1 to about 200; b is an integer ranging from about 1 to about 100; c is an integer ranging from about 1 to about 200; (R⁹⁸O)ₙ is a polyoxyalkylene moiety which can be arranged as a homopolymer, a random copolymer, or a block copolymer of oxyalkylene units; R⁹⁸ is a divalent alkylene moiety selected from C₂H₄, C₃H₆, or C₄H₈, and combinations thereof; and n independently is an integer ranging from about 1 to about 50 in one aspect, from about 3 to about 35 in another aspect, from about 5 to about 25 in a still another aspect, and from about 8 to about 20 in a further aspect.

Other exemplary quaternary nitrogen containing silicones that are useful in the disclosed technology are found in the CTFA Dictionary and in the International Cosmetic Ingredient Dictionary, Vol. 1 and 2, 5th Ed., published by the Cosmetic Toiletry and Fragrance Association, Inc. (CTFA) (1993), the pertinent disclosures of which are incorporated herein by reference. Quaternium-80, Silicone Quaternium-1, Silicone Quaternium-2, Silicone Quaternium-2 Panthenol Succinate, Silicone Quaternium-3, Silicone Quaternium-4, Silicone Quaternium-5, Silicone Quaternium-6, Silicone Quaternium-7, Silicone Quaternium-9, Silicone Quaternium-10, Silicone Quaternium-11, Silicone Quaternium-12, Silicone Quaternium-15, Silicone Quaternium-16, Silicone Quaternium-16/Glycidoxy Dimethicone Crosspolymer, Silicone Quaternium-17, Silicone Quaternium-18, Silicone Quaternium-20 and Silicone Quaternium-21.

Cationic polymers are also useful as fabric softening agents. Suitable cationic polymers can be synthetically derived or natural polymers can be synthetically modified to contain cationic moieties. A number of cationic moiety containing polymers their manufacturers and general descriptions of their chemical characteristics are found in the CTFA Dictionary and in the International Cosmetic Ingredient Dictionary, Vol. 1 and 2, 5th Ed., published by the Cosmetic Toiletry and Fragrance Association, Inc. (CTFA) (1993), the pertinent disclosures of which are incorporated herein by reference.

In one aspect, the cationic polymer contains at least one repeating unit containing a quaternary ammonium salt moiety. Such polymers can be prepared by the polymerization of a diallylamine such as dialkyldiallylammonium salt or copolymer thereof in which the alkyl group contains 1 to about 22 carbon atoms in one aspect and methyl or ethyl in another aspect. Copolymers containing a quaternary moiety derived from a dialkyldiallylammonium salt and an anionic component derived from anionic monomers of acrylic acid and methacrylic acid are suitable conditioning agents. Also suitable are, polyampholyte terpolymers having a cationic component prepared from a derivative of diallylamine, such as a dimethyldiallylammonium salt, an anionic component derived from anionic monomers of acrylic acid or 2-acrylamido-2-methylpropane sulfonic acid and a nonionic component derived from nonionic monomers of acrylamide. The preparation of such quaternary ammonium salt moiety containing polymers can be found, for example, in U.S. Pat. Nos. 3,288,770; 3,412,019; 4,772,462 and 5,275,809, the pertinent disclosures of which are incorporated herein by reference.

In one aspect, suitable cationic polymers include the chloride salts of the foregoing quaternized homopolymers and copolymers in which the alkyl group is methyl or ethyl, and are commercially available under the Merquat® series of trademarks from Lubrizol Advanced Materials, Inc.

A homopolymer prepared from diallyl dimethyl ammonium chloride (DADMAC) having the CTFA name, Polyquaternium-6, is available under the Merquat 100 and Merquat 106 trademark. A copolymer prepared from DADMAC and acrylamide having the CTFA name, Polyquaternium-7, is sold under the Merquat 550 trademark. Another copolymer prepared from DADMAC and acrylic acid having the CTFA name, Polyquaternium-22, is sold under the Merquat 280 trademark. The preparation of Polyquaternium-22 and its related polymers is described in U.S. Pat. No. 4,772,462, the pertinent disclosures of which are incorporated herein by reference.

Also useful is an ampholytic terpolymer prepared from a nonionic component derived from acrylamide or methyl acrylate, a cationic component derived from DADMAC or methacrylamidopropyl trimethyl ammonium chloride (MAPTAC), and an anionic component derived from acrylic acid or 2-acrylamido-2-methylpropane sulfonic acid or combinations of acrylic acid and 2-acrylamido-2-methylpropane sulfonic acid. An ampholytic terpolymer prepared from acrylic acid, DADMAC and acrylamide having the CTFA name, Polyquarternium-39, is available under the Merquat Plus 3330 trademark. Another ampholytic terpolymer prepared from acrylic acid, methacrylamidopropyl trimethyl ammonium chloride (MAPTAC) and methyl acrylate having the CTFA name, Polyquarternium-47, is available under the Merquat 2001 trademark. Still another ampholytic terpolymer prepared from acrylic acid, MAPTAC and acrylamide having the CTFA name, Polyquarternium-53, is available under the Merquat 2003PR trademark. The preparation of such terpolymers is described in U.S. Pat. No. 5,275,809, the pertinent disclosures of which are incorporated herein by reference.

Exemplary cationically modified natural polymers suitable for use in the liquid laundry detergent composition includes polysaccharide polymers, such as cationically modified cellulose and cationically modified starch derivatives modified with a quaternary ammonium halide moiety. Exemplary cationically modified cellulose polymers are salts of hydroxyethyl cellulose reacted with trimethyl ammonium substituted epoxide (CTFA, Polyquaternium-10). Other suitable types of cationically modified cellulose include the polymeric quaternary ammonium salts of hydroxyethyl cellulose reacted with lauryl dimethyl ammonium substituted epoxide (CTFA, Polyquaternium-24). Cationically modified potato starch having the CTFA name, Starch Hydroxypropyltrimonium Chloride, is available under the Sensomer™ CI-50 trademark, from Lubrizol Advanced Materials, Inc.

Other suitable cationically modified natural polymers include cationic polygalactomannan derivatives such as guar gum derivatives and cassia gum derivatives, e.g., CTFA: Guar Hydroxypropyltrimonium Chloride, Hydroxypropyl Guar Hydroxypropyltrimonium Chloride, and Cassia Hydroxypropyltrimonium Chloride. Guar hydroxypropyltrimonium chloride is commercially available under the Jaguar™ trade name series from Rhodia Inc. and the N-Hance trade name series from Ashland Inc. Cassia Hydroxypropyltrimonium Chloride is commercially available under the Sensomer™ CT-250 and Sensomer™ CT-400 trademarks from Lubrizol Advanced Materials, Inc.

Other cationic polymers and copolymers suitable as softeners in the disclosed technology have the CTFA names Polyquaternium-1, Polyquaternium-2, Polyquaternium-4, Polyquaternium-5, Polyquaternium-6, Polyquaternium-7, Polyquaternium-8, Polyquaternium-9, Polyquaternium-10, Polyquaternium-11, Polyquaternium-12, Polyquaternium-13, Polyquaternium-14, Polyquaternium-15, Polyquarternium-16, Polyquaternium-17, Polyquaternium-18, Polyquaternium-19, Polyquaternium-20, Polyquaternium-22, Polyquaternium-24, Polyquaternium-27, Polyquaternium-28, Polyquaternium-29, Polyquaternium-30, Polyquaternium-31, Polyquaternium-32, Polyquaternium-33, Polyquaternium-34, Polyquaternium-35, Polyquaternium-36, Polyquaternium-37, Polyquaternium-39, Polyquaternium-42, Polyquaternium-43, Polyquaternium-44, Polyquaternium-45, Polyquaternium-46, Polyquaternium-47, Polyquaternium-48, Polyquaternium-49, Polyquaternium-50, Polyquaternium-51, Polyquaternium-52, Polyquaternium-53, Polyquaternium-54, Polyquarternium-55, Polyquaternium-56, Polyquaternium-57, Polyquaternium-58, Polyquaternium-59, Polyquaternium-60, Polyquaternium-61, Polyquaternium-62, Polyquaternium-63, Polyquaternium-64, Polyquaternium-65, Polyquaternium-66, Polyquaternium-67, Polyquaternium-68, Polyquaternium-69, Polyquaternium-70, Polyquaternium-71, Polyquaternium-72, Polyquaternium-73, Polyquaternium-74, Polyquaternium-75, Polyquaternium-76, Polyquaternium-77, Polyquaternium-78, Polyquaternium-79, Polyquaternium-80, Polyquaternium-81, Polyquaternium-82, Polyquaternium-83, Polyquaternium-84, Polyquaternium-85, Polyquaternium-86, Polyquaternium-87, and mixtures thereof.

In one aspect of the present technology, the liquid laundry detergent composition optionally comprises a silicone softening agent. Exemplary silicone softening agents include, but are not limited to, polydimethylsiloxanes (dimethicones), polydiethylsiloxanes, polydimethyl siloxanes having terminal hydroxyl groups (dimethiconols), polymethylphenylsiloxanes, phenylmethylsiloxanes, and mixtures thereof.

Silicones can be identified according to a shorthand nomenclature system known to those of ordinary skill in the art as “MDTQ” nomenclature. Under this naming system, the silicone is described according to the presence of various siloxane monomer units which make up the silicone. The “MDTQ” nomenclature system is described in the publication entitled “Silicones: Preparation, Properties and Performance”; Dow Corning Corporation, 2005, and in U.S. Pat. No. 6,200,554.

Exemplary silicone resins for use in the compositions of the disclosed technology include, but are not limited to MQ, MT, MTQ, MDT and MDTQ resins. In one aspect, methyl is the silicone resin substituent. In another aspect, the silicone resin is selected from a MQ resins, wherein the M:Q ratio is from about 0.5:1.0 to about 1.5:1.0 and the average molecular weight of the silicone resin is from about 1000 to about 10,000 daltons.

Another class of silicone softening agent useful in the disclosed technology is a dimethicone copolyol. The dimethicone copolyols are linear or branched copolymers of dimethylsiloxane (dimethicone) modified with terminal and/or pendant alkylene oxide units. Suitable alkylene oxide units are selected from ethylene oxide, propylene oxide, butylene oxide, and combinations thereof. When mixtures of alkylene oxides are present, the alkylene oxide units can be arranged as random or block segments. Dimethicone copolyols can be water soluble or oil soluble depending on the amount and type of polyalkylene oxide present in the dimethicone polymer. The dimethicone copolyols can be derivatized to be anionic, cationic, amphoteric or nonionic in character.

In one aspect, the nonionic dimethicone copolyol contains pendant polyoxyalkylene moieties and can be represented by the formula:

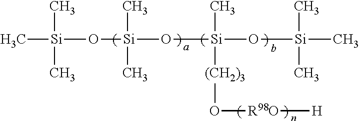

wherein a represents an integer ranging from about 0 or 1 to about 500; b is an integer ranging from about 1 to about 100; (R⁹⁸O)ₙ is a polyoxyalkylene moiety which can be arranged as a homopolymer, a random copolymer, or a block copolymer of oxyalkylene units; R⁹⁸ is a divalent alkylene moiety selected from C₂H₄, C₃H₆, or C₄H₈, and combinations thereof; and n is an integer ranging from about 1 to about 50 in one aspect, from about 3 to about 35 in another aspect, from about 5 to about 25 in a still another aspect, and from about 8 to about 20 in a further aspect.

Exemplary nonionic dimethicone copolyols containing pendant polyoxyalkylene moieties are commercially available under the Silsoft® trade name from Momentive Performance Materials. Specific product designations include, but are not limited to, Silsoft product designations 430 and 440 (PEG/PPG 20/23 Dimethicone), 475 (PEG/PPG 20/6 Dimethicone), 805 (PEG-8 Dimethicone), 875 and, 880 (PEG-12 Dimethicone), 895 (PEG-17 Dimethicone), and 910 (PPG-12 Dimethicone). Other commercially available dimethicone copolyols include Silsense™ Copolyol-1 a dimethicone copolyol blend (PEG-33 Dimethicone and PEG-8 Dimethicone and PEG-14 Dimethicone) from Lubrizol Advanced Materials, Inc.

In another aspect, the nonionic dimethicone copolyol contains terminal polyoxyalkylene moieties and can be represented by the formula:

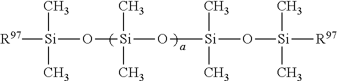

wherein R⁹⁷ independently is selected from methyl and the radical —(CH₂)ₘ—O—(R⁹⁸O)ₙ—H; a is an integer ranging from about 1 to about 500; (R⁹⁸O)ₙ is a polyoxyalkylene moiety which can be arranged as a homopolymer, a random copolymer, or a block copolymer of oxyalkylene units; R⁹⁸ is a divalent alkylene moiety selected from C₂H₄, C₃H₆, or C₄H₈, and combinations thereof; m is an integer ranging from about 1 to about 5; and n is an integer ranging from about 1 to about 50 in one aspect, from about 3 to about 35 in another aspect, from about 5 to about 25 in a still another aspect, and from about 8 to about 20 in a further aspect; subject to the proviso that R⁹⁷ cannot both be methyl at the same time.

Exemplary nonionic dimethicone copolyols containing a terminal polyoxyalkylene moietie(s) also are commercially available under the Silsoft® trade name from Momentive Performance Materials under product designations 810 (PEG-8 Dimethicone), 860 (PEG-10 Dimethicone), 870 (PEG-12 Dimethicone), and 900 (PPG-12 Dimethicone).

In one aspect, the nonionic dimethicone copolyol contains esterified pendant polyoxyalkylene moieties and can be represented by the formula:

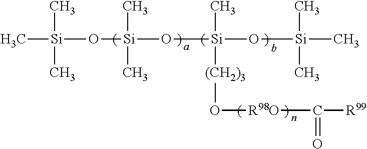

wherein a represents an integer ranging from about 0 or 1 to about 500; b is an integer ranging from about 1 to about 100; (R⁹⁸O)ₙ is a polyoxyalkylene moiety which can be arranged as a homopolymer, a random copolymer, or a block copolymer of oxyalkylene units; R⁹⁸ is a divalent alkylene moiety selected from C₂H₄, C₃H₆, or C₄H₈, and combinations thereof; and n is an integer ranging from about 1 to about 50 in one aspect, from about 3 to about 35 in another aspect, from about 5 to about 25 in a still another aspect, and from about 8 to about 20 in a further aspect; and R⁹⁹ is C₁ to C₂₁ alkyl. In one aspect the acyl radical —C(O)R⁹⁹ that terminates the polyoxyalkylene moiety is derived from a saturated or unsaturated carboxylic or fatty acid obtained from natural or synthetic sources. These acids can be linear or branched. Suitable acids are selected from, but are not limited to caproic acid, enanthic acid, caprylic acid, pelargonic acid, capric acid, undecanoic acid lauric acid, myristic acid, palmitic acid, stearic acid, isosteric acid, oleic acid, linoleic acid, ricinoleic acid, and behenic acid which are typically obtained by hydrolyzing vegetable oils and animal oils such as coconut oils, palm oil, tallow, linseed oil and soybean oil.

Dimethicone copolyol esters and methods for their preparation are disclosed in U.S. Pat. No. 5,136,063, which is herein incorporated by reference. Exemplary dimethicone copolyol esters are commercially available under the Silsence™ trade name as product designations SW-12 (Dimethicone PEG-7 Cocoate) and DW-18 (Dimethicone PEG-7 isosterate) from Lubrizol Advanced Materials, Inc.

Other useful dimethicone copolyol esters contain at least one terminal polyoxyalkylene ester moiety as described in U.S. Pat. No. 5,180,843, which is herein incorporated by reference.

In one aspect, the dimethicone copolyol contains phosphate ester functionality. These compounds can be represented by the formula:

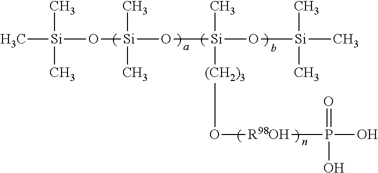

wherein a represents an integer ranging from about 0 or 1 to about 500; b is an integer ranging from about 1 to about 100; (R⁹⁸O)ₙ is a polyoxyalkylene moiety which can be arranged as a homopolymer, a random copolymer, or a block copolymer of oxyalkylene units; R⁹⁸ is a divalent alkylene moiety selected from C₂H₄, C₃H₆, or C₄H₈, and combinations thereof; and n is an integer ranging from about 1 to about 50 in one aspect, from about 3 to about 35 in another aspect, from about 5 to about 25 in a still another aspect, and from about 8 to about 20 in a further aspect.

A suitable fabric softening clay is, for example, a smectite clay. In one aspect, the smectite clays are beidellite clays, hectorite clays, laponite clays, montmorillonite clays, nontronite clays, saponite clays, sauconite clays, and mixtures thereof. Bentonite clays contain principally montmorillonites, and can serve as a source for the textile-softening clay.

Typical minimum levels of incorporation of the fabric softening active in the present compositions range from about 0.1% to about 20 wt. % in one aspect, from about 0.5 to about 12 wt. % in another aspect, from about 1 to about 10 wt. % in a further aspect, and from about 3 to about 8 wt. % in a still further aspect, based on the weight of the total composition.

### Auxiliary Viscosity Modifier

The liquid laundry detergent compositions of the disclosed technology must be easily pourable and possess an optical transmission of at least 10%. If desired the nonionic, amphiphilic polymers of the disclosed technology can be utilized in combination with an auxiliary rheology modifier (thickener). In one aspect, the nonionic, amphiphilic, emulsion polymer of the disclosed technology can be combined with a nonionic rheology modifier to enhance the yield stress value of a composition in which it is included. Any rheology modifier is suitable, so long as such is soluble in water, stable and contains no ionic or ionizable groups. Suitable rheology modifiers include, but are not limited to natural gums (e.g., polygalactomannan gums selected from fenugreek, cassia, locust bean, tara and guar), modified cellulose (e.g., ethylhexylethylcellulose (EHEC), hydroxybutylmethylcellulose (HBMC), hydroxyethylmethylcellulose (NEMC), hydroxypropylmethylcellulose (HPMC), methyl cellulose (MC), hydroxyethylcellulose (HEC), hydroxypropylcellulose (HPC) and cetyl hydroxyethylcellulose); and mixtures thereof methylcellulose, polyethylene glycols (e.g., PEG 4000, PEG 6000, PEG 8000, PEG 10000, PEG 20000), polyvinyl alcohol, polyacrylamides (homopolymers and copolymers), and hydrophobically modified ethoxylated urethanes (HEUR). The rheology modifier can be utilized in an amount ranging from about 0.5 to about 25 wt. % in one aspect, from about 1 to about 15 wt. % in another aspect, and from about 2 to about 10 wt. % in a further aspect, based on the weight of the total weight of the composition.

In one embodiment, the liquid laundry detergent composition of the disclosed technology is an easily pourable mixture, having a viscosity at a shear rate of 18 to 21 s⁻¹ in the range of from about 100 mPa·s to about 2000 mPa·s in one aspect, from about 200 mPa·s to about 1700 mPa·s in another aspect, from about 300 mPa·s to about 1500 mPa·s in still another aspect, and from about 400 mPa·s to about 1200 mPa·s in a further aspect. The viscosities are adjustable by changing the amount of nonionic, amphiphilic polymeric material contained in the liquid laundry detergent composition. The product should be pourable from a relatively narrow mouth bottle (approximately 1.5 cm in diameter).

### Suds Suppressors (Anti-Foaming Agent)

The liquid detergent composition may further comprise a suds suppressor such as silicones, silica-silicone mixtures, fatty acids and their salts, and mixtures thereof. Silicones can generally be represented by the alkylated polysiloxane materials such as PDMS, while silica is normally used in finely divided forms exemplified by silica aerogels and xerogels and hydrophobic silicas of various types. An additional example of a silicone suds controlling agent is disclosed in U.S. Pat. No. 3,933,672. Other suds suppressors are the self-emulsifying silicones such as a siloxane-glycol copolymer commercially available from Dow Corning under the trade name DC-544. These materials can be incorporated directly into the liquid laundry composition or as particulates, in which the suds suppressor is releasably incorporated in a water-soluble or water-dispersible, substantially non-surface-active detergent impermeable carrier. Alternatively the suds suppressor can be dissolved or dispersed in a liquid carrier and applied by spraying onto one or more of the other components.

In one aspect, a suitable fatty acid suds suppressor is a long chain monocarboxylic fatty acid, a long chain monocarboxylic fatty acid salt, and a mixture thereof. Long chain monocarboxylic fatty acids and salts thereof are described in U.S. Pat. No. 2,954,347. The monocarboxylic fatty acids, and salts useful herein typically have about 10 to 24 carbons, or about 12 to 18 carbon atoms and can be saturated or unsaturated and/or linear and branched. Suitable salts include the alkali metal salts such as sodium, potassium, and lithium salts, and ammonium and alkanolammonium salts. Suitable acids are selected from, but are not limited to, capric acid, undecanoic acid lauric acid, myristic acid, palmitic acid, stearic acid, isosteric acid, oleic acid, linoleic acid, ricinoleic acid, behenic acid, lignoceric acid, salts thereof, and mixtures thereof. The fatty acids can be obtained from natural or synthetic sources. The natural fatty acids can be derived from animal fat such as tallow or from vegetable oil such as coconut oil, red oil, palm kernel oil, palm oil, linseed oil, cottonseed oil, olive oil, soybean oil, peanut oil, corn oil, and mixtures thereof. The suds suppressors are normally employed at levels of from about 0.001 to about 3 wt. % of the composition in one aspect, and from about 0.01 to about 2 wt. %.

pH

In one aspect, the liquid detergent of the present technology has a neat pH of from about 5 to about 13 in one aspect, from about 6 to about 9 in another aspect, from about 7 to about 8.5 in a further aspect, and from about 7.5 to about 8 in a still further aspect. Advantageously, the pH of the liquid detergent composition is not dictated by the need to neutralize the nonionic, amphiphilic, suspending polymer in that the polymer's ability to stably suspend particulates is independent of pH. In order to adjust or maintain a desired pH, the liquid detergent may contain a pH adjusting agent and/or buffering agent in a sufficient amount to attain the above mentioned pH. The pH adjusting agents useful in the present laundry compositions include alkalizing agents. Suitable alkalizing agents include, for example, ammonia solution, triethanolamine, diethanolamine, monoethanolamine, potassium hydroxide, sodium hydroxide, sodium phosphate dibasic, soluble carbonate salts, and combinations thereof. In the event that it is necessary to reduce the pH of the liquid laundry composition, inorganic and organic acidity agents may be included. Suitable inorganic and organic acidifying agents include, for example, HF, HCl, HBr, HI, boric acid, sulfuric acid, phosphoric acid, and/or sulphonic acid; or boric acid. The organic acidifying agent can include substituted and substituted, branched, linear and/or cyclic carboxylic acids and anhydrides thereof (e.g., citric acid, lactic acid).

### Buffers

Buffers which may be added to the laundry composition of the present technology include alkali or alkali earth metal carbonates, phosphates, bicarbonates, citrates, borates, acetates, silicates, acid anhydrides, succinates, as well as alkanolamines, and mixtures thereof. Exemplary buffer agents include, but are not limited to, sodium phosphate, sodium triphosphate, sodium citrate, sodium acetate, sodium bicarbonate, sodium carbonate, sodium silicate, borax, monoethanolamine, triethanolamine, and mixtures thereof.

### Perfumes and Fragrances

The liquid detergent composition of the present technology optionally comprises one or more enduring perfume ingredients which are substantive to fabrics, thus minimizing the perfume lost during the laundering process. Substantive perfume ingredients are those fragrance compounds that effectively deposit on fabrics during the cleaning process and are detectable on the subsequently dried fabrics by people with normal olfactory acuity. Enduring perfumes are those which are effectively retained and remain on the laundry for a long lasting aesthetic benefit with a minimum amount of material, and not lost and/or wasted in the cleaning, rinsing, and/or drying steps of the laundering process. In one aspect, the perfume may be selected from alcohols, ketones, aldehydes, esters, ethers, nitriles, alkenes, and mixtures thereof. Suitable perfumes, for example, are disclosed in U.S. Pat. Nos. 8,357,649 and 8,293,697, the pertinent disclosures of which is incorporated herein by reference.

If present, the perfume is typically incorporated in the present compositions at a level from about 0.001 to about 10 wt. % in one aspect, from about 0.01 to 5 wt. % in another aspect, and from about 0.1 to about 3 wt. % in a further aspect, based on the total weight of the composition.

### Deposition Aids

Both for the efficient deposition of perfume and for the deposition of other benefit agents, such as silicone the liquid laundry composition optionally comprises a deposition aid. In one aspect, a suitable deposition aid includes those which are substantive to cellulose.

In one aspect, the deposition aid is a polysaccharide. In one aspect the polysaccharide is a β-1,4-linked backbone of saccharide repeating units which is substantive to cellulose. Exemplary polysaccharides are cellulose, a cellulose derivative, or another β-1,4-linked polysaccharide having an affinity for cellulose, such as polymannan, polyglucan, polyglucomannan, polyxyloglucan and polygalactomannan, and mixtures thereof. In one aspect, the polysaccharide is selected from polyxyloglucans and polygalactomannans. In one aspect, the polysaccharides are locust bean gum, tamarind, xyloglucan, guar gum, cassia gum or mixtures thereof.

Cationic polymers can also be used as deposition aids. Examples of such cationic polymers are cationically modified cellulose (e.g., Polyquaternium-4 and 10), cationically modified starch (e.g., Starch Hydroxypropyl Trimonium Chloride), cationically modified guar (e.g., Guar Hydroxypropyl Trimonium Chloride), and cationically modified cassia (e.g., Cassia Hydroxypropyl Trimonium Chloride), polymers and copolymers comprising repeating units derived from poly diallyl dimethyl ammonium halides DADMAC, and copolymers derived from DADMAC and vinyl pyrrolidone, acrylamides, imidazoles, imidazolinium halides, (e.g., Polyquarternium-6, 7, 22 and 39). The cationically modified celluloses, starches, guar and cassia have a molecular weight ranging from about 15,000 to about 500,000,000 daltons in one aspect, from about 50,000 to about 10,000,000 daltons in another aspect, and from about 250,000 to about 5,000,000 daltons in a further aspect, and from about 350,000 to about 800,000 daltons in a still further aspect.

In one aspect, a suitable deposition aid includes those which are substantive to polyester. The polyester substantive deposition aid is a polymer that is derived from dicarboxylic acids and polyols. In one aspect, the polymer comprises units derived from (poly)ethylene glycol and terephthalic acid.

In one embodiment, the deposition aid is a perfume deposition polyamine having a molecular weight of from about 1,000 to about 50,000 daltons in one aspect and from about 5,000 to about 30,000 daltons in another aspect. In one aspect, the perfume deposition aid is a polyamine selected from polyethyleneimines available under the Lupasol™ trade name from BASF Corporation; poly[oxy(methyl-1,2-ethanediyl)], α-(2-aminomethylethyl)-ω-(2-aminomethylethoxy)- (CAS No. 9046-10-0); poly[oxy(methyl-1,2-ethanediyl)], α-hydro-ω-(2-aminomethylethoxy)-, ether with 2-ethyl-2-(hydroxymethyl)-1,3-propanediol (3:1) (CAS No. 39423-51-3), which are commercially available under the Jeffamine™ trade name from Huntsman Corporation. In one aspect the deposition aid is an amino group containing compound selected from 1,2-ethanediamine, N¹,N¹-bis(2-aminoethyl)- (CAS No. 4097-89-6); 1,2-ethanediamine, N¹-(2-aminoethyl)- (CAS No. 98824-35-2); 1,3-propanediamine, N¹-(3-aminopropyl)-, (CAS No. 56-18-8); and 1,3-cyclohexanediethanamine (CAS No. 40027-36-9); and mixtures thereof.

The amount of deposition aid utilized in the liquid detergent compositions of the present technology can range from about 0.01 to about 5 wt. % in one aspect, from about 0.05 to about 3 wt. % in another aspect, from about 0.1 to about 2 wt. % in a further aspect, and from about 0.5 to about 1 wt. % in a still further aspect, based on the weight of the total composition.

### Odor Control Agents

In yet another embodiment, the liquid detergent composition optionally comprises odor control agents such as cyclodextrin. As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings. The specific coupling and conformation of the glucose units give the cyclodextrins rigid, conical molecular structures with hollow interiors of specific volumes. The “lining” of each internal cavity is formed by hydrogen atoms and glycosidic bridging oxygen atoms; therefore, this surface is fairly hydrophobic. The unique shape and physical-chemical properties of the cavity enable the cyclodextrin molecules to absorb (form inclusion complexes with) organic molecules or parts of organic molecules which can fit into the cavity. Many odorous molecules can fit into the cavity including many malodorous molecules and perfume molecules. Cyclodextrins, particularly the cationic cyclodextrins described below, can also be utilized for the delivery of perfume actives to cellulosic fabrics (U.S. Pat. No. 8,785,171).

Cyclodextrins that are useful in the present technology are highly water-soluble such as, alpha-cyclodextrin and/or derivatives thereof, gamma-cyclodextrin and/or derivatives thereof, derivatized beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, e.g., wherein the substituent(s) is a methyl or an ethyl group; those with hydroxyalkyl substituted groups, e.g., wherein the substituent is a hydroxypropyl and/or hydroxyethyl group; branched cyclodextrins such as maltose-bonded cyclodextrins; cationic cyclodextrins, e.g., wherein the substituent(s) is a 2-hydroxy-3-(dimethylamino)propyl ether moiety (which is cationic at low pH); quaternary ammonium, e.g., wherein the substituent(s) is a 2-hydroxy-3-(trimethylammonio)propyl ether chloride moiety; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49, said references being incorporated herein by reference; and mixtures thereof. Other cyclodextrin derivatives are disclosed in U.S. Pat. Nos. 3,426,011; 3,453,257; 3,453,258; 3,453,259; 3,453,260; 3,459,731; 3,553,191; 3,565,887; 4,535,152; 4,616,008; 4,678,598; 4,638,058; 4,746,734; 5,942,217; and 6,878,695).

Other agents suitable odor control include those described in: U.S. Pat. Nos. 5,968,404; 5,955,093; 6,106,738; 5,942,217; and 6,033,679.

The level of cyclodextrin derivatives that are utilized for odor control in the liquid detergent compositions ranges from about 0.001 to about 0.5 wt. %, based on the weight of the total composition.

The liquid laundry detergent can optionally comprise other ingredients, adjuvants, benefit agents or aesthetic agents such as, for example, anti-microbial agents, preservatives, anti-oxidants, UV absorption agents, pigments, anti-shrink agents, anti-wrinkle agents, opacifiers and pearlescent agents (e.g., mica, coated mica, TiO₂, ZnO, ethylene glycol monostearate (EGMS), ethylene glycol distearate (EGDS), polyethylene glycol monostearate (PGMS) or polyethyleneglycol distearate (PGDS)), and aesthetic beads and flakes, as well as aesthetic gas bubbles.

### Suspended Particles

It is well known that heavy duty liquid laundry detergents provide a hostile environment for desirable functional components such as, for example, bleaches, enzymes, builders, softeners, perfumes, thickeners, and the like contained in the detergent. Functional components contained in heavy duty liquid detergents, particularly concentrated detergent compositions, can be denatured by surfactants and other incompatible co-ingredients within the composition. This results in decreased efficacy and/or the need for additional materials to compensate for the loss. However, such materials are expensive and some are generally less effective when employed at high levels.

Components which are sensitive to high concentrations of surfactant and/or other co-ingredients can be encapsulated and protected until they are ready for release in the wash medium. Moreover, components (e.g. perfumes, fabric softeners, and suds suppressors) which are more desirably released later in the wash and/or rinse cycle can be encapsulated and controllably released when needed. Other components, such as, for example, anti-redeposition agents, builder zeolites, fungicides, odor control agents, antistatic agents, fluorescent whitening agents, antimicrobial actives, UV protection agents, brighteners, and the like can be granulated, agglomerated, or encapsulated and dosed into the liquid detergent as suspended particles.

Liquid components that are immiscible with the liquid detergent compositions, such as amino silicones and silicone defoamers can be encapsulated. Functional polymers including color protecting polymers, fabric protection polymers and soil release polymers, such as PVP (polyvinylpyrrolidone), and polyacrylate copolymers that are prone to be salted out due to the high electrolyte concentration in liquid detergent compositions also can be incorporated in an encapsulated form.

In one aspect, it may be desirable to encapsulate one or more enzymes since enzymes are highly efficient laundry washing ingredients used to promote removal of soils and stains during the cleaning process. In one aspect, it may also be desirable to encapsulate bleach and enzymes separately due to incompatibility issues with one another to further enhance detergent efficacies.

In one aspect, the liquid detergent composition comprises an encapsulated perfume. Suitable encapsulated perfumes include those described in U.S. Patent Application Publication Nos. 2003/215417; 2003/216488; 2003/158344; 2003/165692; 2004/071742; 2004/071746; 2004/072719; 2004/072720; 2003/2038291; 2003/195133; 2004/087477; 2004/0106536; U.S. Pat. Nos. 6,645,479; 6,200,949; 4,882,220; 4,917,920; 4,514,461; 4,234,627; U.S. Reissue Pat. No. RE 32,713; and European Published Patent Application No. EP 1 393 706.

In one aspect, the laundry detergent ingredients, adjuvants, or benefit agents may be encapsulated in the form of microcapsules or microencapsulates containing one or more of the materials. The terms “microcapsules” and “microencapsulates” are used interchangeably herein. One type of microcapsule, referred to as a wall or shell capsule, comprises a generally spherical hollow shell of insoluble polymer material, within which the ingredient, adjuvant or benefit agent is contained.

In one aspect, the microcapsule is one that is friable. “Friability” refers to the propensity of the microcapsules to rupture or break open when subjected to direct external pressures or shear forces. In one aspect, the microcapsules utilized are “friable” if, while attached to fabrics treated therewith, they can be ruptured by the forces encountered when the capsule containing fabrics are manipulated by being worn or handled (thereby releasing the contents of the capsule).

In one aspect, “friability” refers to the propensity of the microcapsules to rupture or break open when subjected to direct shear forces within the washing media during the wash cycle (thereby releasing the contents of the capsule). In one aspect, the microcapsules utilized are “friable” if they can be ruptured by the temperature and/or forces encountered during the drying cycle (thereby releasing the contents of the capsule).

In one aspect, the shell of the microcapsule comprises an aminoplast resin. A method for forming such shell capsules includes polycondensation. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents (e.g., toluene diisocyanate, divinyl benzene, butane diol diacrylate etc.) may also be used and secondary wall polymers may also be used as appropriate, e.g. anhydrides and their derivatives, particularly polymers and co-polymers of maleic anhydride as disclosed in International Published Patent Application No. WO 02/074430. In another embodiment, the shell of the microcapsules comprises urea-formaldehyde; melamine-formaldehyde; or combinations thereof.

In one aspect, the encapsulated material includes encapsulated materials, particles or beads having liquid cores. These particles function especially well in terms of stability within the detergent composition prior to use, yet are suitably unstable in the washing media formed from such products. In one aspect the liquid core has an ionically charged polymeric material encapsulated by a semipermeable membrane. This membrane is one which can be formed by interaction of some of the ionically charged polymer in the core with another polymeric material of opposite charge. Non-limiting examples of suitable liquid core suspension particles are available in U.S. Pat. No. 7,169,741.

In one aspect, the suspension particles are visibly distinct beads suspended within the liquid detergent composition. In another aspect, the suspension particles are not visibly distinct in the liquid detergent composition. Particle or bead visibility is, of course, determined by a number of interrelated factors including size of the beads and the various optical properties of the beads and of the liquid composition they are dispersed within. A transparent or translucent liquid matrix in combination with opaque or translucent beads will generally render the particles visible if they have a minor dimension of 0.2 mm or greater, but smaller beads may also be visible under certain circumstances. Even transparent beads in a transparent liquid matrix might be visibly distinct if the refractive properties of the particles and liquid are sufficiently different. Furthermore, even particles dispersed in a somewhat opaque liquid matrix might be visibly distinct if they are big enough and are different in color from the matrix.

In one aspect, the suspension particles, encapsulated materials and beads have a particle size in the range from about 300 nanometers to about 5 mm. As defined herein, “particle size” means that at least one of said suspension particles have a longest linear dimension as defined. Those of skill in the art will understand that suitable techniques to measure particle size are available. For example, suspension particles having a particle size of from about 0.017 to about 2000 microns can be measured by a light scattering technique such as with a Beckman Coulter Particle Size Analyzer, wherein a sample of the composition is diluted to a concentration ranging from 0.001 to 1% v/v using a suitable wetting and/or dispersing agents. The measurements are recorded providing average particle diameter with distribution; optical microscopy can be used to detect particle sizes between 5 microns to about 500 microns; and macroscopic measuring techniques can measure from 0.5 mm to 5 mm.

It has importantly been found that the liquid detergent composition of the present technology is capable of suspending a vast range of particles, from visibly distinct particles with particle size up to about 5 mm to capsules below 500 μm. In one embodiment, the particle size is from about 0.5mm to about 5 mm in one aspect, from about 0.5 mm to about 3 mm in another aspect, and from about 0.5 mm to about 1 mm in a further aspect. In another embodiment, the suspension particles are not visibly distinct, comprising a particle size of from about 1 nanometer to about 500 μm in one aspect, from about 1 μm to about 300 μm in another aspect, and from about 5 μm to about 200 μm in a further aspect.

The suspension particles, encapsulated materials and beads useful herein will have a density of from about 700 kg/m³ to about 4,260 kg/m³, alternatively from about 800 kg/m³ to about 1,200 kg/m³, alternatively from about 900 kg/m³ to about 1,100 Kg/m³, alternatively from about 940 kg/m³ to about 1,050 kg/m³, alternatively from about and 970 kg/m³ to about 1,047 kg/m³, alternatively from about and 990 kg/m³to about 1,040 kg/m³ at about 25° C.

In one aspect, the difference between the density of the liquid matrix and the density of the particles is less than about 10% of the liquid matrix density in one aspect, less than about 5% in another aspect, less than about 3% in still another aspect, less than about 1% in a further aspect, and less than about 0.5% in a still further aspect, at about 25° C. In one aspect, the liquid matrix and the suspension particle have a density difference of from about 1 kg/m³ to about 3,260 kg/m³ in one aspect, from about 10 kg/m³ to about 200 kg/m³ in another aspect, and from about 10 kg/m³ to about 100 kg/m³ in a further aspect.

The liquid detergent composition of the present technology is capable of suspending particles for 4 weeks at 25° C. Stability can be evaluated by direct observation or by image analysis, by having colored particles suspended in a transparent liquid contained in a transparent bottle. A freshly made composition of the present technology is considered to be stable if less than 10 wt. % in one aspect, less than 5 wt. % in another aspect, and less than 1 wt. % in a further aspect of the particles settle to the bottom or cream to the top of the container after 4 weeks static storage.

Particles suitable for use in the liquid detergents of the present technology should be physically and chemically compatible with the detergent matrix ingredients, but they can disintegrate in use without leaving residues on fabrics and/or hard surfaces such as wash machine and dryer interiors. Thus within the liquid matrix of the detergent compositions, the particles are capable of withstanding a force before bursting or breaking of from about 20 mN to about 20,000 mN in one aspect, from about 50 mN to about 15,000 mN in another aspect, and from about 100 mN to about 10,000 mN in a further aspect. This strength makes them suitable for industrial handling, including the liquid detergent manufacturing processes. They can also withstand pumping and mixing operations without significant breakage and are also stable on transport. At the same time, the particles herein disintegrate readily in use by virtue of their osmotic behavior in dilute aqueous media such as agitated washing media.

### Process of Making

The manner in which the liquid detergent compositions are prepared or formulated are not particularly critical and such can be readily accomplished in any convenient fashion as is well known to those skilled in the liquid detergent formulation art. In one aspect, the liquid detergent composition according to various aspects of the present technology can be prepared by combining the at least one nonethoxylated anionic surfactant; the at least one ethoxylated anionic surfactant; the at least one nonionic fatty alcohol ethoxylate surfactant; any optional surfactants; the amphiphilic, nonionic emulsion suspending polymer; and the liquid carrier in any suitable order by any convenient method of mixing, such as, for example, by rapidly stirring with a mechanical stirrer or by agitating with a mechanical agitator. Any other additives may also be added to the liquid detergent composition using any suitable method.

The present technology is illustrated by the following examples that are merely for the purpose of illustration and are not to be regarded as limiting the scope of the technology or the manner in which it can be practiced. Unless specifically indicated otherwise, parts and percentages are given by weight and are based on 100 percent active material.

### Test Methodology

### Yield Stress and Viscosity

The yield stress and viscosity values of the liquid detergent compositions containing the suspending polymers of the present technology are determined by using a controlled stress rheometer (TA Instruments AR2000EX rheometer, New Castle, Del.) utilizing cone and plate geometry. A 60 mm cone with a cone angle of 2 degrees and 56 μm gap is used for samples with viscosity greater than 2500 mPa·s (Brookfield viscometer, Model RVT, Brookfield Engineering Laboratories, Inc., spindle 5, 20 rpm, measured at 25° C.), and double gap concentric cylinder (17.53 mm rotor outer radius, 16.04 mm rotor inner radius, 2000 μm gap) is used for samples with viscosity less than 2500 mPa·s (Brookfield viscometer, Model RVT, Brookfield Engineering Laboratories, Inc., spindle 5, 20 rpm, measured at 25° C.).

Yield stress is a good indicative for gauging the suspension power of fluids to physically stabilize insoluble materials such as beads and microcapsules with certain size and density properties. Because an actual beads suspension test at room temperature or an oven aging test takes at least a month to complete, a yield stress measurement of a fluid is a very useful and fast technique to predict suspension ability. There are a number of methods to measure yield stress properties, for example, creep/recovery, stress-growth, oscillatory stress, and the Herschel-Bulkley model fitting of stress-rate curves. In any case to use a certain method, the relationship between the measured yield stress and actual beads test result should be carefully and thoroughly established. For a liquid matrix containing active suspension polymers in an amount of less than about 2 wt. %, the yield stress is determined by Herschel-Bulkley model fitting in a shear stress vs shear rate plot. The Herschel-Bulkley equation is described in “Rheometry of Pastes Suspensions and Granular Material” page 163, Philippe Coussot, John Wiley & Sons, Inc., Hoboken, N.J. (2005), which is incorporated herein by reference. A Herschel-Bulkley fluid is a generalized model of a non-Newtonian fluid described by the equation, τ=τ₀+kγⁿ where τ is the shear stress, γ is the shear rate, τ₀ is the yield stress, and k and n are fitting parameters.

For a liquid matrix containing about 2 wt. % or greater of active polymer, the oscillatory measurements are performed at a fixed frequency of 1 Hz. The elastic and viscous moduli (G′ and G″, respectively) are obtained as a function of increasing stress amplitude. The stress corresponding to the crossover of G′ and G″ is noted as the yield stress. The viscosity curves are obtained for a shear rate ranging from 0.005 s⁻¹ to 200 s⁻¹. All viscosity values reported herein are determined at shear rate of about 18 to 21 s⁻¹. A viscosity ranging from about 100 to about 2000 mPa·s at a shear rate of about 18 s⁻¹ to about 21 s⁻¹ at 25° C. is considered pourable.

### Turbidity (Clarity)

The turbidity of a composition is determined in Nephelometric Turbidity Units (NTU) employing a nephelometric turbidity meter (Mircro 100 Turbidimeter, HF Scientific, Inc.) at ambient room temperature of about 20 to 25° C. Distilled water (NTU=0) is utilized as a standard. Six dram screw cap vials (70 mm×25 mm) are filled almost to the top with test sample and centrifuged at 100 rpm until all bubbles are removed. Upon centrifugation, each sample vial is wiped with tissue paper to remove any smudges before placement in the turbidity meter. The sample is placed in the turbidity meter and a reading is taken. Once the reading stabilizes the NTU value is recorded. The vial is given one-quarter turn and another reading is taken and recorded. This is repeated until four readings are taken. The lowest of the four readings is reported as the turbidity value. A turbidity value of below 30 and is considered as an indication of excellent clarity.

### Suspension Stability

The ability of a polymer system to suspend active and/or aesthetically pleasing insoluble oily and particulate materials is important from the standpoint of product efficacy and appeal. A six dram vial (approximately 70 mm high×25 mm in diameter) is filled to the 50 mm point with laundry detergents or dishwashing liquids. Each sample vial is centrifuged to remove any trapped air bubbles contained in the formulation. About 10 Unispheres™ NT-2403 beads, commercially available from InduChem AG, are stirred gently with a wooden stick until they are uniformly dispersed throughout the sample. The position of approximately 4 of the beads within each sample vial is noted by drawing a circle around the bead with black marker pen on the outer glass surface of the vial and photographed to establish the initial position of the beads within the formulation. The vials are placed in a 23° C. to age for a 12 week period. The bead suspension properties of each sample are visually evaluated at the conclusion of the 12 week test period. If the initial position of all 4 of the circled beads is unchanged following the conclusion of the test period the sample passes. If the initial position of one or more of the 4 circled beads changes following the conclusion of the test period the sample fails.

For microcapsule stability testing (e.g., perfume microcapsules) the test detergent is placed into a 6 dram vial in the same amount and conditions as described for the bead stability test except that 0.2-0.5 wt. % of perfume microcapsule (based on the total weight of the test sample) is homogeneously dispersed throughout the detergent. The vials are placed in a 45° C. oven to age for a 12 week period. At the conclusion of the test period, the test samples are visually inspected for phase separation or perfume microcapsules creaming to the top of the vial. Test samples that retain the uniform dispersion of perfume microcapsule after the conclusion of the 12 week test period pass. Samples that exhibit the slightest hint of phase separation and/or particle floating (creamy film formation) fail.

Abbreviations

| | |
|---|---|
| AA | Acrylic Acid |
| AEO-7 | Mixture of C₁₂-C₁₅ ethoxylated alcohols (average of 7 |
| | moles of ethoxylation), Tomadol ™ 25-7 surfactant |
| | (100% active), Air Products and Chemicals, Inc. |
| AMD | Acrylamide |
| AOS | Sodium C₁₄-C₁₆ alpha olefin sulfonate (≈40% active), |
| | Bio-Terge ® AS-40K surfactant, Stepan Company |
| APE | Allyl Pentaerythritol |
| BEM | Behenyl Ethoxylated (25) Methacrylate (50% active), |
| | Sipomer ® BEM, Rhodia |
| CAPB | Cocoamidopropyl Betaine |
| CSEM | Cetearyl Polyethoxylated (25 moles) Methacrylate |
| | (75% active), Bimax Chemicals LTD. |
| DI Water | Deionized Water |
| EA | Ethyl Acrylate |
| E-Sperse | Amphiphilic crosslinker with two polymerizable |
| RS-1617 | reactive groups from Ethox Chemical, LLC |
| E-Sperse | Amphiphilic crosslinker with two polymerizable |
| RS-1618 | reactive groups from Ethox Chemical, LLC |
| E-Sperse | Amphiphilic crosslinker with two polymerizable |
| RS-1684 | reactive group sfrom Ethox Chemical, LLC |
| HEMA | 2-Hydroxyethyl Methacrylate |
| Sodium Xylene | Stepanate ™ SXS Hydrotrope (40-42% active), |
| Sulfonate | Stepan Company |
| LAS | C₁₀ to C₁₆ linear alkyl benzene sulfonate, Bio-Soft ™ |
| | D-40 surfactant (38-39% active), Stepan Company. |
| MEA | Monoethanolamine |
| MAMD | Methacrylamide |
| n-BA | n-Butyl Acrylate |
| n-VP | n-Vinyl Pyrrolidone |
| Selvol ® 502 | Polyvinyl Alcohol (hydrolyzed between 87 to 89%), |
| and 205 PVA | Sekisui Corporation |
| SLES-1 | Sodium Laureth Sulfate (average of 1 mole ethoxylation), |
| | Sulfochem ™ ES-1K surfactant (26.5-27.5% active), |
| | Lubrizol Advanced Materials, Inc.. |
| SLES-2 | Sodium Laureth Sulfate (average of 2 moles of |
| | ethoxylation), Sulfochem ES-2CWK surfactant (27-28% |
| | active), Lubrizol Advanced Materials, Inc. |
| SLES-3 | Sodium Laureth Sulfate (average of 3 moles eth- |
| | oxylation), Steol ™ CS-330 surfactant (27-28% active), |
| | Stepan Company. |
| SLS | Sodium Lauryl Sufate, Sulfochem ™ surfactant (30% |
| | active), Lubrizol Advanced Materials |
| TBHP | t-butyl hydroperoxide (70%), Alfa Aesar |
| VA-086 | Azo VA-086 2,2′-Azobis[2-methyl-N-(2-hydroxy- |
| | ethyl)propionamide] Wako |
| VAc | Vinyl Acetate |

### Example 1

### Emulsion Polymer Synthesis

Monomer Composition: 35 wt. % EA, 15 wt. % n-BA, 45 wt. % HEMA, 5 wt. % BEM, 1 wt. % Amphiphilic Crosslinker (based on polymer dry wt.)

An emulsion polymer was prepared as follows. A monomer premix was made by mixing 140 grams of DI water, 5 grams of E-Sperse® RS-1618 amphiphilic crosslinker, 175 grams of (EA), 75 grams of (n-BA), 225 grams of (HEMA) and 33.3 grams of (BEM). Initiator A was made by mixing 2.86 grams of TBHP in 40 grams of DI water. Reductant A was prepared by dissolving 0.13 grams of erythorbic acid in 5 grams of DI water. Reductant B was prepared by dissolving 2.0 grams of erythorbic acid in 100 grams of DI water. A 3-liter reactor was charged with 800 grams of DI water, 10 grams of 40% AOS and 25 grams of Selvol® 502 PVA. The contents of the reactor were heated to 70° C. under a nitrogen blanket with agitation. After holding the reactor contents at 70° C. for one hour, initiator A was added to the reactor followed by addition of reductant A. After about 1 minute, the monomer premix was metered into the reaction vessel over a period of 180 minutes. About 3 minutes after the start of monomer premix introduction, reductant B was metered to the reactor over a period of 210 minutes. The reaction temperature was kept at 65° C. After completion of reductant B feed, the temperature of the reaction vessel contents was maintained at 65° C. for 60 minutes. The reactor contents were then cooled to 60° C. A solution of 1.79 grams of TBHP and 0.13 grams of 40% AOS in 15 grams of DI water was added to the reactor. After 5 minutes, a solution of 1.05 grams of erythorbic acid in 15 grams of DI water was added to the reactor. The reactor contents were maintained at 60° C. After 30 minutes, a solution of 1.79 grams of TBHP and 0.13 grams of 40% AOS in 15 grams of DI water was added to the reactor. After 5 minutes, a solution of 1.05 grams of erythorbic acid in 15 grams of DI water was added to the reactor. The reactor contents were maintained at 60° C. for about 30 minutes. Then, the reactor was cooled to room temperature and filtered through 100 micron filter cloth. The pH of the resulting emulsion was adjusted to 4.5 with ammonium hydroxide. The polymer product had a total solids content of 30.4%, a viscosity of 21 cps, and a particle size of 119 nm, as measured on a Nicomp 380 nanoparticle size analyzer (dynamic light scattering method).

### Example 2

### Emulsion Polymer Synthesis

35 wt. % EA, 15 wt. % n-BA, 45 wt. % HEMA, 5 wt. % BEM, APE 0.1 wt. % (based on polymer dry wt.), 1 wt. % Amphiphilic Crosslinker (based on polymer dry wt.)

An emulsion polymer employing APE crosslinker and an amphiphilic crosslinker was prepared as follows. A monomer premix was made by mixing 140 grams of DI water, 5 grams of E-Sperse® RS-1618 amphiphilic crosslinker, 175 grams of (EA), 70.6 grams of (n-BA), 225 grams of (HEMA) and 33.3 grams of (BEM). Initiator A was made by mixing 3.57 grams of TBHP in 40 grams of DI water. Reductant A was prepared by dissolving 0.13 grams of erythorbic acid in 5 grams of DI water. Reductant B was prepared by dissolving 2.5 grams of erythorbic acid in 100 grams of DI water. A 3-liter reactor was charged with 800 grams of DI water, 10 grams of 40% AOS and 25 grams of Selvol® 502 PVA and then was heated to 70° C. under a nitrogen blanket with proper agitation. After holding the reactor at 70° C. for one hour, initiator A was added to the reactor and followed by addition of reductant A. After about 1 minute, the monomer premix was metered to the reaction vessel over a period of 180 minutes. About 3 minutes after the start of monomer premix introduction, reductant B was metered to the reactor over a period of 210 minutes. The reaction temperature was kept at 65° C. At about 115 minutes after the monomer premix introduction, the premix metering was stopped for 10 minutes, and then 0.44 grams of 70% APE in 3.94 grams of n-BA was added to the monomer premix. After the 10 minute period, the premix metering was resumed. After completion of reductant B feed, the temperature of the reaction vessel contents was maintained at 65° C. for 60 minutes. The reactor contents were then cooled to 60° C. A solution of 1.96 grams of TBHP and 0.13 grams of 40% AOS in 15 grams of DI water was added to the reactor. After 5 minutes, a solution of 1.27 grams of erythorbic acid in 15 grams of DI water was added to the reactor. The reactor contents were maintained at 60° C. After 30 minutes, a solution of 1.96 grams of TBHP and 0.13 grams of 40% AOS in 15 grams of DI water was added to the reactor. After 5 minutes, a solution of 1.27 grams of erythorbic acid in 15 grams of DI water was added to the reactor. The reactor contents were maintained at 60° C. for about 30 minutes. Then, the reactor contents were cooled to room temperature and filtered through 100 micron filter cloth. The pH of the resulting emulsion was adjusted to 4.5 with ammonium hydroxide. The polymer product had a total solids content of 31.5%, a viscosity of 24 cps, and a particle size of 110 nm, as measured on a Nicomp 380 nanoparticle size analyzer (dynamic light scattering method).

### Example 3

### Emulsion Polymer Synthesis

Monomer Composition: 35 wt. % EA, 15 wt. % n-BA, 45 wt. % HEMA, 5 wt. % BEM, 1 wt. % Amphiphilic Crosslinker (based on polymer dry wt.)

An emulsion polymer was prepared as follows. A monomer premix was made by mixing 140 grams of DI water, 5 grams of 100% E-Sperse® RS-1617 amphiphilic crosslinker, 175 grams of (EA), 75 grams of (n-BA), 225 grams of (HEMA) and 33.3 grams of (BEM). Initiator A was made by dissolving 5 grams of Azo VA-086 in 40 grams of DI water. Initiator B was prepared by dissolving 2.5 grams of Azo VA-086 in 100 grams of DI water. A 3-liter reactor was charged with 800 grams of DI water, 5 grams of 40% AOS and 10 grams of Selvol® 203 PVA. The contents of the reactor were heated to 87° C. under a nitrogen blanket with agitation. After holding the reactor contents at 87° C. for one hour, initiator A was added to the reactor. After about 1 minute, the monomer premix was metered to the reaction vessel over a period of 120 minutes. About 3 minutes after the start of monomer premix introduction, initiator B was metered to the reactor over a period of 150 minutes. The reaction temperature was maintained at 87° C. After completion of the initiator B feed, the temperature of the reaction vessel contents were maintained at 87° C. for 60 minutes. The reactor contents were then cooled to 49° C. A solution of 0.61 grams of TBHP and 0.29 grams of 40% AOS in 15 grams of DI water was added to the reactor. After 5 minutes, a solution of 0.59 grams of erythorbic acid in 15 grams of DI water was added to the reactor. The reactor contents were maintained at 49° C. After 30 minutes, a solution of 0.69 grams of TBHP and 0.29 grams of 40% AOS in 15 grams of DI water was added to the reactor. After 5 minutes, a solution of 0.59 grams of erythorbic acid in 15 grams of DI water was added to the reactor. The reactor contents were maintained at 49° C. for about 30 minutes. The reactor was cooled to the room temperature and filtered through 100 micron filter cloth. The pH of the resulting emulsion was adjusted to 4.5 with ammonium hydroxide. The polymer product had a total solids content of 31.4%, a viscosity of 14 cps and a particle size of 105 nm, as measured on a Nicomp 380 nanoparticle size analyzer (dynamic light scattering method).

### Example 4

### Emulsion Polymer Synthesis

Monomer Composition: 35 wt. % EA, 20 wt. % n-BA, 40 wt. % HEMA, 5 wt. % BEM, 1 wt. % Amphiphilic Crosslinker (based on polymer dry wt.)

An emulsion polymer was prepared in the same manner as Example 3 except that 5 grams of 100% E-Sperse® RS-1617 amphiphilic crosslinker in the monomer mix was replaced by 5 grams of 100% ESperse® RS-1618 amphiphilic crosslinker and monomer compositions were changed to 35 wt. % (EA), 20 wt. % (n-BA), 40 wt. % (HEMA) and 5 wt. % (BEM) instead of 35 wt. % (EA), 15 wt. % (n-BA), 45 wt. % (HEMA) and 5 wt. % (BEM). The polymer product had a total solids content of 31.4%, a viscosity of 42 cps and a particle size of 87 nm, as measured on a Nicomp 380 nanoparticle size analyzer (dynamic light scattering method).

### Example 5

### Emulsion Polymer Synthesis

35 wt. % EA, 15 wt. % n-BA, 45 wt. % HEMA, 5 wt. % BEM, 1 wt. % Amphiphilic Crosslinker (based on polymer dry wt.)

An emulsion polymer was prepared in the same manner as Example 3 except that 5 grams of 100% E-Sperse® RS-1617 amphiphilic crosslinker in the monomer mix was replaced by 10 grams of 50% ESperse® RS-1684 amphiphilic crosslinker. The polymer product had a total solids content of 30%, a viscosity of 29 cps and a particle size of 93 nm, as measured on a Nicomp 380 nanoparticle size analyzer (dynamic light scattering method).

### Example 6

### Emulsion Polymer Synthesis

30 wt. % EA, 20 wt. % n-BA, 45 wt. % HEMA, 5 wt. % BEM, 1 wt. % Amphiphilic Crosslinker (based on polymer dry wt.)

An emulsion polymer was prepared in the same manner as Example 3 except that 5 grams of 100% E-Sperse® RS-1617 amphiphilic crosslinker in the monomer mix was replaced by 5 grams of 100% ESperse® RS-1618 amphiphilic crosslinker, and monomer compositions were changed to 30 wt. % (EA), 20 wt. % (n-BA), 45 wt. % (HEMA) and 5 wt. % (BEM) instead of 35 wt. % (EA), 15 wt. % (n-BA), 45 wt. % (HEMA) and 5 wt. % (BEM). The polymer product had a total solids content of 30.8%, a viscosity of 26 cps and a particle size of 83 nm, as measured on a Nicomp 380 nanoparticle size analyzer (dynamic light scattering method).

### Example 7

### Emulsion Polymer Synthesis

Monomer Composition: 35 wt. % EA, 15 wt. % n-BA, 43 wt. % HEMA, 5 wt. % BEM, 2 wt. % AA, 1 wt. % Amphiphilic Crosslinker (based on polymer dry wt.)

An emulsion polymer was prepared as follows. A monomer premix was made by mixing 70 grams of DI water, 2.5 grams of E-Sperse® RS-1618 amphiphilic crosslinker, 87.5 grams of (EA), 37.5 grams of (n-BA), 16.67 grams of (BEM), 107.5 grams of (HEMA), and 5 grams of (AA). Initiator No. 1 was made by dispersing 2.5 grams of VA-086 in 20 grams of DI water. Initiator No. 2 was prepared by dissolving 1.25 grams of VA-086 in 50 grams of DI water. A 1-liter reactor vessel was charged with 400 grams of DI water, 2.5 grams of 40% AOS and 5 grams of Selvol® 203 PVA and then the contents were heated to 87° C. under a nitrogen blanket and agitation. Initiator No. 1 was added to the reaction vessel. The monomer premix was then metered into the reaction vessel over a period of 120 minutes; while at the same time, initiator No. 2 was metered to the reaction vessel over a period of 150 minutes. After the completion of monomer premix feed, 16.5 grams of DI water was added to the dropping funnel which held the monomer premix to flush out the residual monomers into the reaction mixture. After the completion of initiator No. 2 feed, the temperature of the reaction vessel contents was maintained at 87° C. for 60 minutes. The reaction vessel contents were then cooled to 49° C. A solution of 0.3 grams of TBHP and 0.14 grams of 40% AOS in 7.5 grams of DI water was added to the reaction vessel. After 5 minutes, a solution of 0.3 grams of erythorbic acid in 7.5 grams of DI water was added to the reaction vessel. After 30 minutes, another solution of 0.3 grams of TBHP and 0.14 grams of 40% AOS in 7.5 grams of DI water was added to the reaction vessel. A solution of 0.3 grams of erythorbic acid in 7.5 grams of DI water was then added to the reaction vessel after 5 minutes. The reaction vessel contents were maintained at 60° C. for another 30 minutes. The reaction vessel contents were then cooled to room temperature (23° C.) and filtered through a 100 micron filter cloth. The pH of the resulting emulsion was adjusted to 3.5 to 4.5 with 28% ammonium hydroxide in DI water. The resulting polymer product had a total solids level of 30.7%, and a particle size of 113 nm, as measured on a Nicomp 380 nanoparticle size analyzer (dynamic light scattering method).

### Example 8

### Emulsion Polymer Synthesis

Monomer Composition: 35 wt. % EA, 15 wt. % n-BA, 43 wt. % HEMA, 5 wt. % BEM, 2 wt. % AMD, 1 wt. % Amphiphilic Crosslinker (based on polymer dry wt.)

An emulsion polymer was prepared as follows. A monomer premix was made by mixing 70 grams of DI water, 2.5 grams of E-Sperse® RS-1618 amphiphilic crosslinker, 87.5 grams of (EA), 37.5 grams of (n-BA), 16.67 grams of (BEM), 107.5 grams of 2-hydroxyl ethyl methacrylate (HEMA), and 10 grams 50% acrylamide (AMD). Initiator No. 1 was made by dispersing 2.5 grams of VA-086 in 20 grams of DI water. Initiator No. 2 was prepared by dissolving 1.25 grams of VA-086 in 50 grams of DI water. A 1-liter reactor vessel was charged with 400 grams of DI water, 2.5 grams of 40% AOS and 5 grams of Selvol® 203 PVA. The contents of the vessel was heated to 87° C. under a nitrogen blanket and agitation. Initiator No. 1 was added to the reaction vessel. The monomer premix was then metered to the reaction vessel over a period of 120 minutes; while at the same time, initiator No. 2 was metered to the reaction vessel over a period of 150 minutes. After the completion of monomer premix feed, 16.5 grams of DI water was added to the dropping funnel which held the monomer premix to flush out the residual monomers. After the completion of initiator No. 2 feed, the temperature of the reaction vessel contents was maintained at 87° C. for 60 minutes. The reaction vessel contents were then cooled to 49° C. A solution of 0.3 grams of TBHP and 0.14 grams of 40% AOS in 7.5 grams of DI water was added to the reaction vessel. After 5 minutes, a solution of 0.3 grams of erythorbic acid in 7.5 grams of DI water was added to the reaction vessel. After 30 minutes, another solution of 0.3 grams of TBHP and 0.14 grams of 40% AOS in 7.5 grams of DI water was added to the reaction vessel. A solution of 0.3 grams of erythorbic acid in 7.5 grams of DI water was then added to the reaction vessel after 5 minutes. The reaction vessel contents were maintained at 60° C. for another 30 minutes. Then, the reaction vessel contents were cooled to room temperature and filtered through a 100 micron filter cloth. The pH of the resulting emulsion was adjusted to 3.5-4.5 with 28% ammonium hydroxide solution. The resulting polymer product had a total solids level of 30.4%, and a particle size of 90.4 nm, as measured on a Nicomp 380 nanoparticle size analyzer (dynamic light scattering method).

### Example 9

Monomer Composition: 35 wt. % EA, 15 wt. % n-BA, 43 wt. % HEMA, 5 wt. % BEM, 2 wt. % MAMD, 1 wt. % Amphiphilic Crosslinker (based on polymer dry wt.)

An emulsion polymer was prepared as follows. A monomer premix was made by mixing 70 grams of DI water, 2.5 grams of E-Sperse® RS-1618 amphiphilic crosslinker, 87.5 grams of (EA), 37.5 grams of (n-BA), 16.67 grams of (BEM), 107.5 grams of (HEMA), and 20 grams 25% (MAMD). Initiator No. 1 was made by dispersing 2.5 grams of VA-086 in 20 grams of DI water. Initiator No. 2 was prepared by dissolving 1.25 grams of VA-086 in 50 grams of DI water. A 1-liter reactor vessel was charged with 400 grams of DI water, 2.5 grams of 40% AOS and 5 grams of Selvol® 203 PVA, and then the contents heated to 87° C. under a nitrogen blanket and agitation. Initiator No. 1 was added to the reaction vessel. The monomer premix was then metered to the reaction vessel over a period of 120 minutes; while at the same time, initiator No. 2 was metered to the reaction vessel over a period of 150 minutes. After the completion of monomer premix feed, 16.5 grams of DI water was added to the dropping funnel which held the monomer premix to flush out the residual monomers. After the completion of initiator No. 2 feed, the temperature of the reaction vessel was maintained at 87° C. for 60 minutes. The reaction vessel was then cooled to 49° C. A solution of 0.3 grams of TBHP and 0.14 grams of 40% AOS in 7.5 grams of DI water was added to the reaction vessel. After 5 minutes, a solution of 0.3 grams of erythorbic acid in 7.5 grams of DI water was added to the reaction vessel. After 30 minutes, another solution of 0.3 grams of TBHP and 0.14 grams of 40% AOS in 7.5 grams of DI water was added to the reaction vessel. A solution of 0.3 grams of erythorbic acid in 7.5 grams of DI water was added to the reaction vessel after 5 minutes. The reaction vessel contents were maintained at 60° C. for another 30 minutes. The reaction vessel contents were cooled to room temperature and filtered through a 100 micron filter cloth. The pH of the resulting emulsion was adjusted to 3.5-4.5 with a 28% ammonium hydroxide solution. The resulting polymer latex had a total solids level of 26.2%, and a particle size of 100 nm, as measured on a Nicomp 380 nanoparticle size analyzer (dynamic light scattering method).

### Example 10

### Emulsion Polymer Synthesis

Monomer Composition: 35 wt. % EA, 15 wt. % n-BA, 45 wt. % HEMA, 5 wt. % BEM, 1 wt. % Amphiphilic Crosslinker (based on polymer dry wt.)

An emulsion polymer was synthesized as follows. A monomer premix was made by mixing 140 grams of DI water, 5 grams of RS-1618 E-Sperse™ RS-1618 amphiphilic crosslinking agent, 175 grams of (EA), 75 grams of (n-BA), 225 grams of (HEMA), and 33.3 grams of (BEM). Initiator A was separately prepared by dissolving 5 grams of Azo VA-086 in 40 grams of DI water. Initiator B was separately prepared by dissolving 2.5 grams of Azo VA-086 in 100 grams of D.I. water. A 3 liter reactor was charged with 800 grams of DI water, 5 grams of 40% AOS and 10 grams of Selvol™ 502 PVA and the charge was then heated to 87° C. under a nitrogen blanket with mild agitation. After holding the reactor at 87° C. for one hour, Initiator A was added to the reactor. After about 1 minute the monomer premix was metered to the reaction vessel over a period of 120 minutes. About 3 minutes after the start of monomer premix metering, Initiator B was metered to the reactor over a period of 150 minutes. The reaction temperature was kept at 87° C. After completion of Initiator B feed, the temperature of the reaction vessel was maintained at 87° C. for 60 minutes. The reactor was then cooled to 49° C. A solution of 0.61 grams of TBHP and 0.29 grams of AOS in 15 grams of water was added to the reactor. After 5 minutes, a solution of 0.59 grams of erythorbic acid in 15 grams of water was added to the reactor. The reactor was maintained at 49° C. After 30 minutes, a solution of 0.69 grams of TBHP and 0.29 grams of AOS in 15 grams of water was added to the reactor. After 5 minutes, a solution of 0.59 grams of erythorbic acid in 15 grams of water was added to the reactor. The reactor was maintained at 49° C. for about 30 minutes. The reactor then was cooled to room temperature (22° C.) and filtered through 100 micron filter cloth. The pH of the resulting emulsion was adjusted to 4.5 with 10% ammonium hydroxide in water. The polymer emulsion had a total solids (T.S.) content of 30.2%, a Brookfield viscosity of 27 cps, and a particle size of 79 nm, as measured on a Nicomp 380 nanoparticle size analyzer (dynamic light scattering method).

### Example 11

### Emulsion Polymer Synthesis

Monomer Composition: 20 wt. % NVP, 15 wt. % EA, 20 wt. % n-BA, 20 wt. % VAc, 25 wt. % HEMA, 1 wt. % Amphiphilic Crosslinker (based on polymer dry wt.)

An emulsion polymer was prepared as follows. A monomer premix was made by mixing 70 grams of DI water, 2.5 grams of E-Sperse™ RS-1618 amphiphilic crosslinking agent, 50 grams of (NVP), 37.5 grams of (EA), 50 grams of (n-BA), 50 grams of (VAc), and 62.5 grams of (HEMA). Initiator 1 was made by mixing 1.07 grams of TBHP in 20 grams of DI water. Reductant 2 was prepared by dissolving 0.83 grams of erythorbic acid in 50 grams of DI water. A 1 liter reactor vessel was charged with 400 grams of DI water, 2.5 grams of AOS and 12.5 grams of Selvol™ 502 PVA, and then was heated to 65° C. under a nitrogen blanket and mild agitation. Initiator 1 was added to the reaction vessel. After about 1 minute, the monomer premix was metered into the reaction vessel over a period of 120 minutes; while at the same time Reductant 2 was metered to the reaction vessel for over a period of 150 minutes. After the completion of monomer premix feed, 16.5 grams of DI water was added to flush the residual monomers from the premix vessel into the reaction vessel. After the completion of Reductant 2 feed, the temperature of the reaction vessel was maintained at 65° C. for 60 minutes. The reaction vessel was then cooled to 50° C. A solution of 0.3 grams of TBHP and 7.5 grams of DI water was added to the reaction vessel. After 5 minutes, a solution of 0.29 grams of erythorbic acid in 7.5 grams of DI water was added to the reaction vessel. After 30 minutes, a solution of 0.32 grams of TBHP and 7.5 grams of DI water was added to the reaction vessel. After 5 minutes, a solution of 0.29 grams of erythorbic acid in 7.5 grams of DI water was added to the reaction vessel. The reaction vessel was maintained at 50° C. for about 30 minutes. Then, the reaction vessel was cooled to room temperature (22° C.) and filtered through 100 micron filter cloth. The resulting polymer latex had a total solids (T.S.) level of 30.8%, and particle size 100 nm (Nicomp 380 nanoparticle size analyzer).

### Example 12

### Emulsion Polymer Synthesis

Monomer Composition: 23 wt. % EA, 20 wt. % n-BA, 35 wt. % HEMA, 20 wt. % NVP, 2 wt. % CSEM, 1 wt. % Amphiphilic Crosslinker (based on polymer dry wt.)

An emulsion polymer was prepared as follows. A monomer premix was made by mixing 140 grams of DI water, 5 grams of E-Sperse™ RS-1618 amphiphilic crosslinking agent, 115 grams of (EA), 100 grams of (n-BA), 175 grams of (HEMA), 12.5 grams (CSEM) and 100 grams of (NVP). Initiator A was made by dissolving 4 grams of Azo VA-086 in 40 grams of DI water. Initiator B was prepared by dissolving 0.75 grams of Azo VA-086 in 100 grams of DI water. A 3 liter reactor was charged with 800 grams of DI water, 5 grams of AOS and 20 grams of Selvol™ 203 PVA, and then was heated to 87° C. under a nitrogen blanket with mild agitation. After holding the reactor at 87° C. for one hour Initiator A was then added to the reactor. After about 1 minute, the monomer premix was metered into the reaction vessel for over a period of 120 minutes. About 3 minutes after the start of monomer premix introduction, Initiator B was metered into the reactor over a period of 150 minutes. The reaction temperature was maintained at 87° C. After completion of the Initiator B feed, the temperature of the reaction vessel was maintained at 87° C. for an additional 60 minutes. The reactor was then cooled to 49° C. A solution of 0.61 grams of TBHP and 0.29 grams of AOS in 15 grams of water was added to the reactor. After 5 minutes, a solution of 0.59 grams of erythorbic acid in 15 grams of DI water was added to the reactor. The reactor was maintained at 49° C. After 30 minutes, a solution of 0.69 grams of TBHP and 0.29 grams of AOS in 15 grams of water was added to the reactor. After 5 minutes, a solution of 0.59 grams of erythorbic acid in 15 grams of DI water was added to the reactor. The reactor was maintained at 49° C. for about 30 minutes. The reactor was then cooled to the room temperature (22° C.) and filtered through 100 micron filter cloth. The pH of the resulting emulsion was adjusted to 4.5 with 10% ammonium hydroxide in water. The polymer emulsion had a total solids (T.S.) content of 30.9%, a Brookfield viscosity of 36 cps, and particle size 113 nm (Nicomp 380 nanoparticle size analyzer).

### Examples 13 to 15

Exemplary liquid laundry detergents were formulated from the components set forth in Table 1 below. The ampholytic polymers employed were synthesized as set forth in Examples 11 and 12.

TABLE 1

| | Ex. 13 | Ex. 14 | Ex. 15 |
|---|---|---|---|
| Total Active Surfactant (wt. %) | 21 | 20 | 31 |
| Surfactant Chassis | LAS | SLES-2 | SLES-3¹ |
| | SLES-2 | LAS | LAS |
| | AEO-7 | AEO-7 | AEO-7 |
| Surfactant Ratio (active wt. %) | 8/9/4 | 14/4/2 | 19/10/2 |
| Coco Fatty Acid (active wt. %) | — | 2 | 2 |
| Monoethanolamine (active wt. %) | — | 1 | 2 |
| NaOH (50% aqueous w/w) | 2 | 0.5 | 3 |
| (active wt. %) | | | |
| Ampholytic Polymer Emulsion | Ex. 11 | Ex. 12 | Ex. 11 |
| (≈31 wt. % T.S.) (active wt. %) | (1.5) | (1.5) | (1.5) |
| Sodium Xylene Sulfonate (active wt. %) | 0.8 | — | — |
| Propylene Glycol (active wt. %) | — | — | 6 |
| Diethylene Glycol (active wt. %) | — | — | 1 |
| Ethanol (active wt. %) | — | — | 2 |
| Calcium Chloride (active wt. %) | — | 0.1 | 0.1 |
| Citric Acid (50% aqueous w/w) | — | 4 | 4 |
| (active wt. %) | | | |
| Sodium Formate (active wt. %) | — | 0.2 | 1 |
| Perfume Microcapsules (specific gravity | 0.2 | 0.3 | 0.4 |
| of 0.92-0.97 g/l, particle sizes from | | | |
| 10 to 40 μm) (wt. %) | | | |
| D.I. Water | q.s. to | q.s. to | q.s. to |
| | 100 | 100 | 100 |
| pH | 7.5-8.5 | 8-8.5 | 8-8.5 |

The general procedure for preparing the liquid detergent composition of Examples 13 to 15 of Table 1 was as follows (1000 gram batches): The LAS surfactant was dispersed in warm DI water (40° C.) and neutralized with NaOH and/or monoethanolamine as indicated in the formulation table. The neutralized mixture was stirred with a mixer for 20 to 30 minutes until the solution became clear. The SLES-2 surfactant and liquefied coco fatty acid (liquefied at 40° C.) were added to the neutralized LAS solution with stirring. Separately, the amphiphilic polymer emulsion specified in the table (approximately 31 wt. % total solids as supplied) was weighed to obtain 1.5 wt. % (100% T.S.) and diluted with DI water at a 1:1 wt. ratio and mixed. The polymer water mixture was added with agitation to the previously prepared surfactant chassis. The alcohol ethoxylate surfactant (liquefied at 45° C.) was then added to the surfactant chassis and mixed well until homogeneous. The hydrotropes, electrolytes, builders and perfume microcapsules were added to the surfactant chassis in the order indicated in the table and mixed. DI water was added to the chassis (q.s. to 100) and the pH adjusted for each sample to the range indicated in the table.

Storage and stability studies were carried out according to the test protocol above and the results indicate that these examples are stable and can suspend beads for 6 to 8 weeks.

### Example 16 (Comparative)

For comparison, two commercially available suspension polymers traditionally used to provide suspension and/or thickening of various surfactant systems, an alkali-swellable emulsion (ASE) polymer (INCI: Acrylates Copolymer) and a hydrophobically modified alkali-swellable emulsion (HASE) polymer (INCI: Acrylates/Beheneth-25 Methacrylate Copolymer) were evaluated in liquid laundry detergent formulations utilizing the three component surfactant chassis and the perfume microcapsules as in Examples 13 to 15. The components were formulated in the amounts set for forth in Table 2. The ASE (1.5 wt. % active polymer solids) and HASE (1 wt. % active polymer solids) were formulated in a surfactant chassis totaling 20 wt. % of the total composition. The compositions containing the ASE and HASE suspension polymers were formulated by mixing the suspension polymer, DI water, and surfactants followed by neutralizing to the target pH with sodium hydroxide (10 wt. % solution). Upon neutralization, 0.3 wt. % of perfume microcapsules were added and homogeneously stirred into each sample. The active amounts of the respective suspension polymers for each of the comparative formulation examples were chosen to satisfy a viscosity target range of 500 to 1500 mPa·s.

Within 7 days in the oven aging test at 45° C., the perfume microcapsules “creamed” to the surface of each comparative formulation failing the suspension test. The yield stresses of 16-A, 16-B, and 16-C were 0 mPa, 0.95 mPa, and 0.39 mPa, respectively.

TABLE 2

| | Polymer | | | | |
|---|---|---|---|---|---|
| | Type | Surfactant | | | Suspension |
| Ex. | (active | Chassis | | Viscosity | Stability |
| No. | wt. %) | (active wt. %) | pH | (mPa · s) | Test |
| 16-A | HASE | LAS(12)/SLES-3(5)/ | 8.4 | 1358 | Failed |
| | (1.0) | AEO-7(3) | | | in 7 days |
| 16-B | ASE | LAS(12)/SLES-3(5)/ | 8.8 | 1083 | Failed |
| | (1.5) | AEO-7(3) | | | in 7 days |
| 16-C | Carbomer | LAS(8)/SLES-1(9)/ | 8.3 | 632 | Failed |
| | (0.2) | AEO-7⁴(8) | | | in 6 days |

1. A pourable, transparent or translucent liquid detergent composition capable of stably suspending particulate materials said composition comprising:
(a) 1 to 20 wt. % of a nonethoxylated anionic surfactant;
(b) 1 to 20 wt. % of an ethoxylated anionic surfactant;
(c) 1 to 20 wt. % of a fatty alcohol ethoxylate;
(d) 0 to 7 wt. % of a surfactant selected from a nonionic surfactant other than (c), a cationic surfactant, fatty acid salt, an ampholytic/zwitterionic surfactant, and mixtures thereof;
(e) 0.5 to 5 wt. % of a suspending polymer selected from a crosslinked, nonionic, amphiphilic, emulsion polymer prepared from a monomer composition comprising:
(i) at least one hydrophilic monomer,
(ii) at least one hydrophobic monomer, and
(iii) about 0.01 to about 5 wt. % of at least one amphiphilic crosslinking agent containing more than one unsaturated reactive moieties; and
(f) water;
wherein the amount of (a) through (d) is at least 10 wt. % in one aspect, at least 15 wt. % in another aspect, at least 20 wt. % in still another aspect, at least 25 wt.5 in a further aspect, at least 30, 35, 40, 45, 50, 55, 60, and 65 wt. % in a still further aspect, and wherein the weight percent is based on the weight of the total composition.

2. A composition of claim 1 further comprising from about 0.05 to about 10 wt. % of a suspended material (g) having a particle size ranging from about 300 nm to about 5 mm.

3. A composition of claim 2 wherein said suspended material is a perfume capsule.

4. A composition of claim 1 wherein said nonethoxylated anionic surfactant (a) is selected from an alkyl sulfate, a linear alkylbenzene sulfonate, and mixtures thereof.

5. A composition of claim 1 wherein said ethoxylated anionic surfactant (b) is selected from an alkyl ether sulfate.

6. A composition of claim 1 wherein said fatty alcohol ethoxylate (c) is selected from a compound represented by the formula:
R′″—(OCH₂CH₂)ₙ—OH
wherein R′″ is selected from a C₁₀ to C₂₀ alkyl, a C₁₀ to C₂₀ alkenyl, and a C₈ to C₁₂ alkyl phenyl group, and n is on average from about 3 to about 15.

7. A composition of claim 1 wherein the more than one reactive moieties of said at least one amphiphilic crosslinking agent comprise at least one allyl group.

8. A composition of claim 1 wherein the more than one reactive moieties of said at least one amphiphilic crosslinking agent comprise at least two allyl groups.

9. A composition of claim 1 wherein the at least one amphiphilic crosslinking agent is a compound of formula (III): 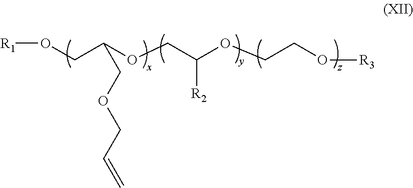
where:
R1 is a C₁₀₋₂₄ alkyl, alkaryl, alkenyl, or cycloalkyl;
R2 is CH₃, CH₂CH₃, C₆H₅, or C₁₄H₂₉;
R3 is H or Z⁻M⁺
Z⁻ is SO₃⁻, or PO₃²;
M⁺ is Na⁺, K⁺, NH₄⁺, or an alkanolamine;
x is 2-10;
y is 0-200; and
z is 4-200.

10. A composition of claim 1 wherein the amphiphilic crosslinking agent is a compound of formula (IV): 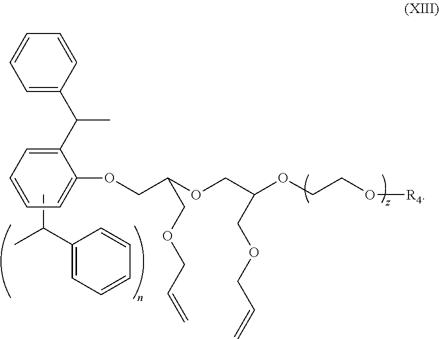
where:
n is 1 or 2;
z is 4 to 40 in one aspect, 5 to 38 in another aspect, and 10 to 20 in a further aspect; and
R₄ is H, SO₃⁻M⁺ or PO₃⁻M⁺, and M is selected from Na⁺, K⁺, NH₄⁺ or alkanolammonium.

11. A composition of claim 1 wherein said hydrophilic monomer is selected from hydroxy(C₁-C₅)alkyl (meth)acrylates, N-vinyl amides, amino group containing monomers, or mixtures thereof; and said hydrophobic monomer is selected from esters of (meth)acrylic acid with alcohols containing 1 to 30 carbon atoms, vinyl esters of aliphatic carboxylic acids containing 1 to 22 carbon atoms, vinyl ethers of alcohols containing 1 to 22 carbon atoms, vinyl aromatic monomers, vinyl halides, vinylidene halides, associative monomers, semi-hydrophobic monomers, or mixtures thereof.

12. A composition of claim 11 wherein said hydroxy(C₁-C₅)alkyl (meth)acrylate is selected from at least one compound represented by the formula: 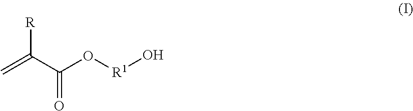
wherein R is hydrogen or methyl and R¹ is an divalent alkylene moiety containing 1 to 5 carbon atoms, wherein the alkylene moiety optionally can be substituted by one or more methyl groups.

13. A composition of claim 11 wherein said amino group containing monomer is selected from (meth)acrylamide, diacetone acrylamide and at least one monomer represented by the following formulas: 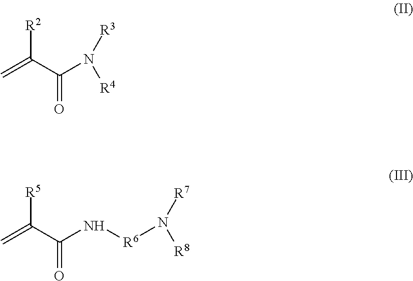
wherein R² is hydrogen or methyl, R³ independently is selected from hydrogen, C₁ to C₅ alkyl and C₁ to C₅ hydroxyalkyl, and R⁴ independently is selected from is C₁ to C₅ alkyl or C₁ to C₅ hydroxyalkyl, R⁵ is hydrogen or methyl, R⁶ is C₁ to C₅ alkylene, R⁷ independently is selected from hydrogen or C₁ to C₅ alkyl, and R⁸ independently is selected from C₁ to C₅ alkyl; or mixtures thereof.

14. A composition of claim 11 wherein said N-vinyl amide is selected from a N-vinyllactam containing 4 to 9 atoms in the lactam ring moiety, wherein the ring carbon atoms, optionally, can be substituted by one or more C₁-C₃ lower alkyl group.

15. The polymer composition claim 11 wherein said ester of (meth)acrylic acid with alcohols containing 1 to 30 carbon is selected from at least one compound represented by the formula: 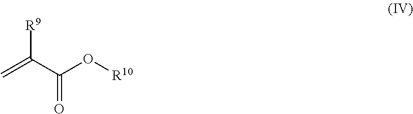
wherein R⁹ is hydrogen or methyl and R¹⁰ is C₁ to C₂₂ alkyl.

16. A composition of claim 11 wherein said vinyl ester of aliphatic carboxylic acids containing 1 to 22 carbon atoms is selected from at least one compound represented by the formula: 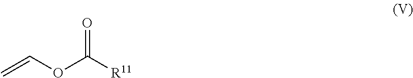
wherein R¹¹ is a C₁ to C₂₂ aliphatic group which can be an alkyl or alkenyl.

17. A composition of claim 11 wherein said vinyl ether of alcohols containing 1 to 22 carbon atoms is selected from at least one compound represented by the formula: 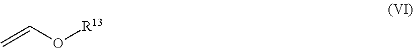
wherein R¹³ is a C₁ to C₂₂ alkyl.

18. A composition of claim 11 wherein said associative monomer comprises (i) an ethylenically unsaturated end group portion; (ii) a polyoxyalkylene mid-section portion, and (iii) a hydrophobic end group portion containing 8 to 30 carbon atoms.

19. A composition of claim 18 wherein said associative monomer is represented by formulas VII and/or VIIA: 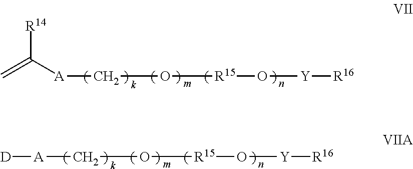
wherein R¹⁴ is hydrogen or methyl; A is —CH₂C(O)O—, —C(O)O—, —O—, —CH₂O—, —NHC(O)NH—, —C(O)NH—, —Ar—(CE₂)_{z}-NHC(O)O—, —Ar—(CE₂)_{z}-NHC(O)NH—, or —CH₂CH₂NHC(O)—; Ar is a divalent arylene (e.g., phenylene); E is H or methyl; z is 0 or 1; k is an integer ranging from about 0 to about 30, and m is 0 or 1, with the proviso that when k is 0, m is 0, and when k is in the range of 1 to about 30, m is 1; D represents a vinyl or an allyl moiety; (R¹⁵—O)ₙ is a polyoxyalkylene moiety, which can be a homopolymer, a random copolymer, or a block copolymer of C₂-C₄ oxyalkylene units, R¹⁵ is a divalent alkylene moiety selected from C₂H₄, C₃H₆, or C₄H₈, and combinations thereof; and n is an integer in the range of about 2 to about 150 in one aspect, from about 10 to about 120 in another aspect, and from about 15 to about 60 in a further aspect; Y is —R¹⁵O—, —R¹⁵NH—, —C(O)—, —C(O)NH—, —R¹⁵NHC(O)NH—, or —C(O)NHC(O)—; R¹⁶ is a substituted or unsubstituted alkyl selected from a C₈-C₃₀ linear alkyl, a C₈-C₃₀ branched alkyl, a C₈-C₃₀ carbocyclic alkyl, a C₂-C₃₀ alkyl-substituted phenyl, an araalkyl substituted phenyl, and an aryl-substituted C₂-C₃₀ alkyl; wherein the R¹⁶ alkyl group, aryl group, phenyl group optionally comprises one or more substituents selected from the group consisting of a hydroxyl group, an alkoxyl group, benzyl group styryl group, and a halogen group.

20. A composition of claim 19 wherein said associative monomer is represented by formula VIIB: 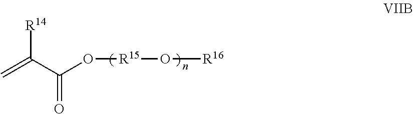
wherein R¹⁴ is hydrogen or methyl; R¹⁵ is a divalent alkylene moiety independently selected from C₂H₄, C₃H₆, and C₄H₈, and n represents an integer ranging from about 10 to about 60, (R⁵—O) can be arranged in a random or a block configuration; R¹⁶ is a substituted or unsubstituted alkyl selected from a C₈-C₃₀ linear alkyl, a C₈-C₃₀ branched alkyl, a C₈-C₃₀ carbocyclic alkyl, a C₂-C₃₀ alkyl-substituted phenyl, an araalkyl substituted phenyl, and an aryl-substituted C₂-C₃₀ alkyl, wherein the R⁶ alkyl group, aryl group, phenyl group optionally comprises one or more substituents selected from the group consisting of a hydroxyl group, an alkoxyl group, benzyl group styryl group, and a halogen group.

21. A composition of claim 11 wherein said semi-hydrophobic monomer comprises (i) an ethylenically unsaturated end group portion; (ii) a polyoxyalkylene mid-section portion, and (iii) an end group portion selected from hydrogen or an alkyl group containing 1 to 4 carbon atoms.

22. A composition of claim 21 wherein said semi-hydrophobic monomer is selected from at least one monomer represented by formulas VIII and IX: 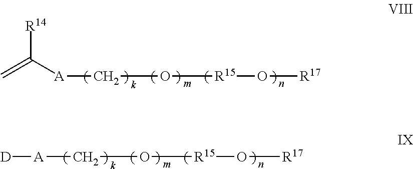
wherein R¹⁴ is hydrogen or methyl; A is —CH₂C(O)O—, —C(O)O—, —O—, —CH₂O—, —NHC(O)NH—, —C(O)NH—, —Ar—(CE₂)_{z}-NHC(O)O—, —Ar—(CE₂)_{z}-NHC(O)NH—, or —CH₂CH₂NHC(O)—; Ar is a divalent arylene (e.g., phenylene); E is H or methyl; z is 0 or 1; k is an integer ranging from about 0 to about 30, and m is 0 or 1, with the proviso that when k is 0, m is 0, and when k is in the range of 1 to about 30, m is 1; (R¹⁵—O). is a polyoxyalkylene moiety, which can be a homopolymer, a random copolymer, or a block copolymer of C₂-C₄ oxyalkylene units, R¹⁵ is a divalent alkylene moiety selected from C₂H₄, C₃H₆, or C₄H₈, and combinations thereof; and n is an integer in the range of about 2 to about 150 in one aspect, from about 5 to about 120 in another aspect, and from about 10 to about 60 in a further aspect; R¹⁷ is selected from hydrogen and a linear or branched C₁-C₄ alkyl group; and D represents a vinyl or an allyl moiety.

23. A composition of claim 22 wherein said semi-hydrophobic monomer is selected from at least one monomer represented by formulas VIIIA and VIIIB:
CH₂═C(R¹⁴)C(O)O—((C₂H₄O)ₐ(C₃H₆O)_{b}—H VIIIA
CH₂═C(R¹⁴)C(O)O—((C₂H₄O)ₐ(C₃H₆O)_{b}—CH₃ VIIIB
wherein R¹⁴ is hydrogen or methyl, and “a” is an integer ranging from 0 or 2 to about 120 in one aspect, from about 5 to about 45 in another aspect, and from about 10 to about 0.25 in a further aspect, and “b” is an integer ranging from about 0 or 2 to about 120 in one aspect, from about 5 to about 45 in another aspect, and from about 10 to about 0.25 in a further aspect, subject to the proviso that “a” and “b” cannot be 0 at the same time.

24. A composition of claim 1 wherein said polymer is polymerized from a monomer mixture comprising at least 30 wt. % of said hydrophilic monomer(s) and at least 5 wt. % of said hydrophobic monomers.

25. A composition of claim 1 wherein said amphiphilic polymer further comprises a conventional crosslinking agent which is present in an amount sufficient to be incorporated into said polymer from about 0.01 to about 1 wt. %, based on the dry weight of the polymer.

26. A composition of claim 25 wherein said conventional crosslinking agent contains an average of about 3 crosslinkable unsaturated moieties.

27. A composition of claim 25 wherein said monomer composition comprises a conventional crosslinking agent which is present in an amount sufficient to be incorporated into said polymer from about 0.01 to about 0.3 wt. %, based on the dry weight of the polymer.

28. A composition of claim 25 wherein the at least one conventional crosslinking agent is selected from polyallyl ethers of trimethylolpropane, polyallyl ethers of pentaerythritol, polyallyl ethers of sucrose, or mixtures thereof.

29. A composition of claim 25 wherein the at least one conventional crosslinking agent is selected from pentaerythritol diallyl ether, pentaerythritol triallyl ether, pentaerythritol tetraallyl ether; or mixtures thereof.

30. A composition of claim 1 wherein said emulsion polymer is prepared in the presence of a stabilizing surfactant or a reactive derivative thereof.

31. A composition of claim 1 wherein said monomer composition is polymerized in the presence of a protective colloid.

32. A composition of claim 1 wherein said polymer is prepared from a monomer composition comprising:
a) from about 20 to about 60 wt. % of at least one C₁-C₄ hydroxyalkyl (meth)acrylate;
b) from about 10 to about 70 wt. % of at least one C₁-C₁₂ alkyl (meth)acrylate or from about 10 to about 70 wt. % of at least one C₁-C₅ alkyl (meth)acrylate;
c) from about 0 to about 40 wt. % of at least one vinyl ester of a C₁-C₁₀ carboxylic acid;
d) from about 0 to about 30 wt. % of a vinyl lactam;
e) from about 0 to about 15 wt. % of at least one associative and/or a semi-hydrophobic monomer (wherein all monomer weight percentages are based on the weight of the total monomers); and
f) from about 0.01 to about 5 wt. % in one aspect, from about 0.1 to about 3 wt. % in another aspect, and from about 0.5 to about 1 wt. % in a further aspect of at least one crosslinker (based on the dry weight of the polymer) selected from an amphiphilic crosslinking agent or a combination of an amphiphilic crosslinking agent and said conventional crosslinking agent.

33. A composition of claim 32 wherein said polymer is prepared from a monomer composition comprising:
a) from about 20 to about 60 wt. % of at least one C₁-C₄ hydroxyalkyl (meth)acrylate;
b) from about 10 to about 30 wt. % ethyl acrylate;
c) from about 10 to about 35 wt. % butyl acrylate;
d) from about 0 to about 25 wt. % of a vinyl ester of a carboxylic acid selected from vinyl formate, vinyl acetate, vinyl propionate, vinyl butyrate, vinyl isobutyrate, and vinyl valerate;
e) from about 0 to about 30 wt. % of vinyl pyrrolidone;
f) from about 0 to about 15 wt. % of at least one associative monomer and/or semi-hydrophobic monomer (wherein all monomer weight percentages are based on the weight of the total monomers); and
g) from about 0.01 to about 5 wt. % in one aspect of at least one crosslinker (based on the dry weight of the polymer) selected from an amphiphilic crosslinking agent or a combination of an amphiphilic crosslinking agent and said conventional crosslinking agent.

34. A composition of claim 33 wherein said polymer is prepared from a monomer composition comprising:
a) from about 20 to about 50 wt. % of hydroxyethyl methacrylate;
b) from about 10 to about 30 wt. % ethyl acrylate;
c) from about 10 to about 30 wt. % butyl acrylate;
d) from about 0 to about 25 wt. % of vinyl pyrrolidone;
e) from about 0 to about 25 wt. % of vinyl acetate;
f) from about 0 to about 10 wt. % of at least one associative and/or semi-hydrophobic monomer (wherein all monomer weight percentages are based on the weight of the total monomers); and
g) from about 0.01 to about 5 wt. % of at least one crosslinker (based on the dry weight of the polymer) selected from an amphiphilic crosslinking agent or a combination of an amphiphilic crosslinking agent and said conventional crosslinking agent.

35. A composition of claim 32 wherein said polymer is prepared from a monomer composition comprising:
a) from about 20 to about 50 wt. % of hydroxyethyl methacrylate;
b) from about 10 to about 40 wt. % ethyl acrylate;
c) from about 10 to about 20 wt. % butyl acrylate;
d) from about 0.1 to about 10 wt. % of at least one associative and/or semi-hydrophobic monomer (wherein all monomer weight percentages are based on the weight of the total monomers); and
e) from about 0.01 to about 5 wt. % in one aspect, from about 0.1 to about 3 wt. % in another aspect, and from about 0.5 to about 1 wt. % in a further aspect of at least one crosslinker (based on the dry weight of the polymer) selected from an amphiphilic crosslinking agent or a combination of an amphiphilic crosslinking agent and said conventional crosslinking agent.

36. A composition of claim 32 wherein said polymer is prepared from a monomer composition comprising:
a) from about 20 to about 50 wt. % of hydroxyethyl methacrylate;
b) from about 10 to about 30 wt. % ethyl acrylate;
c) from about 10 to about 30 wt. % butyl acrylate;
d) from about 1 to about 10 wt. % of at least one associative and/or semi-hydrophobic monomer (wherein all monomer weight percentages are based on the weight of the total monomers); and
e) from about 1 to about 10 wt. % of at least one crosslinker (based on the dry weight of the polymer) selected from an amphiphilic crosslinking agent or a combination of an amphiphilic crosslinking agent and said conventional crosslinking agent.

37. A composition of claim 32 wherein said polymer is prepared from a monomer composition comprising:
a) from about 20 to about 35 wt. % of hydroxyethyl methacrylate;
b) from about 10 to about 30 wt. % ethyl acrylate;
c) from about 10 to about 30 wt. % butyl acrylate;
d) from about 15 to about 25 wt. % of vinyl pyrrolidone,
e) from about 15 to about 25 wt. % of vinyl acetate (wherein all monomer weight percentages are based on the weight of the total monomers); and
f) from about 0.01 to about 5 wt. % of at least one crosslinker (based on the dry weight of the polymer) selected from an amphiphilic crosslinking agent or a combination of an amphiphilic crosslinking agent and said conventional crosslinking agent.

38. A composition of claim 32 wherein said polymer is prepared from a monomer composition comprising:
a) from about 20 to about 40 wt. % of hydroxyethyl methacrylate;
b) from about 10 to about 30 wt. % ethyl acrylate;
c) from about 10 to about 30 wt. % butyl acrylate;
d) from about 15 to about 25 wt. % of vinyl pyrrolidone;
e) from about 1 to about 5 wt. % of at least one associative and/or semi-hydrophobic monomer (wherein all monomer weight percentages are based on the weight of the total monomers); and
e) from about 0.01 to about 5 wt. % of at least one crosslinker (based on the dry weight of the polymer) selected from an amphiphilic crosslinking agent or a combination of an amphiphilic crosslinking agent and said conventional crosslinking agent.

39. A composition of claim 20 wherein said associative monomer in said monomer composition is selected from lauryl polyethoxylated (meth)acrylate, cetyl polyethoxylated (meth)acrylate, cetearyl polyethoxylated (meth)acrylate, stearyl polyethoxylated (meth)acrylate, arachidyl polyethoxylated (meth)acrylate, behenyl polyethoxylated (meth)acrylate, cerotyl polyethoxylated (meth)acrylate, montanyl polyethoxylated (meth)acrylate, melissyl polyethoxylated (meth)acrylate, where the polyethoxylated portion of the monomer contains about 2 to about 50 ethylene oxide units.

40. A composition of claim 1 further comprising at least one ingredient selected from builders, electrolytes, bleaches, bleach activators, enzymes, nonaqueous cosolvents, pH adjusting agents, perfume, perfume carriers, fluorescent brighteners, suds suppressors, hydrotopes, anti-redeposition agents, optical brighteners, dye transfer inhibitors, antimicrobial active ingredients, auxiliary rheology modifiers, antioxidants, corrosion inhibitors, fabric softeners, and UV absorbers.
